(19) United States
(12) Patent Application Publication
(10) Pub. No.: US 2011/0186731 A1
(43) Pub. Date: Aug. 4, 2011

(54) LCMS TECHNOLOGY AND ITS USES

(75) Inventors: Cécile Antoinette Carola Maria Van Els, Bilthoven (NL); Ernst Christiaan Soethout, Odijk (NL); Adrianus Petrus Josephus Maria De Jong, Nieuwkoop (NL); Hugo Derk Meiring, Leusden (NL)

(73) Assignee: DE STAAT DER NEDERLANDEN, VERT. DOOR DE MINISTER V, Den Haag (NL)

(21) Appl. No.: 12/998,017

(22) PCT Filed: Sep. 9, 2009
(86) PCT No.: PCT/NL2009/050539

§ 371 Date: Apr. 15, 2011

(30) Foreign Application Priority Data
Sep. 9, 2008 (EP) 08163987.4

(51) Int. Cl. H01J 49/26; B05B 5/00

(52) U.S. Cl. 250/288; 239/690

(57) ABSTRACT

The present invention relates to an improved LCMS technology and its uses in methods for the selective identification and characterization of immunogenic pathogen associated epitopes, and the use thereof in vaccine development. One way of bridging the knowledge gap on T cell epitopes is to apply a new platform technology, “immunoproteomics”, to directly assess the epitope display at the surface of antigen presenting cells by nanoscale mass spectrometry of extracted peptide samples. This is the only methodology that can provide unbiased insight into epitope features such as the exact molecular nature, diversity, abundance, dynamics and PTM of T cell epitopes originating from pathogen-derived proteins. Therefore, this platform technology and immunoproteomics should become an intrinsic part of vaccinology.

### FIELD OF THE INVENTION

The present invention relates to an improved LCMS technology and its uses in methods for the selective identification and characterization of immunogenic epitopes, and the use thereof in vaccine development.

### BACKGROUND OF THE INVENTION

The specific receptor-mediated recognition of immunogenic pathogen-associated epitopes by T cells of the immune system is the basis for protective immunity against infectious diseases. After initial recognition under sufficiently stimulatory circumstances, such epitopes drive the expansion, differentiation and maintenance of clonal populations of specific T cells. During infection these T cell populations disarm and eliminate the pathogen. Hereafter, the T cell populations undergo a strong contraction, but a small fraction is maintained to mount a rapid memory response upon re-encounter with a specific antigen. This concept is adopted in vaccine development. Vaccines against infectious diseases should expose the immune system to relevant pathogen-derived epitopes to induce the generation of protective levels of specific memory T cells.

Pathogen associated T cell epitopes are small protein fragments from pathogen-encoded proteins, exposed after intracellular processing as ligands of Major Histocompatibility Complex (hereafter MHC) molecules at the cell surface of antigen presenting cells (hereafter APC). The processes and enzymes responsible for the excision, survival, competition and eventual presentation of peptide epitopes by MHC molecules are very little understood. Two types of MHC molecules are involved in epitope presentation to two functional classes of T cells. MHC class I molecules present epitopes to CD8⁺ T cells, whereas MHC class II molecules present epitopes to CD4⁺ T cells, respectively.

To design the vaccines of the future, we need novel thinking about T cell epitopes. Especially for pathogens displaying highly variable surface antigens or for (renewedly) emerging pathogens, protective T epitopes and their antigens remain elusive. The inventors of the present application have now realised that at the present state of the art a knowledge gap on the two distinguishable classes of pathogen-associated epitopes, MHC class I ligandomes and MHC class II ligandomes, is being maintained by major conventions in current vaccinology.

First, genome-based antigen discovery (reverse vaccinology) has made its entrance in vaccinology and has promised to reveal whole pathogen proteomes to us. By the virtue of immunoinformatics, surface structures such as major bacterial virulence factors and viral surface antigens are predicted in silico, which could be candidate protective antigens. The reverse vaccinology approach then requires recombinant antigen expression technology and immunogenicity studies in experimental animals. Indeed, this approach has successfully led to the selection of promising vaccine candidates as an alternative for PorA based Neisseria meningitidis serogroup B vaccines (Masignani et al. 2002). However, knowledge gaps on epitopes will remain despite the reverse vaccinology approach: (i) reverse vaccinology will not reveal immunodominant T cell antigens when being internal proteins of a pathogen and (ii) immunogenicity in animals may not be predictive for immunogenicity and immuno dominance in humans.

Second, classical T cell epitope identification methods based on the use of sets of synthetic peptides from candidate proteins, algorithm-predicted epitopes or even whole proteomes as overlapping synthetic peptides in high throughput MHC binding and T cell assays, have yielded insight into a considerable number of T cell epitopes, including pathogen-associated ones. However, the inventors consider also this approach as limited: these conventional methods deny the effects of intracellular natural processing, destruction as opposed to survival, selection and competition of epitopes, respectively, as well as the importance for immunogenicity of epitope features such as primary sequence, diversity, exact molecular length and length polymorphism, abundance, natural variance, and eventually dynamics of T cell epitopes in the course of infection and on different cell types. Also, T cell epitopes are commonly regarded as true in silico predictable translations of primary gene sequences. However, evidence is accumulating that multiple types of post-translational modifications (hereafter PTM) of primary protein sequences, including phosphorylation, glycosylation, deamidation, methylation, and splicing, as well as out-of-frame translations of genomes may lead to a much more diverse collection of immunologically relevant epitopes, than expected based on in silico proteomics only (Temmerman et al. 2004, Engelhard et al. 2006).

Furthermore, the inventors have realised that the techniques to identify T cell epitopes as described above under ‘second’ rely on in vitro responses of peripheral blood mononuclear cells (PBMC), isolated from individuals who have become immune to the pathogen of interest, usually by surviving a previous infection. Typically, these individuals are very scarce when a pathogen is rare or newly emerging. Therefore, epitope identification relating to emerging infectious diseases should be based on a novel technique that is independent of the usage of PBMC from previously infected individuals.

Furthermore, the inventors of the present application have realised that the identification of pathogen-associated MHC class I and MHC class II epitope ligands (so-called ligandomes) is a technically demanding challenge, requiring ultimate quantitative and qualitative sensitivity. Pioneering work of various laboratories has shown that mass spectrometry in combination with liquid chromatographpy (LCMS) is by far the most useful analytical tool to provide unbiased insight into these type of ligandomes (Hunt et al. 1992). However, current approaches fail to reach sufficient immunological and technological sensitivity and selectivity to gain unbiased insight into epitope features, such as the exact sequence, diversity, abundance, PTM and dynamics of immunogenic epitopes originating from pathogen-derived proteins. There is still a need for ‘immunoproteomics’ in vaccinology to bridge the knowledge gap on pathogen-related epitopes. Only then will we be able to recognize truly immunogenic and protective epitopes and understand strategies by which pathogens may evade their specific recognition. However, without major improvement of the methodology no insight can be created into what is beneath the tip of the epitope iceberg known to date.

MHC epitope analysis is highly challenging. MHC molecules on APC present a large variety of different peptide epitopes in large concentration ranges. The sensitivity of the system should be sufficient to detect a pathogen-associated epitope, even when expressed at a single copy per cell, in extracts from a APC cell culture containing 10⁷-10⁸ cells, equivalent to a peptide mass of 10-100 attomole on column at full recovery. The selectivity of the system should be sufficient to identify such individual epitope amongst hundreds of thousands of other irrelevant MHC epitopes.

This application discloses improvements in column technology with respect to sensitivity, coverage and dynamic range in comprehensive epitope mining. It is therefore the object of the present invention to provide a novel platform technology which, in a sensitive, selective and simple fashion, can identify immunogenic pathogen-related epitopes that are recognised as MHC class I and II ligands by protective T cells in a single analytical epitope sample.

The inventors have realised that this object is solved by combining three findings: (i) an improved highly sensitive and robust platform LCMS technology for the detection and identification of trace amounts of unknown peptide species in highly complex peptide mixtures, combined with (ii) a tailor-made in vitro immunological experimental design to liberate each class of immunogenic pathogen-associated epitopes in a relevant manner from its source protein and into one single solution and (iii) the (optional) application of selective chemical or physical modification of antigens, to facilitate rapid and unambiguous recognition and identification of relevant pathogen-associated epitopes in the sample.

A liquid chromatography-mass spectrometry (LCMS) device is known from US 2002/146349, incorporated by reference in its entirety, in particular relating to aspects of the device.

### Objects of the LCMS Device

The chromatographic separation of analytes (here peptides) in a sample is accomplished by using a liquid chromatography (LC) column. Preferably, the interior diameter and the length of this column are such that:

(i) the highest possible sensitivity is obtained, in combination with
(ii) a maximum separation efficiency.

It is an object of the present invention to provide an improved LCMS device equipped with a nanoscale column. In this application different aspects of the LCMS device are improved. An improved LCMS platform is provided. The improved LCMS platform has proven to be able to allow more detailed analysis than prior art LCMS platforms.

It is an even further object of the present invention to allow significantly longer total analysis time.

### DESCRIPTION OF THE INVENTION

An aspect of the invention concerns a liquid chromatography mass spectrometry (LCMS) device. An improved method for analysis using an LCMS device is provided. Further improved methods for manufacturing parts thereof are provided.

Another aspect of the invention concerns a method of chromatography, in particular a two-dimensional liquid chromatography.

A further aspect of the invention relates to a salt-free two-dimensional high-performance nanoscale liquid chromatography separation technology.

According to yet a further aspect, the invention concerns nanoscale liquid chromatography columns and the preparation of such columns to be used in liquid chromatographic applications, in particular in liquid chromatography mass spectrometry.

Another aspect of the invention concerns an Electro Spray Ionisation (ESI) emitter and a method for manufacturing of emitters to be used in conjunction with columns for liquid chromatography, preferably coupled to electro spray ionisation mass spectrometry (LC-ESI/MS).

Another aspect of the invention concerns connections and methods for connecting nanoscale LC columns.

Yet another aspect of the invention concerns connections and methods for (zero-dead volume) connection in nanoscale liquid chromatography columns. In an embodiment narrow bore (capillary) nanoscale liquid chromatography columns are provided.

In a further aspect the invention pertains to use of an LCMS device of the invention in a method for identification of an epitope.

In yet a further aspect the invention pertains to a method for identifying an epitope wherein the method comprises the steps of: a) preparation of a sample comprising at least one of MHC class I and MHC class II epitopes (ligandomes), wherein the epitopes have been processed and presented by an antigen presenting cell; and, b) analysing the sample obtained in a) in an LCMS device of the invention.

In one aspect the invention relates to a method for producing a composition comprising an epitope as identified in accordance with the methods of the invention, wherein the method comprises at least one of chemical synthesis and recombinant expression of a molecule comprising the epitope.

In one other aspect the invention relates to an epitope obtainable by the use of an LCMS device of the invention and/or a method for epitope identification of the invention.

Another aspect of the invention concerns the use of an epitope identified in accordance with the invention or the use of a composition comprising said epitope. The epitope or the composition comprising the epitope are used for the manufacture of a vaccine for the prevention and/or treatment of a disease caused by a pathogen carrying this epitope, or for assessing the immune status of a mammal.

All these aspects of the invention are discussed in the following.

### LCMS Device

In an embodiment the LCMS device comprises a column, preferably a nanoscale column for performing chromatography. An LCMS device comprises a liquid chromatography (LC) column arranged and constructed for operating at flow rates in the range of nanolitres per minute (nl/min). Such nanoscale columns allow high separation efficiencies of the chromatographic column allowing an improved analysis in the mass spectrometer (MS).

Since mass spectrometry has emerged as a powerful technique for the identification of peptides, nanoscale liquid chromatography coupled to mass spectrometry is the first method of choice nowadays for the identification of MHC-presented peptides, as it is a technique capable of providing sequence information of individual peptides at low attomole amounts. However, applications of embodiments of the invention are not limited to LCMS applications only.

In general, an embodiment of the LCMS device comprises a mixing pump arrangement that has a pump, preferably a high-pressure liquid chromatography (HPLC) pump, in an embodiment in combination with a flow splitting device as a convenient way to produce in a very accurate manner the desired low flow rates of a mixed solvent system, an analytical column and a mass spectrometer.

The LCMS device further has an electro spray ionization (ESI) unit comprising an emitter, a coating and a dedicated electro spray ionization source. The LCMS device comprises connecting elements for connecting respective capillary tubing. Preferred embodiments will be discussed in detail hereunder.

### Liquid Chromatography

Physically, liquid chromatography (LC) is performed in a column, e.g. a cylinder-like construction which has a space (cavity) on its inside to contain a material. The column material and the elution fluid used usually determine the type of chromatography. In the cavity a material is held, which is defined as the stationary phase. In a preferred embodiment, a sample is dissolved in a mobile phase. The sample and mobile phase pass through the stationary phase, where separation of the analytes takes place prior to their measurement or analysis. In subsequent steps further isolation is possible.

After fractionating the sample, in a preferred embodiment, peptides, and in a preferred embodiment of the LCMS device setup, individual peptides, are identified by means of mass spectrometry. Mass spectrometry generates mass (Mw) and structural information (amino acid sequences) on the basis of which peptides may be identified.

### LCMS Analysis

An object of the present invention may be achieved by multidimensional LCMS/MS analysis of proteolytic digested proteins, where Strong Cation eXchange (SCX) fractionation was used in conjunction with Reversed Phase (RP) separations. These analysis techniques are coupled to increase the separation efficiency and dynamic range of the analysis.

In an embodiment an online multidimensional LC method using a mixed bed of anion- and cation exchange particles for the first separation dimension is provided.

### Trapping Column

In an embodiment the LCMS device comprises a solid phase extraction (SPE) trapping column or trapping column upstream from the analytical or separation column. In the trapping column Strong Cation eXchange (SCX) or Weak Anion eXchange (WAX) resins or a mixed bed of SCX and WAX resins can be used. This constitutes one dimension of the LCMS/MS analysis. A second dimension could be added by C18 reversed phase (RP) chromatography in the downstream analytical column. Furthermore, the trapping column enables the relatively fast loading (transfer) of relatively large sample volumes into a nanoscale LC column. Therefore, the interior diameter of the trapping column should be in balance with the interior diameter of the analytical column.

In an embodiment a sample comprising a peptide (meaning at least one peptide) is introduced into the trapping column. Preferably, as later identified herein, a sample comprising an epitope to be identified. In an embodiment subsequently a solvent is injected into the trapping column that will transfer the bound peptides from the trapping column into the reversed phase C18 analytical column.

In an embodiment the Anion-Cation Exchange (ACE) solid phase trapping column comprises a mixture of both strong cation and weak anion resins. Such a mixed bed is known from Motoyama (Motoyama et al. 2007), wherein ammonium acetate is used for the recovery of bound peptides.

A problem with the prior art is that the use of cationic salts used for the recovery of the bound analytes, including ammonium acetate, adversely affects the performance of the online reversed phase nanoscale LC system in the second dimension.

According to a further aspect of the invention the recovery of the bound analytes in the first dimension can be accomplished in a salt-free manner. Use of a salt-free solution prevents the deterioration of the downstream reversed phase resins.

Preferably, the transfer or elution solvent is a salt-free solvent. Preferably, formic acid (methanoic acid) is used as transfer solvent. In other words, formic acid is used for elution of bound peptides. Although in literature the elution strength of formic acid is known as being too low for the recovery of peptides from ion exchange resins, it was found surprisingly in experiments that formic acid could be used as a transfer solvent. An explanation for this surprising effect could be found in the structure of the WAX resin on the silica particle comprising a more or less open structure of cross-linked molecules having a crystalline structure wherein the COO⁻ group of formic acid can penetrate and perform displacement of the bound analyte (peptide).

In an embodiment hydrochloric acid (HCl) was used for this purpose, although this is less preferred.

In an embodiment of the LCMS device or the method of operating such a device, a certain amount (e.g. 10 μl) of an equimolar mixture of formic acid and dimethylsulphoxide with an increasing strength (of concentration) is added through the trapping column. The peptides leaving the ACE trapping column, are re-trapped on the C18 reversed phase trapping column of the reversed phase column switching system.

### LC Analytical Column

The chromatographic separation of analytes (here peptides) in a sample is accomplished by using an LC analytical column. In an embodiment the column has a length of at least 50 cm, preferably at least 75 cm, more preferably at least 85 cm, and even more preferably at least 90 cm. The length of the column is an important parameter for the performance of the LC column, in particular with respect to the separation efficiency of the column.

In an embodiment an at least 75 cm, e.g. 90 cm analytical column with an interior diameter of less than 70 μm, preferably less than 55 μm and in an embodiment less than 50 μm packed with 5 μm C18 particles was installed for in depth analysis of a HLA-A2 elution sample. The sample was run in a 4-h gradient. The mass spectrometer was programmed to conduct 1 MS and 3 consecutive CAD MS/MS scans per cycle.

In an embodiment a fused silica column is used. In a preferred embodiment, a fused silica capillary column is used. The column comprises a packing for liquid chromatography. A suitable method for packing the column is provided.

In an embodiment the LCMS device comprises a nanoscale column. In an embodiment such a column can comprise a fused silica (capillary) tubing having an outer radius and an inner radius, the inner radius corresponding to a cavity extending throughout the fused silica. Preferably the outer diameter of the nanoscale tubing is in the range of 150-1400 μm. The outer diameter of the tubing preferably lies within the range of 200-800 μm.

The column comprises an inner diameter of less than 75 μm, preferably less than 55 μm, more preferably less than 50 μm, even more preferably less than 30 μm, and even further preferably less than 26 μm. A smaller inner diameter will improve the sensitivity and separation efficiency of the LCMS device. The inner cavity preferably has a diameter within the range of 5-100 μm, and more preferably within 16-70 μm, and in an even more preferred embodiments within 18-50 μm. Such capillary tubing can be used for flow rates in a range of 5-50 nl/min and more preferably 10-30 nl/min.

### Manufacture of an LC Analytical Column

According to an aspect of the present invention a method is provided for manufacturing a LC column comprising a column of at least 45, preferably at least 75 cm length having an internal cavity with an interior diameter of at most 55 μm, preparing a frit in one end of the column and packing a suitable liquid chromatography solid phase material in the column, wherein the liquid chromatography solid phase material is provided as a slurry in a low viscosity solvent. In a preferred embodiment, the low viscosity solvent is acetone having a viscosity of 0.32 cP at 20° C.

### Packing of an LC Analytical Column

According to a further aspect of the invention, a method for manufacturing an LC analytical column is provided comprising a column of at least 45 cm, preferably at least 75 cm length having an internal cavity with an interior diameter of at most 55 μm, preparing a frit in one end of the column and packing a suitable liquid chromatography solid phase material in the column, wherein the column is vibrated or ultrasonically treated during packing. In an embodiment the column is sonificated.

A known problem in prior art is the speed of packing of a ‘long’ LC analytical column.

In an embodiment a method for improved packing according to the present invention comprises vibrating, preferably using ultrasonic vibrations, the column during packing.

In an embodiment ultrasonic vibrating is performed during packing. Preferably, the slurry entering the column is being vibrated. This improves the packing efficiency and prevents the formation of voids/holes in the packed bed.

According to yet a further aspect, a nonviscous solvent, such as aceton, is used in combination with a method of packing a column. In a preferred embodiment the nonviscous solvent is used in combination with the slurry. Preferably a solvent is used that is at least twice less viscous than isopropanol.

In a specific embodiment the fritted end of the fused silica column is placed into an ultrasonic bath (e.g. Branson 200). In a further embodiment the ultrasonic treatment is carried out only after solid phase particles are flushing into the fused silica column.

In an embodiment the slurry contains at least 150 mg reversed phase particles suspended into 1 ml of acetone. The linear velocity of acetone versus isopropanol through the column during packing equals a surprising factor of 7±1.

### Electro Spray Ionization (ESI) and Emitter Manufacture

In an embodiment the LCMS device comprises an emitter for use in liquid chromatography coupled to electro spray ionisation mass spectrometry (LC-ESI/MS) having a tip for electro spraying. The tip, which is part of an electro spray ionization unit also comprising a coating and an electro spray ionization source, is preferably constructed and arranged to electro spray the nanolitre flow rate received from the analytical column.

A problem of the known emitters is the deterioration of the gold layer in particular near the end of the tip which could result in a pulsating spray. It is an object of the invention to improve the emitter, in particular to allow longer LCMS-ESI runs.

Preferably, the tip/emitter comprises a primary coating, preferably an electrically conducting coating, preferably of a precious metal, such as gold. A secondary coating is used as protective layer. In an embodiment the secondary coating is a conductive carbon based coating. In another embodiment a silicon based coating is used as secondary coating. In another embodiment a conductive polymer coating is used.

Preferably, the emitter is formed of tubing, preferably fused silica capillary tubing. In an embodiment the emitter has a inner diameter of at most 55 μm, preferably at most 30 μm.

In an embodiment of the invention a method is provided for forming the emitter. The method comprises heating the tubing and pulling in order to form a tip having a reduced inner radius. Such a reduced inner radius will further enhance the performance of the LCMS analysis. According to an aspect, the invention provides a method for manufacturing such an improved emitter. The method of manufacturing the improved tip that is to be used in the LCMS setup comprises a step of coating the tip and in particular the end of the tip with a conductive carbonbased coating. The interior diameter of the tip near its tapered end is preferably in the range of about 2-30 μm, more preferably 3-10 μm. In an embodiment the emitter/tip is formed with inner diameter of the emitter at the tapered end is at most 10 μm.

In an embodiment a tubing is pulled at both ends and heated in a middle part. During heating, the glass becomes weaker near the middle part, becomes elongated and eventually snaps. In this embodiment two tapered emitters are formed.

In an embodiment the elongated tip is coated with a precious metal such as gold. Thereafter, the tip is cut, preferably close to the tapered (elongated/pulled) end in order to form an outlet of reduced inner diameter.

In an embodiment the emitter is integrally formed onto an end of the analytical column. This prevents connections between the end of the analytical column and the upstream end of the emitter.

According to an aspect an emitter for a nanoscale flow is provided comprising an upstream end for receiving a sample, such as from a liquid chromatography column and a tapered end for electro spraying the sample, the emitter being part of an electro spray ionisation unit, the emitter formed from fused silica and having an interior diameter of less than 55 μm, wherein the tapered end of the emitter is provided with a conductive primary coating of gold and a secondary conductive carbon-based coating.

Furthermore, an emitter for a nanoscale flow is provided comprising an upstream end for receiving a sample, such as from a liquid chromatography column and a tapered end for electro spraying the sample, the emitter being part of an electro spray ionisation unit, the emitter formed from fused silica and having an interior diameter of at most 55 μm, wherein the tapered end of the emitter is provided with a coating comprising a silicon alloy or a conductive polymer.

### T-Connector

In a nanoscale LCMS device it is critical to avoid dead volumes, i.e. voids, in the flow path as dead volumes with a size that is comparable to the interior diameter of the flow path have a dramatic effect on the band (peak) width. Peak broadening due to dispersion will have a detrimental effect on both the sensitivity of the system and the dynamic range.

In an embodiment an improved connecting element is provided that at least significantly reduces the presence of dead volumes in the flow path of the LCMS device.

Therefore connecting elements are provided comprising an inner volume having a cross-section having a diameter generally equal to the outer diameter of the tubing to be fitted.

### Butt Connection of Tubing

An aspect of the invention concerns providing a method for the butt connection of nanoscale columns, that are able to withstand high pressures (>4×10⁴ kPa).

In an embodiment of the invention the ends of the tubing that are to be connected are cut using a diamond cutter for obtaining a “straight cut” perpendicular to the length direction of the tubing. Such a straight cut will allow an abutment of the ends of the tubing within the connecting element and will at least reduce the presence of dead volumes for the mobile phase when flushed from the upstream column into the entrance of the downstream column. The connection of tubing having straight edges at their endings is generally referred to as a butt connection. The straight cut avoids formation of burrs or fins.

Although the ends of the tubing are in abutment, such a butt connection is not entirely or tightly closed and leakage can occur. The leaking volume can reach a third connection assembly of the connecting element in the embodiment of a three-way connecting element.

Although the invention will be described using specific embodiments, it will be clear that the invention is not limited to the shown embodiments. More particular, the shown embodiments show applications of LCMS technique. However, the inventions are not limited to applications in LCMS. Although the invention will be explained using specific embodiments, the invention is not limited to the explicit features disclosed herein, but also comprises any implicit feature or equivalent feature. Although the specific claims are appended to this application, the disclosure of the application is not limited by the claims, but comprises all implicit and explicit features, and subsequent divisional filings could be directed at any combination of these features.

It will be clear to the skilled reader that embodiments according to this disclosure can be combined. Unless explicitly indicated, any of the disclosed embodiment herein can be combined with (a part of) a feature of another disclosed embodiment.

The invention will later on be described in more detail referring to the drawings.

Throughout the application, the expression LCMS device is interchangeably used with LCMS platform technology or LCMS apparatus.

### Use of the LCMS Device

In a further aspect, there is provided a use of a device as defined in previous aspects of the invention to identify an epitope.

The skilled person knows what an epitope is. Briefly, an epitope is a protein fragment, preferably a peptide. Usually, an epitope has a length of approximately 8 to 10 amino acids for MHC class I ligands and approximately 11-34, preferably 14-16 amino acids for MHC class II ligands, but peptides of other lengths can also be expected. Such peptide may be further altered by PTM (Engelhard et al. 2004). Any epitope may be potentially identified using the LCMS device of the invention. In one preferred embodiment, a MHC class I T cell epitope is identified. In another preferred embodiment a MHC class II T cell epitope is identified. The skilled person will understand that several epitopes may be identified using a single sample. It is also possible to identify MHC class I and II T cell epitopes in a single sample.

### MHC Class I Epitope

In a first preferred embodiment, a T cell epitope is an MHC class I epitope. An MHC Class I epitope as known by the skilled person and already explained in the background, is an epitope which is presented by an APC on an MHC Class I molecule to activate a CD8⁺ T cell. An MHC Class I epitope preferably originates or derives from a protein expressed inside mammalian cells, preferably derived from a virus during intracellular infection. An MHC Class I epitope may also originate from other non-self proteins, which may be bacterial proteins processed and presented in APC in the context of MHC Class I molecules. Preferably, these proteins derive from bacteria which may adapt an intracellular life style, which means that they may enter mammalian APC, preferably human APC. An MHC Class I epitope may also originate from non-self bacterial or viral proteins, which may be taken up by APC from the extracellular environment and which may reach the MHC Class I processing compartment via cross-presentation. Also, an MHC Class I epitope may originate from a host protein whose expression is de novo induced or upregulated by an intracellular infection of the APC and is therefore infection- or pathogen-related.

Several strategies may be used to identify an MHC Class I epitope using a LCMS device of the invention. For viral pathogens, first of all a virus has to be chosen for which an MHC Class I epitope needs to be identified. Preferred viruses include but are not limited to any virus, which is able to induce a condition or a disease in said mammal. Preferably the mammal is a human being. Viruses of human beings for which an MHC Class I epitope may be identified include: Retroviridae such as Human Immunodeficiency virus (HIV); a rubellavirus; paramyxoviridae such as parainfluenza viruses, measles, mumps, respiratory syncytial virus, human metapneumovirus; orthomyxoviridae such as influenza virus; flaviviridae such as yellow fever virus, dengue virus, Hepatitis C Virus (HCV), Japanese Encephalitis Virus (JEV), tick-borne encephalitis, St. Louis encephalitis or West Nile virus; Herpesviridae such as Herpes Simplex virus, cytomegalovirus, Epstein-Barr virus; Bunyaviridae; Arenaviridae; Hantaviridae such as Hantaan; Coronaviridae; Papovaviridae such as human Papillomavirus; Rhabdoviridae such as rabies virus. Coronaviridae such as: human coronavirus; Alphaviridae, Arteriviridae, filoviridae such as Ebolavirus, Arenaviridae, poxyiridae such as smallpox virus, and African swine fever virus. A Measles virus, an influenza virus and a respiratory syncytial virus are taken as examples in the experimental part.

A next step is to prepare a mixture comprising an MHC Class I epitope from a chosen virus, submit this mixture or sample to an LCMS device as identified earlier herein for identifying said MHC Class I epitope. Several strategies may be used for identifying an MHC class I epitope. In this preferred embodiment (MHC Class I epitope), a mixture comprising an MHC Class I epitope is preferably derived from a cell comprising said epitope. Therefore, if the MHC Class I epitope to be identified originates or derives from a virus, the skilled person will have first to infect cells of a mammal with said virus to obtain said mixture. This may be carried out using known techniques for the skilled person and has been extensively described in the experimental for the Measles or an influenza virus as example. Preferably, APC are used to be infected. APC may be derived from a cell line or may be isolated from a mammal, preferably a human being. Isolation and identification methods for professional APC. Preferred used APC are human DC, more preferably human monocyte derived dendritic cells (MDDC) as described in the experimental part. APC are preferably cultured for several days (approximately 4 to 6 days) in a suitable medium, optionally supplemented with a given nutrient. APC are subsequently infected with a chosen virus according to known techniques. Depending on the identity of the virus, the skilled person will know which infection protocol has to be followed. After infection, APC are harvested, washed, counted, and optionally pelleted and frozen before further analysis. As a control, non-infected APC may be used. Depending on the design of the experiment, one may culture APC in at least two parallel cultures, one of which is infected by chosen virus. The only other difference between the parallel cultures is that the infected culture is realised in the presence of 50% of stable isotopically labelled amino acid(s) such as ¹³C₆-L-leucine and/or ¹³C₅,¹⁵N₁-L-methionine and/or ¹³C₅,¹⁵N₁-L-valine and 50% of their native amino acid counterparts, L-leucine, L-methionine and L-valine. Other amino acids may be chosen for labelling, preferably amino acids that represent MHC anchor residues relevant to the HLA background of the experiment. Use of a 1:1 mixture of infected and control APC (cell/cell) prior to the elution of one MHC Class I epitope composition will differentially affect isotopic ion clusters for viral infection-associated versus normal unaltered self-epitopes. This will allow to better identify a viral infection-associated MHC Class I epitope later on.

Depending of the experimental design, one may choose to use APC from a specific HLA background. For example, if one uses APC from a HLA-A*0201 background, one will identify an epitope which is specifically presented in this context. We may also choose to use in parallel APC from distinct HLA backgrounds to identify an epitope which may be presented in the context of several backgrounds. After the 1:1 mixing of APC (cell/cell), the cells mixture may be frozen before further epitope analysis is being done.

When the analysis will be done, APC are thawed if they had been frozen. APC are subsequently lysed for solubilisation of MHC Class I molecules according to known techniques. A preferred method is similar to the method described under the section entitled MHC Class II epitope. A more preferred method is also described in the experimental part. The preparation of a composition or sample comprising an MHC Class I epitope suitable to be downloaded into a device of the invention for identifying each of the epitopes present in the eluted composition is similar to the preparation of a composition comprising an MHC Class II epitope to be downloaded into a device of the invention.

The downloading of a suitable composition into a device of the invention and the analysis of the results obtained leading to the identification of an MHC Class I epitope is carried out according to known techniques to the skilled person and which have been explained in the examples.

This approach allows the identification of potentially any MHC Class I epitope of a given virus known to infect a mammal. It also provides insight into the relative abundance of a given MHC Class I epitope. It may also provide insight into other features of the epitope including length variation of the epitope, reflected by the presence of multiple length variants comprised in the eluted composition, as well as post-translational modifications (PTM) of the epitope, or the role of protein or epitope polymorphism presented on the presentation in a given HLA context. This technique is powerful and will be needed for the development of a functional vaccine. If a virus chosen is a virus known to adapt itself quite quickly to existing therapies, a preferred embodiment encompassed by the present invention is to identify shared MHC Class I epitopes derived from at least two strains of one virus, preferably in this preferred embodiment, the virus is the influenza virus.

### MHC Class II Epitope

In another more preferred embodiment, a T cell epitope is an MHC Class II epitope. In a preferred use of the invention, an MHC class II epitope is identified after having incubated a mixture comprising a source of an epitope with APC in an antigen pulse experiment and subsequently submitting a sample comprising an epitope that has been processed and presented by the APC to the device as defined herein. Preferably a source of an epitope is a source protein of an epitope.

An MHC Class II epitope, as known by the skilled person and already explained in the background, is an epitope which is presented by an APC on an MHC Class II molecule to activate a CD4⁺ T cell. An MHC Class II epitope used herein preferably originates or derives from a non-self protein. A non-self protein is preferably a protein from a pathogen as later identified herein and said protein is non-self for a mammal that may be infected by said pathogen. Several strategies may be used to identify a pathogen-related MHC Class II epitope using a LCMS device of the invention. First of all, a pathogen has to be chosen for which an MHC Class II epitope needs to be identified. Preferred pathogens include but are not limited to any pathogen of a mammal, which is able to induce a condition or a disease in said mammal. Preferably the mammal is a human being. Pathogens of human beings for which an MHC Class II epitope may be identified include: a prokaryote or a eukaryote cell. Preferably, a prokaryote is a bacterium. Preferred bacteria include Helicobacter, such as Helicobacter pylori, Neisseria, Haemophilus, such as Haemophilus influenzae, Bordetella, Chlamydia, Streptococcus, such as Streptococcus pneumoniae, Vibrio, such as Vibrio cholera, as well as Gram-negative enteric pathogens including e.g. Salmonella, Shigella, Campylobacter and Escherichia, as well as bacteria causing anthrax, leprosy, tuberculosis, diphtheria, Lyme disease, syphilis, typhoid fever, gonorrhea and Q fever. Preferred bacteria belong to a Bordetella or a Neisseria species. More preferred Bordetella species include Bordetella pertussis, Bordetella parapertussis, or Bordetella bronchiseptica. More preferred Neisseria species include Neisseria meningitidis. A pathogen may be a parasite e.g. protozoan, such as Babesia bovis, Plasmodium, Leishmania spp. Toxoplasma gondii, and Trypanosoma, such as Trypanosoma cruzi. Preferred eukaryotes include a fungus. More preferred fungi are yeast or filamentous fungus. An example of a preferred yeast belongs to a Candida species. Preferred fungi include Aspergillus sp., Candida albicans, Cryptococcus, such as e.g Cryptococcus neoformans, and Histoplasma capsulatum. A pathogen may also be a viral pathogen as later defined herein. In this case, when one refers to pathogen cells, one preferably refers to a viral infected cell.

A next step is to prepare a mixture comprising a source protein, or multiple source proteins, of one or multiple MHC Class II epitope(s) from a chosen pathogen, incubate this mixture with APC in an antigen pulse experiment and submit a sample comprising an epitope or multiple epitopes that have been processed and presented by APC to a LCMS device as identified earlier herein for identifying said MHC Class II epitope. Several types of mixtures of one or multiple source protein(s) may be used depending on the aim of the experiment and/or on the knowledge the skilled person has of the chosen pathogen and/or depending on the identity of the pathogen.

In a preferred embodiment, said mixture is derived from a cell or comprises a cell. More preferably, a cell in this context is a pathogen cell. Preferred pathogens have already been identified herein. A mixture derived from a pathogen cell is preferably a mixture derived from a whole cell preparation. This more preferred embodiment (use of a mixture derived from a whole cell preparation) is usually attractive when no or few epitope(s) are known for said pathogen cell or additional epitope(s) or epitope(s) from unknown pathogen proteins should be identified for said pathogen. This more preferred embodiment is also attractive when known or unknown pathogen-related epitopes should be identified as dominantly processed and presented over other known or unknown epitopes from the pathogen. Also, this more preferred embodiment is attractive when in a single analytical sample the full pathogen-related MHC Class II ligandome should be comprised that resembles the outcome of in vivo processing and presentation of complete and complex pathogen proteomes by mammalian APC, preferably human APC. Briefly, in order to prepare such mixture, pathogen cells are cultured in a suitable medium in two parallels cultures, preferably until stationary phase. The only difference between the two parallel cultures is that one culture is realised in the presence of ¹⁴N (native nitrogen isotope) and the other in the presence of ¹⁵N stable isotope. Use of a 1:1 mixture of ¹⁴N- and ¹⁵N-labeled pathogen cells in an antigen pulse experiment with APC will preferably create equal copy numbers of the light (¹⁴N) and the heavy (¹⁵N) form of an epitope. This will allow facilitated recognition of a pathogen-related MHC Class II epitope later on in a LCMS device. Depending on the pathogen, the skilled person knows which suitable medium may be used and how it may optionally be supplemented by an additional nutrient. Usually, pathogen cells are heat-inactivated when they have reached the stationary phase. A stationary phase preferably means that no additional growth of a cell is detectable using preferably the measurement of the optical density. The optical density is preferably measured at 590 nm. Subsequently, pathogen cells may be concentrated in a physiological buffer such as PBS in order to obtain a whole cell preparation having a suitable optical density (OD), preferably between 0.6 and 1.

In another preferred embodiment, said mixture comprises a protein of a cell or is derived from a protein of a cell, preferably of a pathogen cell. Pathogen cells have already been defined herein. A preferred protein is P.69 Pertactin which is a protein from Bordetella pertussis. This type of mixture is typically used when a protein from a pathogen is already known as being immunogenic and new, improved or dominant epitopes need to be identified. A protein is preferably present in a purified preparation. A purified preparation preferably means that preparation comprises or consists of at least 80%, at least 85%, at least 90% of said protein, or at least 95%, or at least 98%, or at least 99% (w/w). A protein may be purified from a pathogen directly or its encoding gene may have been cloned into another host that will express said protein. A preferred example of such host is Escherichia coli (E. coli) as described in the experimental part. The way a protein is obtained is not limited to a specific way in the present invention as long as the purity of the preparation is as defined herein. To obtain said protein, a pathogen is cultured under suitable conditions as in the previous paragraph. In case of a host cell, expression of said protein may be induced by adding an inducer. Preferably, for E. coli, IPTG is used as inducer. If said protein is intracellularly expressed, said pathogen or host cells are lysed at the end of the culture using a detergent known to the skilled person. Cytosolic cell extracts are subsequently prepared which comprises said protein. Said protein is subsequently purified from said cytosolic extract. In the case of E. coli, said protein may be present in inclusion bodies. Purification of a protein present in an inclusion body is known to the skilled person and may be carried out as described in the example. Subsequently, protein preparation may be concentrated or diluted in a physiological buffer such as PBS or may be further purified in order to obtain a protein preparation having a suitable concentration of protein, preferably between 0.3 and 2.5 mg/ml.

In another preferred embodiment, a mixture is derived from a compartment of a cell or comprises a compartment of a cell, preferably a pathogen cell. Pathogen cells have already been defined herein. A preferred compartment is a vesicle, more preferably an Outer Membrane Vesicle (OMV) from Neisseiria meningitidis. This type of mixture is typically used when a vesicle from a pathogen is already known as being an immunogenic entity of the pathogen and new, improved or dominant epitopes need to be identified. A compartment of a cell is preferably present in a purified compartment preparation as explained for a protein as in the previous paragraph. A purified compartment preparation preferably means that said preparation comprises or consists of at least 5% of one representative protein known to be present in such preparation. Said preparation preferably comprises or consists of at least 10%, at least 20%, at least 30%, at least 40%, at least 50%, at least 60%, at least 70%, at least 80%, at least 90%, at least 85%, at least 90%, or at least 95%, or at least 98%, or at least 99% (w/w). An example of a representative protein present in OMV from Neisseiria meningitidis is the outer membrane protein Porin A (PorA). A compartment is preferably purified from a pathogen directly. The way a compartment is obtained is not limited to a specific way in the present invention as long as the required purity of the preparation comprising said compartment is fulfilled. To obtain said compartment preparation, a pathogen is cultured under suitable conditions as in the last two previous paragraphs. Depending on the identity of the compartment chosen, the skilled person will know how to isolate and optionally purify it from a cultured pathogen cell. A preferred way of preparing a preparation comprising OMV is described in the examples. Subsequently, the compartment preparation may be concentrated or diluted in a physiological buffer such as PBS or may be further purified in order to obtain a purified compartment preparation having a suitable concentration of protein representing the compartment. For example if one uses OMV from Neisseria meningitidis as said compartment, then the purified compartment should preferably contain between 1.2 and 2.4 mg/ml of the major representative outer membrane protein Porin A (PorA).

Any other mixture comprising a source of an MHC Class II epitope may be used in the present invention. Preferably, such source is a protein source. A mixture comprising a source of a viral epitope may also be used. Preferred viruses are later defined herein. A mixture comprising a source of a viral epitope is preferably a mixture comprising a viral protein or being derived therefrom or being a source of a viral protein, preferably a replicating viral organism. This preferred embodiment is usually attractive when a virus-associated MHC class II epitope inducing CD4⁺ T cells should be identified.

In parallel with the preparation of a mixture comprising a source of an MHC Class II epitope, a preparation comprising APC from a mammal known to be a potential target of the chosen pathogen is also prepared. Preferably APC are obtained from a human being. The skilled person knows how to isolate APC from a human being. This is usually done by using a gradient centrifugation technique of human whole blood, preferably gradient centrifugation of a leukapheresis buffy coat. The identity of APC is preferably checked by flow cytometry using specific antibodies specific for APC markers. Preferred used APC are human DC, more preferably human monocyte derived dendritic cells (MDDC) as described in the experimental part. Depending of the experimental design, one may choose to use APC from a specific HLA background. For example, if one uses APC from a HLA-DR1 background, one will identify an epitope, which is specifically presented in this context. We may also choose to use in parallel APC from distinct HLA backgrounds to identify an epitope, which may be presented in the context of several backgrounds. It is also possible to use other cell types as APC, preferably professional APC from the immune system such as B lymphocytes, monocytes, macrophages and lineages of dendritic cells other than MDDC. Also, other mammalian cell types can be used as APC to identify (an) epitope(s) specifically generated in the context of antigen processing and presentation background of said cells or relevant for a disease state. Herein, APC are preferably subsequently cultured a few days (approximately 4 to 6) in a suitable culture medium, which may be supplemented by a nutrient. At the end of the culture, a 1:1 mixture comprising of equal amounts of ¹⁴N and ¹⁵N source of an epitope or multiple epitopes (whole cell or protein or compartment of a cell) is incubated with APC for 1 to 2 days in a suitable medium, which may be further supplemented. A supplement may be an adjuvant. A preferred adjuvant is LPS (LipoPolySaccharide). More preferably LPS is from S. abortis equi. This is the so-called antigen pulse experiment. At the end of the incubation, APC are harvested, washed and counted. They may be frozen before further epitope analysis is being done.

When the analysis will be done, APC cells are thawed if they had been frozen. APC are subsequently lysed for solubilisation of MHC Class II molecules according to known techniques. A preferred lysis buffer comprises 1% CHAPS, is buffered and supplemented with protease inhibitors as described in the example. Supernatant obtained after centrifugation may be subsequently purified on several CNBr-activated, TRIS-blocked sepharose columns as described in the example in order to get an eluted composition comprising an epitope or epitopes. The eluted composition may be further purified by membrane filtration, concentrated and reconstituted in a suitable composition or sample to be downloaded into a device of the invention for identifying each of the epitope present in the eluted composition.

The downloading of a suitable composition or sample into a device of the invention and the analysis of the results obtained leading to the identification of an MHC Class II epitope is carried out according to known techniques to the skilled person and which have been explained in the examples.

This approach allows the identification of potentially any MHC Class II epitope of a given pathogen of a mammal. It also provides insight into the relative abundance of a given MHC Class II epitope. It may also provide insight into other features of the epitope including length variation of the epitope, reflected by the presence of multiple length variants comprised in the eluted composition, as well as post-translational modifications (PTM) of the epitope, or the role of protein or epitope polymorphism (as extensively demonstrated in the example for region 4 of N. meningitidis) on the presentation in a given HLA context. This technique is powerful and will be needed for the development of a functional vaccine.

### Epitopes Identified and Uses Thereof.

In another further aspect, the invention provides an epitope obtainable using any of the methods described herein. Preferred epitopes have already been identified herein (see Tables 1-8 in the experimental data, SEQ ID NO: 1-153). Each of the SEQ ID NO as identified in the examples represents an identified epitope. The adjacent residues to each identified epitope that are specified between brackets are preferably not taken into account as being part of the epitope. Preferably, each SEQ ID NO takes into account any PTM as indicated herein.

Preferred epitopes from the Measles virus are identified in Tables 1 and 2 and are selected from the group consisting of: SEQ ID NO: 1-45. More preferred epitopes are selected from the group consisting of SEQ ID NO: 7-45, optionally combined with at least one of SEQ ID NO: 1-6.

Preferred epitopes associated with infection with the influenza virus are identified in Table 3 and are selected from the group consisting of: SEQ ID NO: 46-49 and SEQ ID NO: 52-58.

Preferred epitopes from B. pertussis are identified in Tables 4 and 5 and are selected from the group consisting of: SEQ ID NO: 59-72.

Preferred epitopes from Neisseria meningitidis are identified in Tables 6, 7 and 8 and are selected from the group consisting of: SEQ ID NO: 73-153. Preferred epitopes are derived from a PorA protein, either the Porin A serosubtype P1.5-2.10 or the Porin A serosubtype P1.7-2.4. A PorA protein may be subdivided into 8 regions (see Table 6):
region 1 corresponds to the first 20 amino acids of a PorA protein, preferably the Porin A serosubtype P1.5-2.10 or the Porin A serosubtype P1.7-2.4
region 2 to amino acid 39 till 59,
region 3 to amino acid 91 till 111,
region 4 to amino acid 131 till 168,
region 5 to amino acid 191 till 224,
region 6 to amino acid 292 till 306
region 7 to amino acid 318 till 349
region 8 to amino acid 349 till 372.

In a preferred embodiment, one or more PorA epitopes are used as following: a PorA epitope comprised within region 4, and/or a PorA epitope comprised within region 5 and/or a PorA epitope comprised within region 6, optionally in combination with a PorA epitope comprised within region 1 and/or 2 and/or 3 and/or 7 and/or 8. Preferred epitopes comprised within each region are represented in Table 6:
preferred epitopes comprised within region 1 are represented by SEQ ID NO: 73-76,
preferred epitopes comprised within region 2 are represented by SEQ ID NO: 77-79,
preferred epitopes comprised within region 3 are represented by SEQ ID NO: 80-91,
preferred epitopes comprised within region 4 are represented by SEQ ID NO: '92-95,
preferred epitopes comprised within region 5 are represented by SEQ ID NO: 96-99,
preferred epitope comprised within region 6 is represented by SEQ ID NO: 100,
preferred epitope comprised within region 7 is represented by SEQ ID NO: 101,
preferred epitopes comprised within region 8 are represented by SEQ ID NO: 102-110.

In a more preferred embodiment, PorA epitopes are selected from the group consisting of: SEQ ID NO: 92-95, optionally in combination with at least one of the other identified PorA epitopes.

Table 7 identifies Neisseria meningitidis originating epitopes identified from other (non-PorA) proteins and represented by SEQ ID NO: 111-134. Therefore, in a preferred embodiment, a Neisseria meningitidis originating epitope is selected from the group consisting of SEQ ID NO: 111-134.

In a more preferred embodiment, a Por A epitope as identified above is used in combination with a Neisseria meningitidis originating epitope identified from another protein as identified in Table 7. Most preferably, PorA epitopes are selected from the group consisting of: SEQ ID NO: 92-95, in combination with at least one of SEQ ID NO: 111-134.

Table 8 identifies Neisseria meningitidis originating epitopes identified from PorA and a non-PorA protein and represented by SEQ ID NO: 135-153. Therefore, in a preferred embodiment, a Neisseria meningitidis originating epitope is selected from the group consisting of SEQ ID NO: 135-153.

In a more preferred embodiment, a Neisseria meningitidis epitope as identified above is used in combination with a Neisseria meningitidis originating epitope as in Table 8. Most preferably, PorA epitopes are selected from the group consisting of: SEQ ID NO: 92-95, in combination with at least one of SEQ ID NO: 135-153.

Each of the epitopes presented in Tables 3, 4 and 5 and a major part of the others presented in Tables 2, 6, 7 and 8 are believed to be new, which strengthens the unicity of the LCMS device of the invention.

Any of these epitopes is a potential candidate to be incorporated into a vaccine against the pathogen or virus it originates or derives from. Accordingly, the invention also relates to a composition comprising an epitope as identified herein for the manufacture of a vaccine for the prevention and/or treatment of a disease caused by a pathogen carrying this epitope. It is to be understood that the invention encompasses a composition comprising one, two, three, four, five, six, seven, eight, nine or more epitopes as identified herein for one given pathogen. Optionally, known epitopes may be combined with an epitope as identified herein.

As defined herein, an epitope is identified by having a certain length. A composition comprising said epitope is preferably not limited to a certain length. Said composition may comprise a peptide derived from a pathogen as defined herein, said peptide comprising an identified epitope, preferably with features as identified after natural processing and presentation, including PTM. Also, a composition may comprise a polypeptide comprising an identified epitope as a core sequence and being flanked by amino acid sequences beneficial to the presentation of said epitope after in vivo administration. Also, a composition may comprise a polypeptide comprising of multiple identified epitopes and flanking sequences. However, it is preferred that an epitope after in vivo delivery by such a composition has a length which is comprised within 8 and 12 amino acids for a MHC Class I epitope or within 11-34 amino acids, preferably 14-16 for a MHC Class II epitope. Said amino acid sequence being preferably entirely or partly derived from a protein expressed by a pathogen as defined herein. Therefore in a preferred embodiment, a peptide comprising an epitope as identified herein is used in a composition as a vaccine. A peptide comprising an MHC Class I epitope may have a length ranged between 8-20 amino acids or more. A peptide comprising an MHC Class II epitope may have a length ranged between 8-40 amino acids or more. Said peptide comprising an MHC Class I or II epitope may comprise an epitope and additional flanking sequences from the native pathogen protein or additional flanking sequences not originating from the native pathogen protein.

A peptide may therefore consist of an identified epitope, comprise an identified epitope, comprise multiple identified epitopes or have an amino acid sequence having at least 50%, 55%, 60%, 65%, 70%, 75%, 80%, 85%, 90%, 95%, 97%, 99% or 100% identity with one of the epitope sequences identified herein and wherein preferably this peptide is not the native amino acid sequence originating from a pathogen as identified herein. Preferably, a peptide is defined by its identity to one of the identified sequences and has a length as earlier identified herein. Identity is calculated by defining the number of identical amino acids between the two sequences after having aligned both sequences to ensure highest number of identical amino acids will be obtained.

It is further encompassed by the present invention that a composition comprising an epitope as identified herein may mean that a native protein of a pathogen for which one or more epitopes have been identified herein is used as a vaccine. This is preferably the case when a new native protein of a pathogen has been identified herein as having at least one epitope. Alternatively, part of said native protein may be used. Within the context of the invention, “part” means at least 10%, 20%, 30%, 40%, 50%, 60%, 70%, 80%, 90% or 100% of the number of amino acid of said mature protein sequence. In the experimental data (see Tables 2, 4-8-), several pathogen specific proteins were identified. Each of the proteins as identified in these Tables or parts thereof may be used in a composition as a vaccine against the corresponding pathogen.

A (poly)peptide of said composition used in the invention may be easily synthesized.

Another composition may comprise the genetic (DNA) code for a polypeptide comprising one or multiple identified epitopes in their optimal form. The art currently knows many ways of generating said (poly)peptide or said DNA.

The invention therefore further relates to a composition comprising an epitope of the invention as earlier defined herein. Said composition is preferably a pharmaceutical composition and is preferably used as a vaccine. A vaccine may be used for immunisation (raising an immune response) or vaccination of a mammal. A composition may further comprise an adjuvant. Adjuvants are herein defined to include any substance or compound that, when used in combination with an epitope, to immunise a mammal, preferably a human, stimulates the immune system, thereby provoking, enhancing or facilitating the immune response against said epitope, preferably without generating a specific immune response to the adjuvant itself. Preferred adjuvants enhance the immune response against a given epitope by at least a factor of 1.5, 2, 2.5, 5, 10 or 20, as compared to the immune response generated against said epitope under the same conditions but in the absence of the adjuvant. Tests for determining the statistical average enhancement of the immune response against a given epitope as produced by an adjuvant in a group of animals or humans over a corresponding control group are available in the art. The adjuvant preferably is capable of enhancing the immune response against at least two different epitopes. The adjuvant of the invention will usually be a compound that is foreign to a mammal, thereby excluding immunostimulatory compounds that are endogenous to mammals, such as e.g. interleukins, interferons and other hormones.

In a further preferred embodiment, a pharmaceutical composition further comprises a pharmaceutically acceptable carrier. The pharmaceutical compositions may further comprise pharmaceutically acceptable stabilizing agents, osmotic agents, buffering agents, dispersing agents and the like. The preferred form of the pharmaceutical composition depends on the intended mode of administration and therapeutic application. The pharmaceutical carrier can be any compatible, nontoxic substance suitable to deliver the active ingredients, i.e. an epitope and optionally an adjuvant to the patient. Pharmaceutically acceptable carriers for intranasal delivery are exemplified by water, buffered saline solutions, glycerin, polysorbate 20, cremophor EL and an aqueous mixture of caprylic/capric glyceride and may be buffered to provide a neutral pH environment. Pharmaceutically acceptable carriers for parenteral delivery are exemplified by sterile-buffered 0.9% NaCl or 5% glucose optionally supplemented with 20% albumin. Preparations for parental administration must be sterile. The parental route for administration of the active ingredients is in accordance with known methods, e.g. injection or infusion by subcutaneous, intravenous, intraperitoneal, intramuscular, intra-arterial or intralesional, intranasal, intradermal or oral routes. The compositions of the invention are preferably administered by bolus injection. A typical pharmaceutical composition for intramuscular injection would be made up to contain, for example, 1-10 ml of phosphate-buffered saline and 1-100 μg, preferably 15-45 μg of epitope of the invention. For oral administration, the active ingredient can be administered in liquid dosage forms, such as elixirs, syrups and suspensions. Liquid dosage forms for oral administration can contain coloring and flavoring to increase patient acceptance. Methods for preparing parenterally, orally or intranasally administrable compositions are well known in the art and described in more detail in various sources, including e.g. Remington's Pharmaceutical Science (15th ed., Mack Publishing, Easton, Pa., 1980) (incorporated by reference in its entirety for all purposes).

### Other Use of an Epitope of the Invention

In a further aspect, there is provided a further use of an epitope of the invention to assess the immune status of a mammal. In this aspect, a mixture comprising an epitope of a pathogen may be incubated in vitro with APC or T cells from said mammal using techniques known to the skilled person. Assessing the immune status of a mammal preferably means to assess whether said mammal had already been infected with a given pathogen or whether an administered vaccine still protects said mammal of future infections by said pathogen. Preferably, an epitope is obtainable using any of the methods described herein. Preferred epitopes and preferred compositions comprising said epitopes have already been defined herein. The detection of an activation of said T cells or the processing and recognition of an epitope associated with an APC may indicate that said mammal is still protected for said pathogen. An activation of T cells that are specifically directed against said epitope may be assessed in a proliferation assay or by an increase of the cytokines or other effector molecules produced by these T cells. Each of these methods is known to the skilled person. Said use is also named as an in vitro ‘Correlates of Protection (CoP)’.

In this document and in its claims, the verb “to comprise” and its conjugations is used in its nonlimiting sense to mean that items following the word are included, but items not specifically mentioned are not excluded. In addition, the verb “to consist” may be replaced by “to consist essentially of meaning that a product or a composition as defined herein may comprise additional component(s) than the ones specifically identified, said additional component(s) not altering the unique characteristic of the invention. In addition, reference to an element by the indefinite article “a” or “an” does not exclude the possibility that more than one of the element is present, unless the context clearly requires that there be one and only one of the elements. The indefinite article “a” or “an” thus usually means “at least one”.

All patent and literature references cited in the present specification are hereby incorporated by reference in their entirety.

The following examples are offered for illustrative purposes only, and are not intended to limit the scope of the present invention in any way.

### DESCRIPTION OF THE FIGURES

FIG. 1 is a diagrammatic view of an LCMS setup in a first embodiment;

FIG. 2 is a cross-sectional view of an emitter for electro spraying and its assembling to an analytical column to be used in combination with electro spraying in an LCMS setup in a second embodiment;

FIG. 3a-3d show schematically a method for preparing a tip according to the second embodiment;

FIG. 4 shows a cross-sectional view of a connecting element according to a third embodiment;

FIG. 5 shows a cross-section of a step in a method for packing an analytical column;

FIG. 6 shows a second step in a method for packing an analytical column;

FIG. 7 shows a schematic view of the trapping column in a seventh embodiment;

FIG. 8 Schematic representations of the mass spectral recognition patterns for the allocation of a T cell epitope, presented by MHC class I or MHC class II molecules.

FIG. 9 illustrates a utility of combined improvements in LCMS technology in complex sample analysis.

FIG. 10 illustrates the results of high quality nanoscale LC technology in complex sample analysis.

FIG. 11 illustrates results of LCMS analysis of a MHC ligandome from human MDDC.

FIG. 12 illustrates the results of the use of stable isotope labelling guiding LCMS identification of virus infection-associated upregulated MHC class I self epitopes.

FIG. 13 illustrates the results of the use of stable isotopes guiding LCMS identification of pathogen-derived MHC class II ligands from a complex pathogen whole cell preparation.

FIG. 14 illustrates the results of the use of stable isotopes guiding LCMS identification of pathogen-derived MHC class II ligands from a single recombinantly expressed protein.

FIG. 15 illustrates the results of the use of stable isotopes guiding LCMS identification of pathogen-derived MHC class II ligands from a bacterial membrane preparation.

FIG. 16 illustrates the results of the use of stable isotopes enabling the identification of MHC class II epitopes with unexpected PTM.

FIG. 17 illustrates differential recognition of P1.5-2.10 and P1.7-2.4 ‘region 4’ epitopes by human MB71.5 T cells.

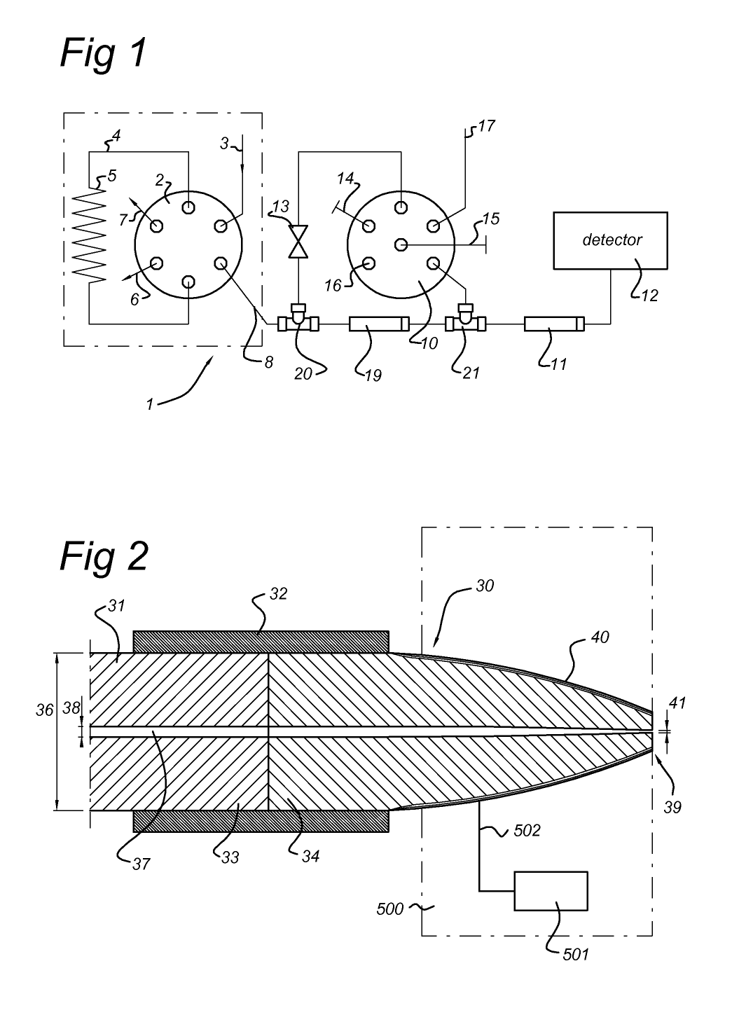

### DETAILED DESCRIPTION OF FIGS. 1-7

FIG. 1 schematically shows a view of a LCMS setup 1. On the left hand side an injector valve 2 is shown schematically. The valve 2 may be connected with a supply 3 connected to a pump, preferably a mixing pump. The valve is also connected to a loop 4 comprising an injection loop 5. The injector valve may further be connected to waste exits 6 and 7 and an outlet 8 connected to the next valve, more specifically the so-called Deans valve 10 schematically shown on the right hand side of FIG. 1. The valve is configured to allow a part of the flow to split into the outlet 8.

The Deans valve 10 is used for switching, splitting and directing the column flow into the analytical column 11 and eventually in mass spectrometer 12. The Deans valve accomplishes the splitting in a remote sense using a simple six-port switching valve. The column head pressure is created by the dimensions of a restrictor 13. The Deans valve is further connected to plugs 14, 15 and wastes 16, 17.

In an embodiment the LCMS device comprises a nanoscale pump arrangement. The pump arrangement comprises a pump and is able to deliver a flow rate in the nl/min range for a continuously varying binary solvent. In another embodiment a conventional high-pressure liquid chromatography (HPLC) pump is used.

A pump, preferably a HPLC pump or a binary or a quaternary pump, should be capable of:
(i) delivering a linear and undelayed gradient at a given column flow rate or precise gradient flow (mixing of at least two solvents in a precisely and well defined ratio,
(ii) the solid phase extraction trap should not adversely affect the (overall) separation efficiency; and
(iii) peak broadening in the ESI interface should be absent or minimal. Nonlinear and delayed gradients could be caused by operating the pump at a flow rate (F) that is too low compared to pump holdup volume (Vm).

In an embodiment a nanoscale LC pump is used in the LCMS device according to the invention. However, they are expensive and unable to produce a precise and steady gradient at very low flow rates, i.e. lower than 30 nl/min.

In an embodiment the pump arrangement comprises a pump, preferably a HPLC pump, in combination with a flow splitting device as a convenient way to produce in a very accurate manner the desired low flow rates of a mixed solvent system. The system is based on a remote switching mechanism, previously developed for so-called cutting in gas chromatography and will be referred to as Deans switching. Splitting and directing the column flow is accomplished in a remote sense using in an embodiment a six-port switching valve (referred to as Deans Valve). The desired column head pressure results from the dimensions (length, interior diameter) of the restrictor placed upstream of a trapping column and the primary outlet flow rate of the pump. A T-connector could be used to connect the restrictor and subsequent downstream columns.

A nanoscale HPLC system comprises a solvent vacuum degasser, a solvent mixing pump, preferably a quaternary mixing pump, more preferably a high pressure mixing binary pump, an autosampler able to inject at least 10 μl sample volume. Preferably, all connecting tubing has an interior diameter of less than 105 μm, preferably less than 55 μm, and more preferably less than 30 μm. The tubing is made of undeactivated fused silica.

Part of the splitting and directing system of the Deans valve 10 is a trapping column 19 positioned in between two three-way connectors 20, 21. The trapping column comprises a stationary phase bed, comprising particles having a size of at most 5 μm and the dimensions of said stationary phase bed having a length of 5 mm, preferably at least 10 mm and more preferably at least 20 mm and having an interior diameter of about 50 μm.

In an embodiment the LCMS device comprises a solid phase extraction (SPE) trapping column or trapping column 19 upstream from the analytical column 11. A trapping column can be positioned in parallel with the Deans valve 10, a system also known from the literature as Vented Column or V-column (Licklider et al. 2002). The trapping column enables the relatively fast loading (transfer) of relatively large sample volumes into a nanoscale LC column. The interior diameter of the trapping column 19 should be in balance with the interior diameter of the analytical or separation column 11.

Use of trapping columns 19 with large interior diameters (ID) results in the transfer of trapped compounds in relatively broad bands onto the analytical column 11 owing to a linear velocity of the mobile phase dropping far below the optimal value of approximately 1 mm/s. The linear velocity of the mobile phase in the trapping column 19 is proportional to the square of the column/trap ID ratio, or 0.03 and 0.25 mm/s, respectively, for a 300 μm ID and a 100 μm ID trapping column 19 in combination with a 50 μm ID analytical column 11 operated at linear velocity of 1 mm/s. In addition, large ID trapping columns 19 cause a significant delay since the void volume of the trapping columns 19 and connecting tubing should have passed the column before the elution process may commence.

In an embodiment the analytical column 11 can comprise a stationary phase bed, comprising particles having a size of at most 3 μm and the dimensions of said stationary phase bed having a length of 25 cm, preferably at least 50 cm, and more preferably at least 95 cm and having an interior diameter of about 25 μm. The end of this column is in abutting connection with a conductive nanospray tip or emitter, an example of which is shown in FIG. 2 (having an interior diameter of about 25 μm and comprising fused silica tubing tapered to a 3.5 μm internal diameter near a tapered end of the tip) with a gold-carbon coating according to the invention. An LCMS setup with such an analytical column 11 may operate at a flow rate of about 30 nl/min. It is highly recommended to validate the chromatographic systems prior to the analysis of the peptide sample.

In an embodiment a tandem mass spectrometer 12 is used. The mass spectrometer is able to operate at a mass resolution of at least 10,000 FWHM. Mass spectra should be acquired in profile continue mode at a scan rate of at least 0.9 sec/scan. The accuracy of the mass determination should be 100 parts per million or better.

Sample constituents may be separated based on several physical, chemical or other specific properties of the analytes, like their molecular size, polarity, charge and others. In embodiments combinations of several methods (several types of chromatography), e.g. by size exclusion chromatography, ionic interactions, or ion exchange chromatography, specific molecular interactions (e.g. antibody-antigen) and the like, are combined. Also several of such chromatographic methods may be used to fractionate the sample.

The separation efficiency is significantly increased by employing SCX chromatography as the first dimension, which is orthogonal to the reversed phase chromatography, being used as the second dimension. Best performance in two-dimensional LCMS (2D-LC/MS) is obtained in an offline mode of operation as it provides the highest degree of freedom in optimizing both separations system independently and it does preclude any compromise with respect to the separation efficiency. SCX chromatography is also important to remove any residual detergent or buffer components that might still be present in the peptide sample and may interfere during peptide elution. These compounds may elute from the SCX column in the void volume and hence, will appear in the first fractions that generally do not contain peptide.

The separation efficiency of the LC column can be expressed in the number of components that can be separated in a single run (i.e. peak capacity). The column separation efficiency is the quotient of the length of the column (L) and the plate height (H).

According to Van Deemter (Van Deemter et al. 1956) the height of a theoretical plate (H) is proportionally dependent on the particle size (dₚ) of the stationary phase particles. Another parameter in the plate count is the flow rate of the mobile phase, which is a combined linear and hyperbolic function with an optimum linear velocity (near 1 mm/s). In an embodiment the column head pressure is controlled such that the mobile phase has a linear velocity of approximately this value.

The LCMS setup is known to the skilled person, and he will be familiar with the fact that numerous alternative setups are possible. The setup shown in FIG. 1 is merely an example of one of a large number of possible setups.

FIG. 2 shows the tip of an emitter 30 that is part of a schematically shown electro spray ionization unit 500. The unit 500, illustrated by dotted line, comprises a current source 501 connected 502 to the emitter 30, in particular connected to the coating.

The emitter 30 is connected to the end of an analytical column 31 using a connector 32. Connector 32 is shown only schematically. FIG. 2 shows a cross-section of the emitter 30 connected to the end 33 of the column 31. In the specific embodiment the connection between the emitter 30 and column end 33 is a butt connection. In a further embodiment a diamond cutter is used for preparing the distal end 33 of the column 31 and the proximal end 34 of the emitter 30 in order to allow a suitable butt connection between the column and the tip. The external diameter 36 of the column 31 is preferably in the range of 200-800 μm. The tubing may comprise fused silica. In the fused silica tubing, an internal cavity 37 is formed having an interior diameter 38, preferably in the range of about 10 μm to about 200 μm, more preferably between 15 μm and 50 μm.

Emitter 30 comprises a proximal end 34 to be connected to the column end 33 and a distal end 39 that has a tapered shape. The tapered end 39 has both a reduced external diameter and a reduced interior diameter.

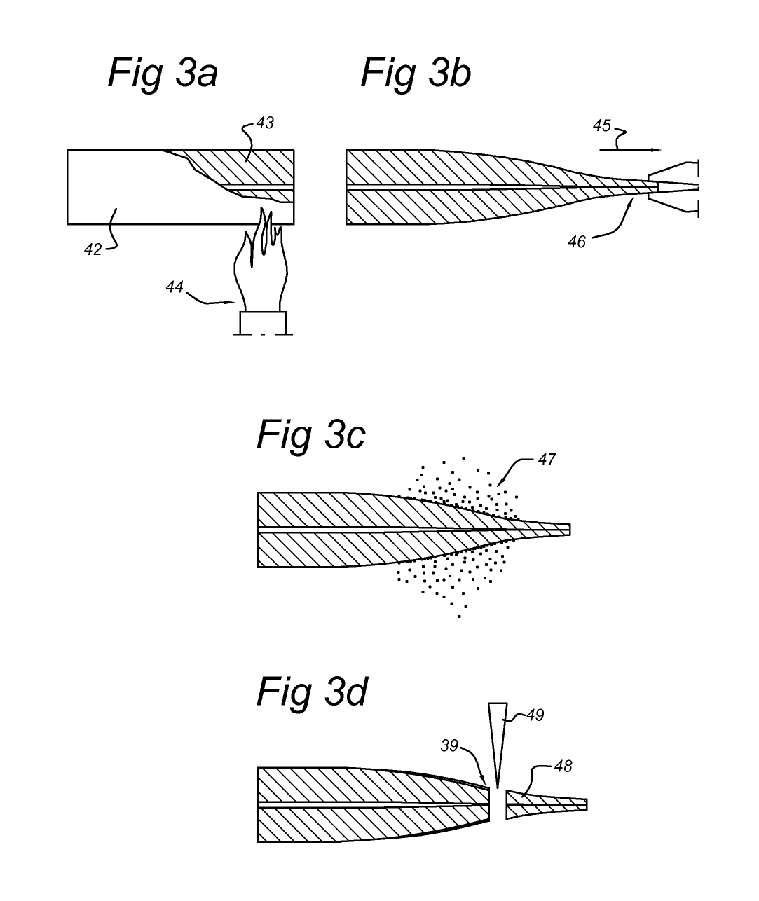

In FIGS. 3a-3d an example of a method for preparing the tip of an emitter 30 presented. In a first step as shown in FIG. 3a, the coating 42 of a fused silica tubing 43 is (at least partly) removed, for instance by using a butane torch 44. In a subsequent step, the heated end 46 of the fused silica 43 (by means shown schematically in FIG. 3b) is drawn in direction 45, causing the emitter 30 to be extended or elongated in said direction. The tubing is squeezed together, reducing the internal cavity and eventually closing it. Then the fused silica tubing is provided with a coating 47 on its external surface, allowing an electrical current to be conducted and to reach the tapered end 46 thereof allowing an electro spraying operation. The interior diameter 41 of the tip near its tapered end 46 is preferably in the range of about 2-30 μm, more preferably 3-10 μm. A smaller interior diameter will further increase the sensitivity of the subsequent mass-spectrometry.

In FIG. 3c the earlier-mentioned application of a coating on the tip is shown. In an embodiment a first coating comprising a precious metal such as gold is applied onto the tip 46. However, it has been shown that a gold coating deteriorates during electro spraying and is not able to provide a continuous electrical conduction during a prolonged period of time. Alternatively or additionally, a carbon-based conductive coating is applied onto tip 46. This coating can be applied onto the tip by a spraying process. In an embodiment the carbon is deposited using an aerosol or vapour deposition. The carbon particles could be suspended in isopropanol.

In an embodiment according to the invention the step of applying a coating can be repeated once or more than once. In an embodiment multiple coatings are applied on top of each other.

Preferably a combination of coatings is used for coating the tip. In an embodiment first a gold coating is applied and thereafter a carbon-based conductive coating. In a further embodiment a gold coating is applied first and then the gold coating is covered with a layer of carbon-based conductive coating. The layer of carbon-based conductive coating is applied by preparing 50 mg of Left-C™ carbon particles suspended into 1 ml of isopropanol and spraying the same on the emitter (i.e. on the tip). Leit-C-plast™ is an adhesive with high electrical conductivity and permanent plasticity and is available from Electron Microscopy Sciences (EMS), Hatford, UK.

In an embodiment a conducting oxidation resistant material is used as a further coating on top of a gold coating at the tapered end of the tip. In an embodiment a carbon-based conductive coating is used.

In another embodiment a silicon alloy is used.

In a further embodiment an electrical conducting polymer is used as coating according to the invention or as additional coating.

The additional coating can be adhered to the gold coating. The additional coating provides protection. In an embodiment the coating is sprayed on the tapered end of the emitter. In another embodiment the oxidation resistant coating is applied on the tapered end. A suitable solvent such as isopropanol is used for spraying. In another embodiment the slurry to be sprayed on the tapered end of the emitter contains 30-70 mg, in a preferred embodiment 45-55 mg conductive carbon cement into 1 ml of isopropanol.

In a subsequent step shown in FIG. 3d the closed end 48 of the emitter 30 is removed using a cutter 49, for instance a diamond cutter. The cutting results in a emitter 30 with a tapered end 39 having a reduced interior diameter. The combined effect of squeezing the tubing 43 and exerting a pulling force at the free end of the tubing 43, results in a smooth reduction of the interior diameter.

In an embodiment a connector for fused silica tubing is used for connecting the respective parts of the trapping column and/or analytical column. In a LCMS setup a three-way connector or T-connector is used for connecting the columns or valves. In prior art, a three-way connector of Upchurch® (in the art known as through-hole union from Upchurch Scientific, Oak Harbor, Wash.) is used. Preferably, the tubing consisting of fused silica having an outer diameter and an inner diameter, the inner diameter defining a cavity, is connected using such a connector. In a preferred embodiment the connector is a through-hole connector.

In an embodiment an LCMS device comprises a nanoscale column having an interior diameter of 25 μm. In an application using peptides, these peptides migrate through such a column in a concentrated band with volumes of typically 1 nanolitre or less.

In another embodiment connectors for nanoscale tubing are provided lacking a dead volume, and they are preferably suitable to be used at pressures over 400 bar (i.e. 4×10⁴ kPa).

In an embodiment the connector is an adapted Upchurch through-hole T-connector.

In an embodiment a T-connector comprises at least one, possibly two ferrules and preferably three ferrules. A tubing and in particular a microcapillary nanoscale column can be received in a cavity of the ferrule. This will allow mounting of the tubing in a inner volume of the connecting element. The ferrule cavity is of suitable size. The ferrule cavity is a through cavity having an inner diameter generally equal or close to the outer diameter of the tubing to be received in the ferrule cavity. The ferrule cavity will have frictional contact with the outer diameter of the tubing of the inserted tubing.

The ferrule in combination with the connector is used to align the cavity of the tubing with a cavity of the connecting element. The connecting element comprises a receiving cavity for fitting the ferrule, wherein the fitting cavity and the ferrule cooperate and are disconnectable. In a connected state, the ferrule will position the tubing having an inner cavity with respect to an inner cavity of the connecting element. Preferably the connecting element comprises two ferrule fitting cavity combinations. In current Upchurch designs, the inner volume of the connector comprises a dead volume.

In respect of current Upchurch designs, the inner cavity is very much enlarged. This is contrary to the known skills of the skilled persons.

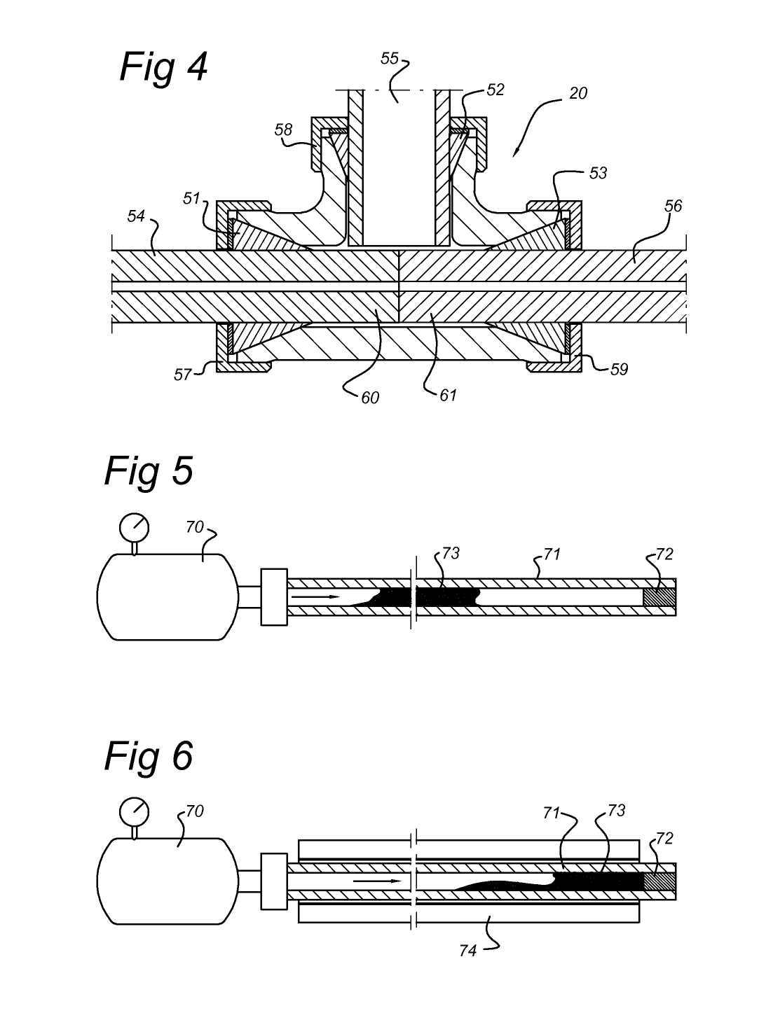

FIG. 4 shows a detail of a three-way connecting or switching element 20, 21 of the setup 1 according to FIG. 1. The figure is not to scale. More specifically, the ratio of diameters of the elements shown is not limited to the ratio shown.

The three-way connecting element 20 comprises three ferrules 51-53. The ferrules are bodies that fit in a receiving cavity at the three ends of the three-way connector 20. In an embodiment the three ferrules have a different size. The fitted ferrule may self-align in the cavity due to its shape that essentially corresponds to the shape of the cavity. More specifically, in the in the embodiment shown, the ferrule may have a conical form corresponding to a conical form of the cavity. The self-alignment will allow bringing the receiving cavity of the ferrule in a predetermined position with respect to the connecting element 20.

The ferrules 51-53 may comprise a cavity. The outer diameter of a tubing 54-56 and the inner diameter of the cavity are adapted to enable the ferrule to receive any tubing 54-56 in its cavity.

Ferrules 51-53 are shown in a connected state, received in respective cavities of the connecting element 20, 21. A cap 57-59 is provided, the cap comprising a fixing system (not shown in detail) for fixing the cap 57-59 to the connector and thereby fixing the position of the ferrules 51-53. In an embodiment the fixing system comprises a locking system, for instance a screwlike connection. The fixing system can also be constructed and arranged for fixing and clamping the ferrule 51-53 in the connected state, resulting in a clamping force being exerted on the outer diameter of the tubings 54-56. This causes the tubing 54-56 to be locked in their respective positions.

The connecting element 20, ferrules 51-53 and caps 57-59 may be manufactured with various manufacturing techniques, especially by injection moulding.

The tubing 54,56 are in a state wherein they are received in the ferrule and the ferrule is connected to the connecting element, substantially in alignment. This means that the inner cavities of the tubing 54,56 are substantially aligned as well.

In another embodiment, the inner volume of the connecting element, preferably the inner volume of a T-body for a connector, is aligned with the cavity of the ferrule for receiving the tubing. In such an amended connecting element, preferably an Upchurch element wherein a part of the inner body of the connecting element has been removed by drilling, now a connecting element is provided that allows tubing to be aligned at two respective lateral ends of the connecting element and the tubing can be positioned with their ends in abutment within the connecting element, that is within the inner cavity of the connector, preferably the three-way connector.

In the shown embodiment, the ends 60,61 of fused silica tubing 54,56 have been cut using a diamond cutter in order to get a straight cut allowing the tubing 54,56 to be in abutment in the connected state of the ferrules 51,53. This prevents the presence of dead volumes within the body of the connecting element 20. Despite the abutting connection, liquid from within the tubing 54,56 can leak through the abutting ends, allowing passage of liquid through tubing 55.

In another embodiment the connecting element comprises a fixing element for fixing the ferrule with respect to the connecting element. In an embodiment the fixing device comprises clamping means. In an embodiment clamping the ferrule will result in clamping the tubing in place that is received in the ferrule. The fixing device is constructed and arranged to fix the tubing as well as the ferrule in position.

In a further embodiment two pieces of a tubing are connected in a three-way connector wherein the in- and out-ports of the connecting element are positioned in a straight line, and a third connector is connected perpendicular to this straight line. The tubing is positioned in the butt connecting position, and this abutting connection does not have to be centred exactly in the middle of the connecting piece since the third connector has a connecting channel and the leaking volume is able to reach this connecting channel due to the high pressures used in liquid chromatography.

FIGS. 5 and 6 show a pressurized vessel or bomb 70. The bomb 70 can contain a suspension of chromatographic particles, preferably a vial containing suspended chromatographic stationary phase.

In an embodiment the tubing is heated, e.g. by placing the tubing in a temperature programmed oven. Preferably a programmed temperature is used. In an embodiment an initial temperature is set at 30° C. continued for 5 min, followed by an increase to 100° C. in 15 min, and this temperature is maintained for 5 hours. Subsequently, the frit and tubing is cooled down to ambient temperature. Thereafter the hardened frit and fused silica is cooled down to room temperature. Next, trim the ceramic frit formed to a length of approximately 1-2 mm using a fused silica cutter. Preferably a straight cut is applied.

In another embodiment a nanoscale LC column is manufactured and provided by packing the column. A method of packing the column comprises preparing a particle retaining frit in fused silica (FS) tubing. The tubing is cut to have a desired length. In a specific embodiment a mixture of potassium silicate solution (also called KASIL herein) and formamide in a ratio of 90/10 (v/v) is provided. The mixture is shaken vigorously. In an embodiment a vortex mixture is used e.g. for 10 s. Preferably immediately thereafter, the fused silica is dipped in this mixture for short period of time (not critical, e.g 1 s) to allow a plug of a few cm of length of the mixture to be sucked into the tubing.

In an embodiment packing the LC analytical column comprises mounting a fused silica tubing provided with a frit into a pressurized vessel (bomb). The pressurized vessel can contain a slurry of desired particles. Preferably, a ferrule is used for mounting the tubing to the pressurized vessel. Preferably, a connection part according to the invention is used for connecting the tubing in the pressurized vessel.

Preferably, a vibrating element 74 is used to bring a complete column in vibration. In an embodiment of the method according to the invention a column is vibrated at least two positions over the length of the column. In an embodiment at least two frequencies, preferably ultrasonic frequencies are used for vibration.

In a specific embodiment the fritted end of the fused silica column is placed into an ultrasonic bath (e.g. Branson 200). In a further embodiment the ultrasonic treatment is carried out only after solid phase particles are flushing into the fused silica column.

In an embodiment of the method of packing a column, a highly concentrated (thick) slurry is used. Use of a slurry is a most convenient way to pack narrow (25 μm ID) and extended length columns.

In an embodiment the slurry contains at least 150 mg reversed phase particles suspended into 1 ml of acetone. The linear velocity of acetone versus isopropanol through the column during packing equals a surprising factor of 7±1.

In another specific embodiment of manufacturing a packed column, a fitted FS tubing is placed (frit up) through a ferrule with a hole of 0.5 mm into a slurry of desired particles in a pressurised vessel. The ferrule is connected to the vessel. Next, the secondary pressure of the reducer mounted onto an e.g. helium cylinder is adjusted to approximately 50 bar and apply the pressure to the bomb e.g. by opening a valve (e.g. a Swagelok SS-41GSX2 valve).

Once the column is ready, the compactness of the packing is visually inspected using a binocular (25×). Before use, flush the column with acetonitrile/water (85/15, v/v) plus 0.1 M acetic acid at a pressure of 250 bar using an HPLC pump.

Preferably the column is tested before use. The backpressure (bar/cm) of the column can be checked. Place a sleeve (interior diameter 0.4 mm) at the fritted end of the column. Measure the displacement (mm) of the meniscus in the sleeve for 1 min. The volume follows from:

flow rate (nl/min)=displacement (mm)×100(nl/mm).

Read the pressure on the pump and calculate the normalised pressure drop (P_{b}, bar/cm of column length) across the column:

P_{b}=[time/volume]×[(ID/50)²×125]×P/L

where “time” is the period of time of flow measurement in minutes, “volume” is the collected volume in nl, “ID” is the column interior diameter in μm, “P” is the column head pressure during flow measurement in bar, and “L” is the length of column in cm.

A fused silica tubing 71 is provided and a porous ceramic frit 72 is formed at one end of the tubing 71. The other end is connected to the high pressure vessel 70. The high pressure will bring part of the suspended particles into the cavity. During the flow of particles into the cavity, an ultrasonic vibrating element 74 can be used to vibrate the column or parts of the column 71 in order to prevent the formation of void volume in the particles. In an embodiment, the vibrating element 74 is positioned near the congestion of material in the column.

In case a downstream obstruction occurs, the column can be lifted up and out of the slurry (but still in vessel) and flush the liquid out to dryness. Subsequently, the FS is placed back into the slurry and the packing process is resumed until the desired bed length is obtained.

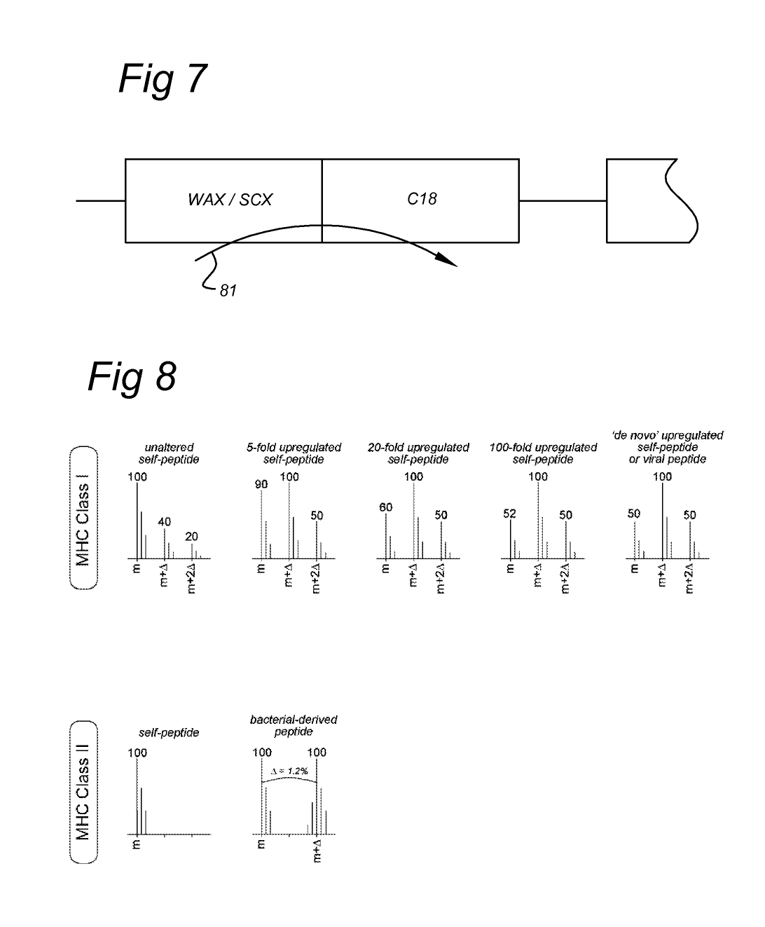

FIG. 7 schematically illustrates two dimensions of a liquid chromatography application to be used in combination with one of the embodiments according to the invention. As a first dimension, Strong Cation eXchange (SCX) and in the illustrated embodiment a mixed bed of SCX and Weak Anion eXchange (WAX) resins are used. The mixed bed of anion and cation exchange particles, such as described by Motoyama (Motoyama et al. 2007) is preferred.

A second dimension could be C18 reversed phase (RP) chromatography as illustrated.

The compatibility of SCX and reversed phase chromatography is poor, particularly in conjunction with the use of a cationic solvent, buffer or medium. According to an embodiment of the invention a solvent medium 81 is used such as formic acid or hydrochloric acid (HCl). Although the elution strength of these media is lower, especially formic acid shows a high efficiency in the recovery of bound peptides to the Anion-Cation Exchange (ACE) resin.

In an embodiment multidimensional LCMS/MS analysis of proteolytic digested proteins, where SCX fractionation was used in conjunction with RP separations. The analysis techniques are coupled to increase the separation efficiency and dynamic range of the analysis. In an embodiment an online multidimensional LC method using a mixed bed of anion- and cation exchange particles for the first separation dimension is provided.

In an embodiment a mixed ion exchange bed according to Motoyama (Motoyama et al. 2007) is used.

In an embodiment of the LCMS device samples are fractionated in an online fashion. Preferably a two-dimensional chromatography is constructed and arranged in the LCMS device. Preferably at least one of the separation mechanisms utilizes the hydrophobic properties of the sample constituents. In a further embodiment at least one of the separation mechanisms used is SCX, which is preferably used for the fractionation of a HLA-DR elution sample.

In an embodiment orthogonal fractionation is used. In a preferred embodiment SCX fractionation is used. In a combined setup the total analysis time can be readily increased by typically 15 times. The SCX dimension can be used both in an online and an offline manner.

SCX resin comprises particles with strongly negatively charged groups at the particle surface, allowing to bind positively charged molecules. SCX resins are capable of holding (retaining/binding) positively charged peptides.

Usually, bound molecules are released/recovered by displacing/eluting by means of flushing the resin with a (continuous/discontinuous) gradient of a suitable aqueous cationic salt solution of increasing strength. Because of the gradient, molecules that are only loosely bound will let go more rapidly than strongly bound molecules. This yields the desired separation of the complex samples.

The second dimension can be reversed phase chromatography. In an embodiment a second separation step preferably comprises C18 RP chromatography. In an embodiment a C18 reversed phase of the LCMS device comprises a mixed anion and cation exchange solid phase extraction trapping column.

The orthogonality between SCX and RP separations is due to the fact that SCX uses electrostatic interactions to retain peptides. In practice, retention in SCX peptide separations is a combination of electrostatic (main) and hydrophobic (sub) interactions, the latter of which results from the hydrophobic nature of a sulfonyl polymer backbone. This “mixed-mode” property has been recognized as one of the reasons why SCX can separate structurally similar peptides possessing the same net charge.

The orthogonality between ion exchange (IEX) and RP separations is based on electrostatic interactions and hydrophobicity. In practice, retention in IEX peptide separations is a combination of electrostatic (main) and hydrophobic (sub) interactions, the latter of which results from the hydrophobic interaction with silanol groups at the silica particle surface nature. This “mixed-mode” property has been recognized as one of the reasons why IEX can separate structurally similar peptides possessing the same net charge.

Preferably the LCMS method comprises a step of fractionating using weak anion exchange (Poly WAX LP™, The Nest Group, Inc. 45 Valley Road Southborough, Mass. 01772-1323 also called WAX herein). The WAX particles comprise in a preferred embodiment a layer of a cross-linked coating comprising positive cation particles. More preferably, the WAX particles comprise silica-based materials cross-linked with linear polyethyleneimine.

The LCMS device preferably comprises an ACE solid phase extraction column as a first dimension allowing the recovery of bound peptides.

In an embodiment peptide elution in SCX can be accomplished using volatile organic salts such as ammonium acetate. Ammonium acetate in acetic acid has been proposed as a suitable solvent medium for separating the peptide from the ACE column.

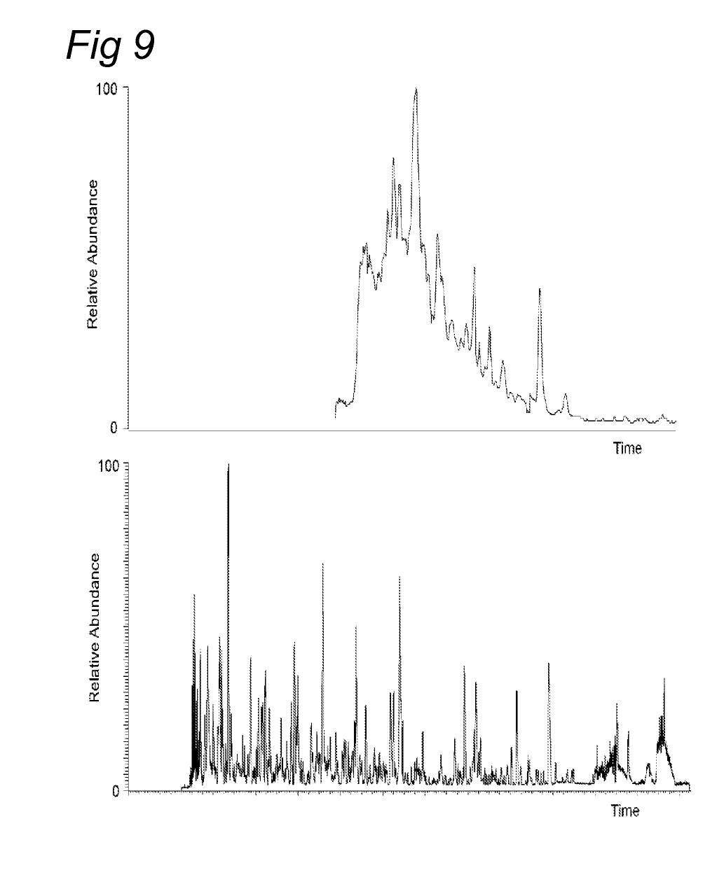

FIG. 8 is a schematic representation of the mass spectral recognition patterns for the allocation of a T cell epitope, presented by MHC class I or MHC class II molecules. Upper panel: MHC class I-associated peptides are characterized by their binomial mass spectral isotope distribution, due to the incorporation of the native and isotope-labelled amino acid residues (present in equimolar amounts in the culture medium during the infection). The degree of upregulation of self-peptides can be calculated based upon the intensity ratio of the monoisotopic masses of the native epitope (m) and the singly labelled epitope (m+Δ). For de novo synthesized proteins and pathogen originating proteins, the theoretical isotope patterns will show an exact binomial distribution. Theoretical isotope distribution patterns for epitopes containing up to 2 labelled amino acid residues are given in the upper trace: an unaltered expression and a 5-, 20-, and 100-fold upregulated expression of self-peptides and for the de novo upregulated self- or viral peptides after infection. Lower panel: MHC class II-associated peptides that originate from the pathogen can unambiguously be distinguished from the self-peptides, based on their characteristic mass spectral doublets as described in Experimental Methods II.

FIG. 9 presents the LCMS base peak ion traces from an unfractionated HLA-A2 ligandome derived from MV-infected WH cells, obtained after employing the standard LCMS technology as described in Experimental Methods I (top trace) and after employing the Platform LCMS technology (bottom trace).

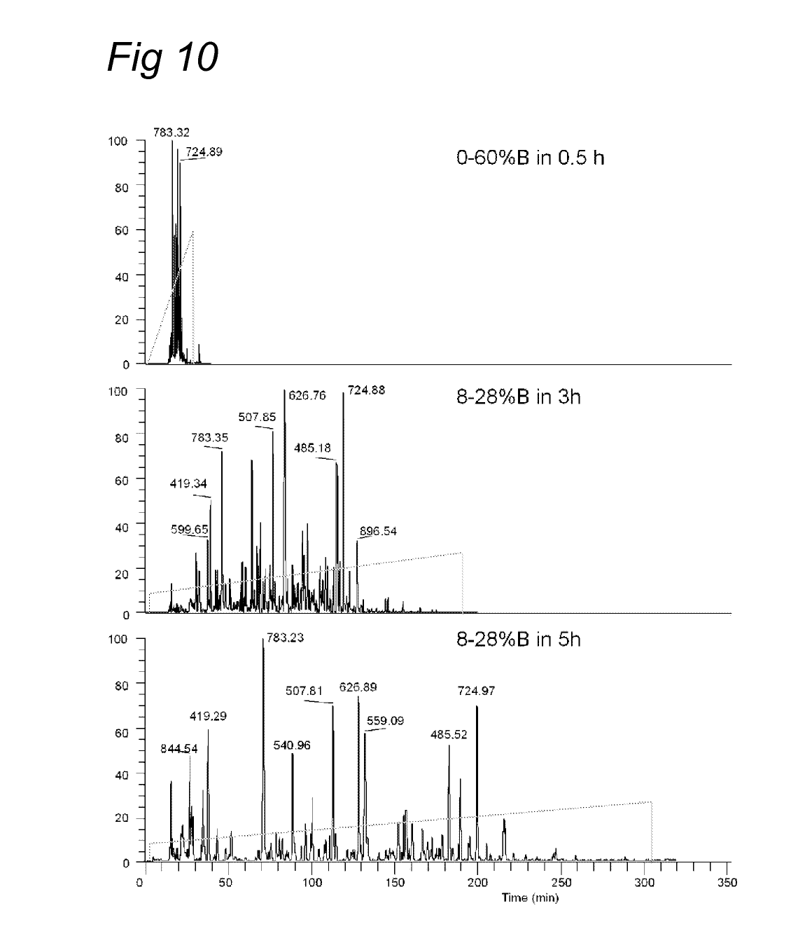

FIG. 10 illustrates a utility of high quality nanoscale LC technology in complex sample analysis. Separation of tryptic peptides on a 90-cm long C18 column (50 μm ID, d_{f}=5 μm) using different gradient profiles, ranging from increments of the organic modifier acetonitrile of 2%/min (top trace), to 6.7% acetonitrile per hour (middle trace), and to 4% acetonitrile per hour (bottom trace). The peak-width-at-half-maximum (FWHM) increases from 3 to approximately 30 sec. The peak capacity increases from approximately 300 in the steep gradient (top trace) to approximately 900 in the shallow gradient (bottom trace). The increasing duty cycle (elution window as percentage of the run time) and the extended presence of compounds in the MS source, allow for the comprehensive data dependent-multistage LCMS analysis of low abundant peptides (i.e. peptide mining).

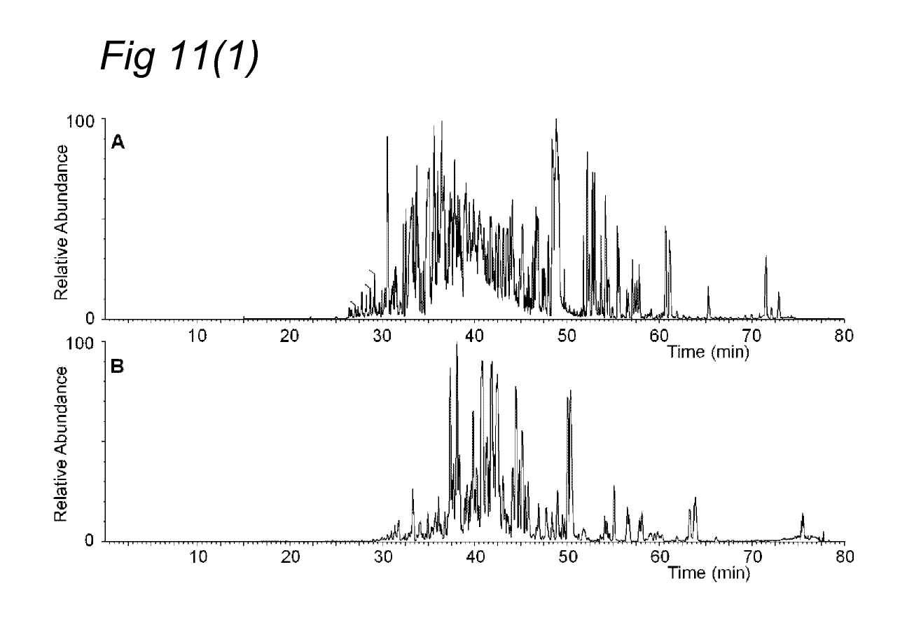

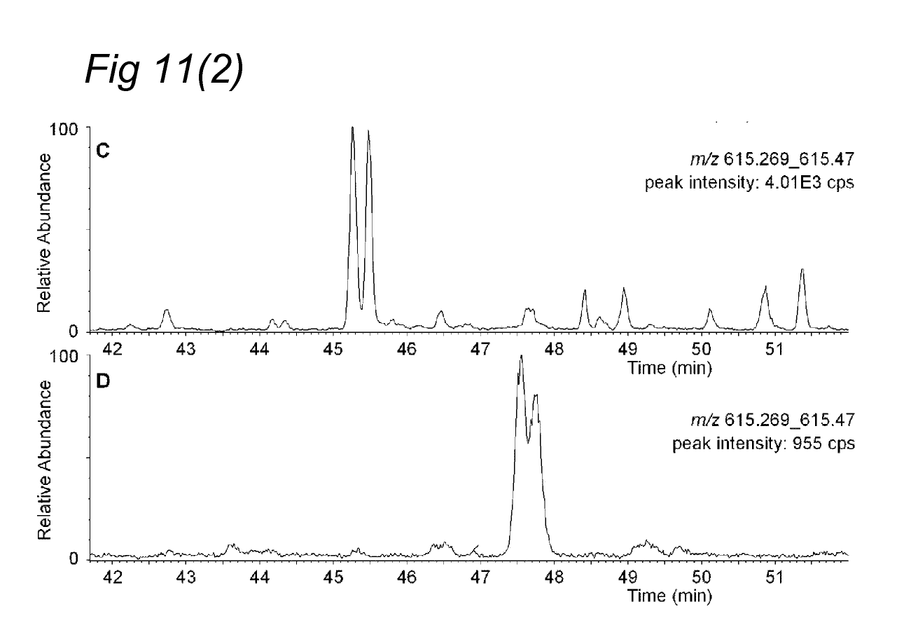

For FIG. 11 a complex MHC class II ligandome from human MDDC was analyzed on a 25-μm ID column (trace A, base peak ion trace) and a 50-μm ID column (trace B, base peak ion trace), packed with 3-μm and 5-μm C18 particles, respectively, using identical gradient slopes. Solid phase parameters determine LCMS performance in MHC class II ligandome analysis. The 25-μm ID column shows a significantly improved LCMS performance in terms of sensitivity and peak resolution. Traces C and D illustrate the difference in LC performance in detail of two isobaric peptides in this sample (i.e. non-identical peptides sequences, but with identical masses of [M+2H]²⁺=615.4 Da) on a 25-μm ID and a 50-μm ID column, respectively.

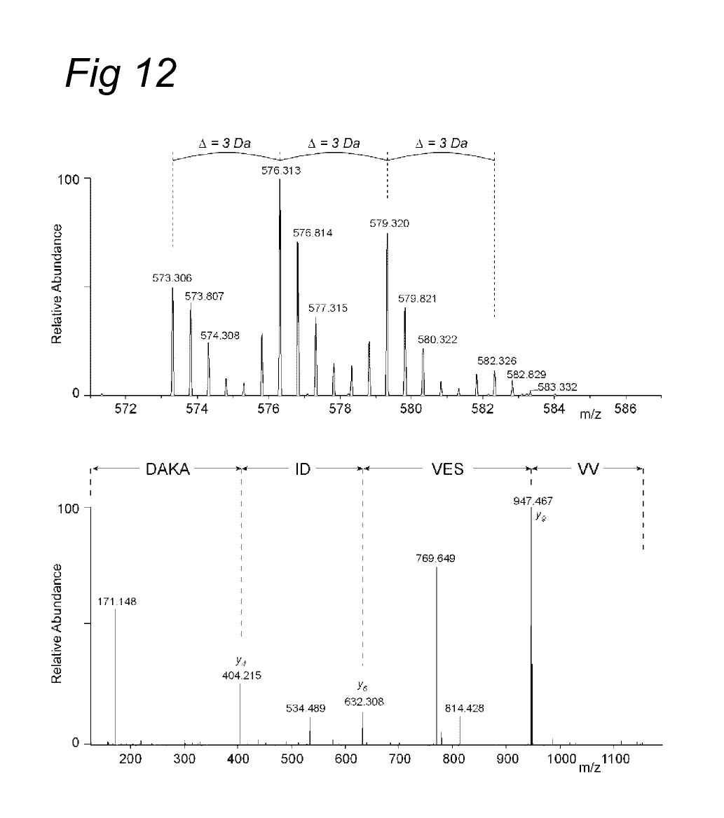

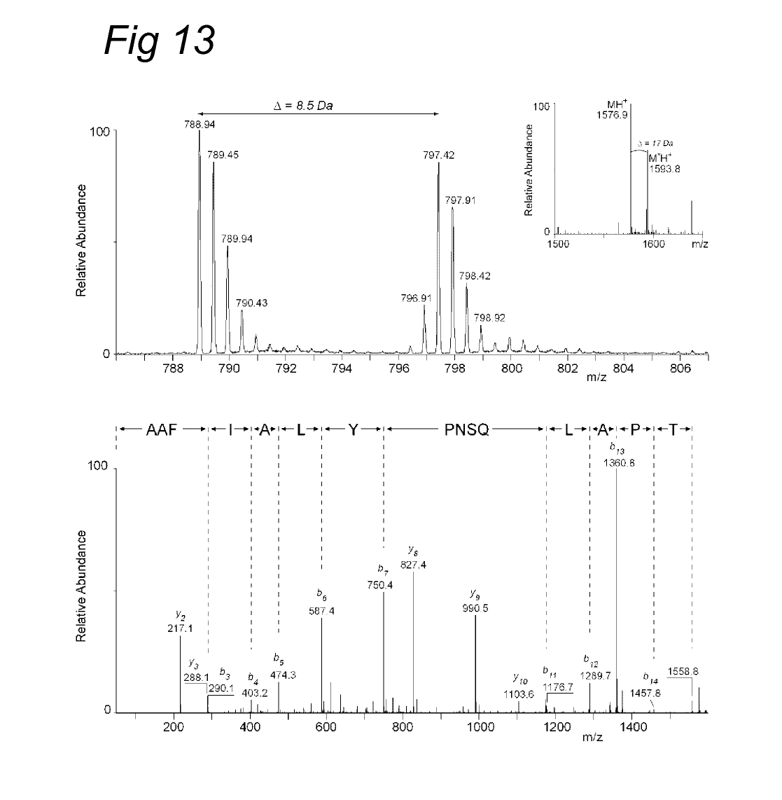

For FIG. 12 the HLA-A2 ligandome isolated from human MDDC after infection with influenza virus and the use of stable isotope-labelled amino acids as described in Experimental Methods I (approach C), was subjected to LCMS analysis. The upper trace shows a doubly charged upregulated epitope, visualized by an almost binomial distribution of the isotope pattern. Three labelled residues are incorporated in the epitope. The MS/MS spectrum of this peptide obtained at m/z 573.3 Da (lower trace) reveals the peptide sequence (based on the y-type ions series and accurate mass measurements) as VVSEVDIAKAD. This particular experiment has been carried out using leucine (L), valine (V) and methionine (M) as labelled residues in the culture medium during the infection. The three labelled residues in this peptide were all valines (V). The degree of upregulation of this epitope can be calculated based upon the mass spectral intensity ratio of the monoisotopic mass m of the native epitope at m/z 573.306 Da and the monoisotopic mass [m+3] of the singly labelled isomer at m/z 576.313 Da (see Experimental Methods I). For this particular epitope, the degree of upregulation due to the influenza virus infection equals 16.

For FIG. 13, the HLA-DR2 ligandome isolated from human MDDC after pulsing with ¹⁴N- and ¹⁵N-labelled B. pertussis whole cell preparations, as described in Experimental Methods II (approach D), was subjected to LCMS analysis. The top panel shows the ESI mass spectrum, containing the doubly charged mass spectral doublet at m/z 788.94 Da and 797.42 Da. The inset illustrates the deconvoluted mass spectrum indicating a candidate B. pertussis peptide containing 17 nitrogen atoms. The MS spectrum complies with the general criteria for a positive allocation of a bacterial originating epitope using the stable isotope approach (see text). The lower panel shows the deconvoluted MS/MS spectrum of this peptide at m/z 788.94 Da, revealing the sequence (b-type ions series) of the Putative Periplasmic Protein (accession nr. CAE43606) originating peptide AAFIALYPNSQLAPT.

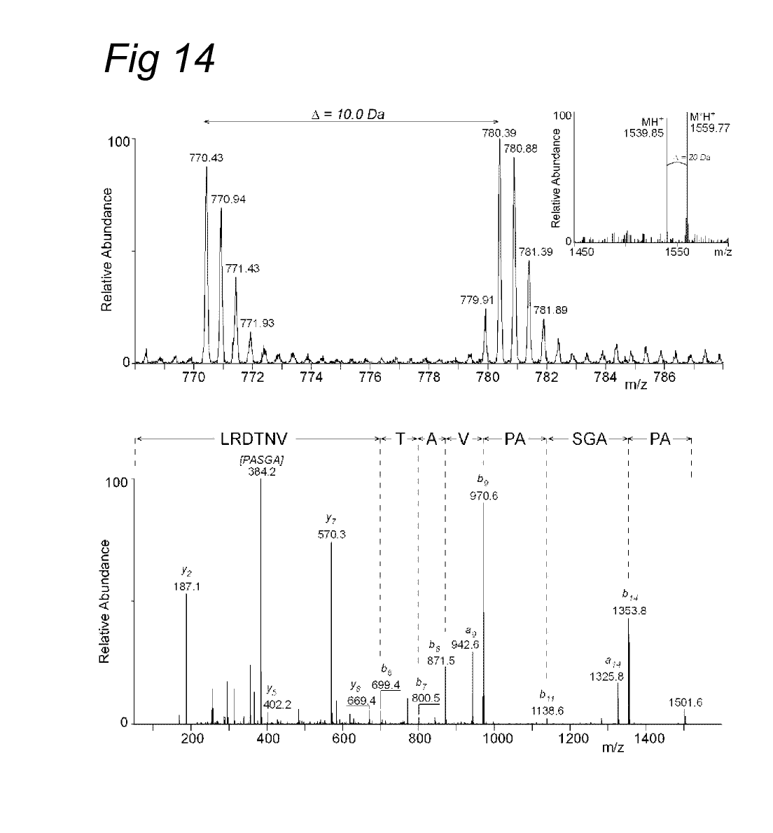

For FIG. 14, the HLA-DR ligandome isolated from a heterogeneous mixture of various human MDDC after pulsing with ¹⁴N- and ¹⁵N-labelled B. pertussis rP.69 Prn1, as described in Experimental Methods II (approach E), was subjected to LCMS analysis. The top panel shows the ESI mass spectrum, containing the doubly charged mass spectral doublet at m/z 770.43 Da and 780.39 Da. The inset illustrates the deconvoluted mass spectrum indicating a candidate rP.69 Prn1 originating peptide containing 20 nitrogen atoms. The MS spectrum complies with the general criteria for a positive allocation of a rP.69 Prn1 originating epitope using the mass tag-assisted approach (see text). The lower panel shows the deconvoluted MS/MS spectrum of this peptide at m/z 770.43 Da, revealing the sequence (b-type ions series) of the rP.69 Prn1 originating peptide LRDTNVTAVPASGAPA.

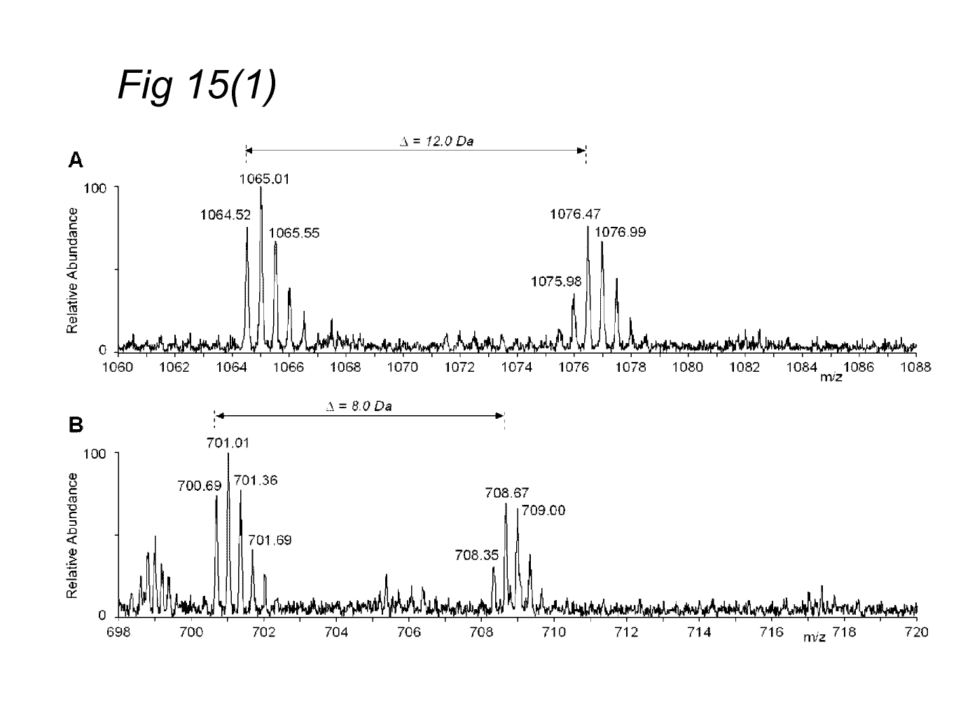

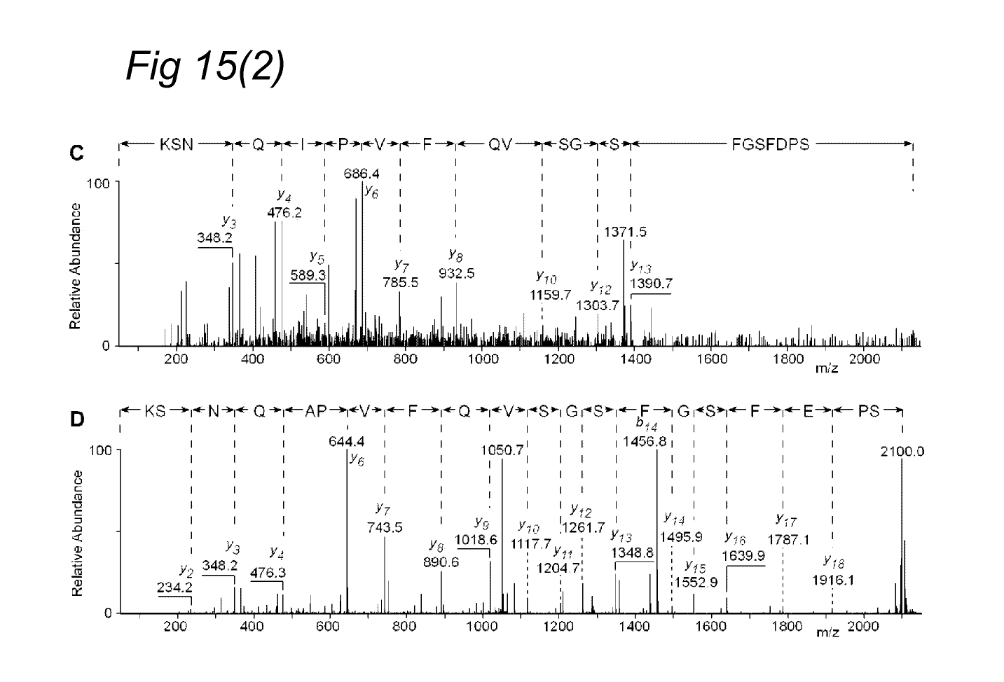

For FIG. 15, the HLA-DR1/P1.7-2.4 and HLA-DR2/P1.5-2.10 ligandomes, isolated from human MDDC after pulsing with different ¹⁴N- and ¹⁵N-labelled N. meningitidis OMV preparations as described in Experimental Methods II (approach F) were analysed by LCMS. Spectral doublets were detected by the search algorithm in both ligandomes for the HLA-DR1/P1.7-2.4 sample in trace A and for the HLA-DR2/P1.5-2,10 sample in trace B. MS sequencing led to the identification of a P1.7-2.4 derived epitope SPDFSGFSGSVQFVPIQNSK (trace B) and its P1.5-2.10 homologue SPEFSGFSGSVQFVPAQNSK (trace D). The residues at positions 3 and 16 of these epitopes are strain specific. The LCMS spectra comply with the general criteria for bacterial-derived epitopes using the mass tag-assisted approach (Experimental Methods II). Furthermore, the number of nitrogen atoms contained within each of the epitopes can be deduced from the LCMS spectra. The mass differences between the doubly charged mass spectral doublet in trace A (4=12 Da) and the triply charged mass spectral doublet in trace B (4=8.0 Da) show that each epitope contains 24 N-atoms. Indeed, both identified epitopes comply with these data.

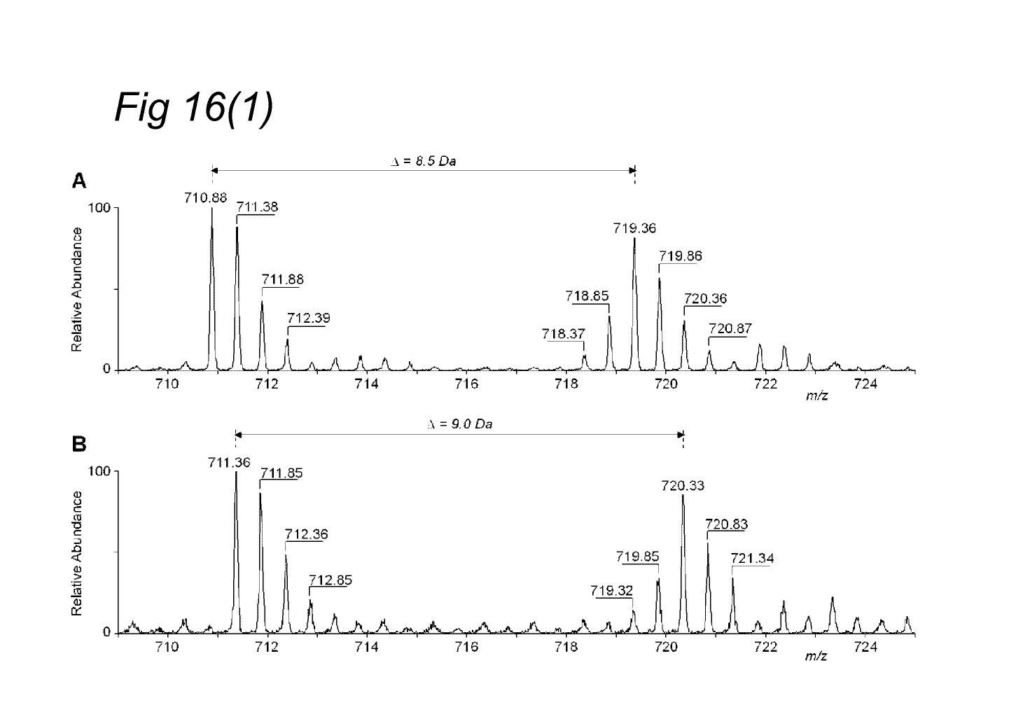

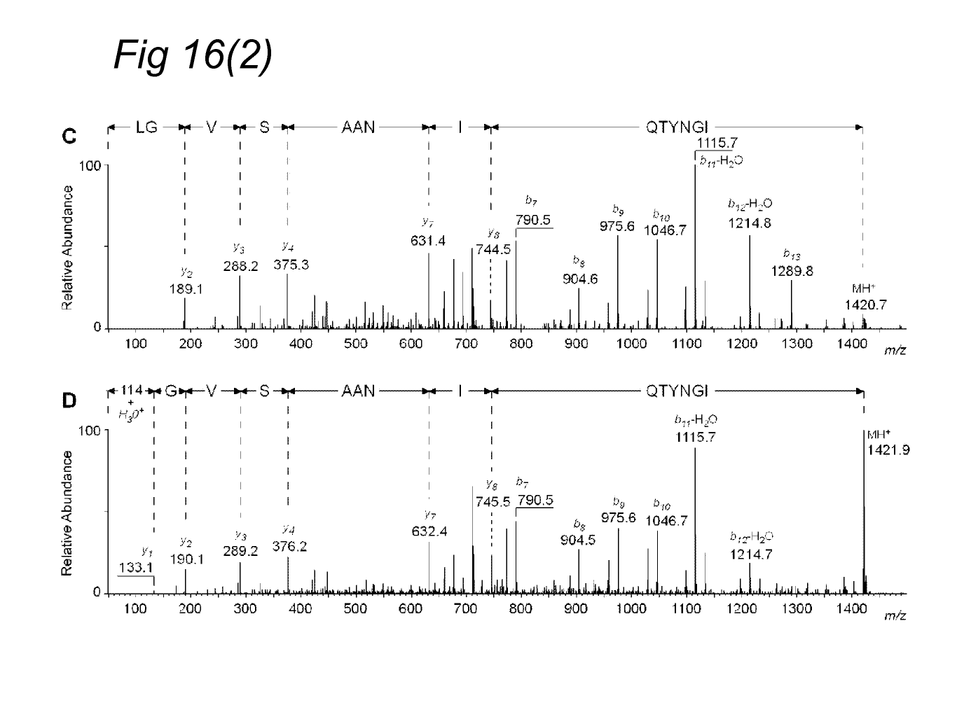

For FIG. 16, the HLA-DR1 ligandome, isolated from human MDDC after pulsing with a ¹⁴N- and ¹⁵N-labelled N. meningitidis P1.7-2.4 OMV preparation as described in Experimental Methods II (approach F), was analysed by LCMS. As one of a set of length variants representing region 8, the N. meningitidis P.1-7-2.4 originating epitope IGNYTQINAASVGL (traces A and C) was identified. At a 1% abundance of this native epitope, a doubly charged mass spectral doublet was detected representing the anomalous P1.7-2.4 derived epitope showing a striking similarity with the native epitope, except for the C-terminal amino acid residue that differs by only +1 Da. IGNYTQINAASVG-[+114 Da] (traces B and D) (note that the number of pathogen-derived nitrogen atoms contained in the anomalous epitope, as deduced from its ion pair, was 18, as opposed to 17 for the native epitope). As a result, the complete y-type ions series of the non-native epitope (D) shifts by +1 Da as compared to the native epitope (C), while the b-type ions series remains unaltered. The collective y- and b-type ion series of both heavy and light ions of the doublet indicate that this non-native epitope is a result of a protein slicing event of the pathogen-derived protein and the subsequent intramolecular ligation of distinct fragments of the same P1.7-2.4 molecule, resulting in a spliced MHC class II ligand.

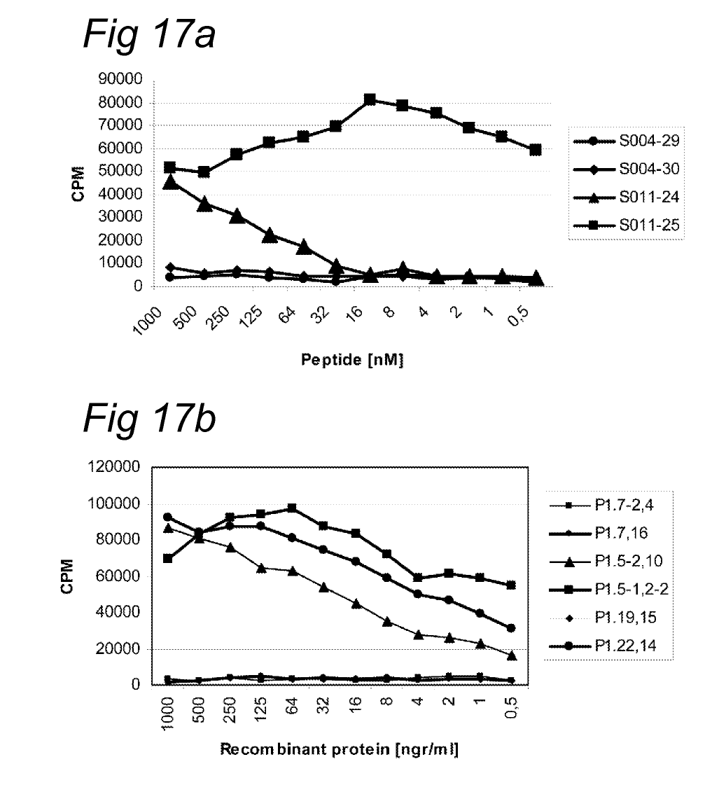

FIG. 17 illustrates differential recognition of P1.5-2.10 and P1.7-2.4 ‘region 4’ epitopes by human MB71.5 T cells. A: MB71.5 T cells, generated after in vitro restimulation (2×) of PBMC from donor MB71 with recombinant P1.5-2.10 protein, proliferated in the presence of autologous PBMC pulsed with synthetic peptides PEFSGFSGSVQFVPAQNS (S011-24) and SGSVQFVPAQNSKSAYTP (S011-25), but not with PDFSGFSGSVQFVPIQNS (S004.29) or SGSVQFVPIQNSKSAYTP (S004.30). B: MB71.5 T cells only recognize PorA variants expressing the alanine (A) in the C-terminal part of the ‘region 4’ sequence, i.e. P1.5-2.10, P1.5-1, 2-2 and P1.22.14, but not the isoleucine (I), i.e. P1.7-2.4, P1.7.16 and P1.19.15, respectively (see text in Results).

### EXAMPLES

### Experimental Methods I: MHC Class I Ligandomes

### Measles Virus, Influenza Virus and Respiratory Syncytial Virus

Plaque-purified Measles virus of the Edmonston B strain (hereafter MV) was grown in Vero cells. Influenza virus (A/Wisconsin/67/2005 strain) was grown in MDCK1 cells. Plaque-purified Respiratory Syncytial virus (RSV-A2 no. VR-1302, ATTC) was grown in hep-2 cells.

### Human B-Cell Lines WH and MB02 and Human Monocyte-Derived Dendritic Cells

The HLA-A*0201 expressing EBV-transformed B cell line WH and the HLA-A*0201, -B*0701 expressing EBV-transformed B cell line MB-02 were cultured in RPMI 1640 medium supplemented with antibiotics and 5% Fetal Bovine Serum (hereafter FBS, Harlan, USA).

Human Monocyte-Derived Dendritic Cells (hereafter MDDC) were cultured according to a procedure described by Sallusto (Sallusto et al. 1994). Briefly, 1×10⁹ PBMC were freshly isolated by density centrifugation with lymphoprep (Axis-shield, Norway) of a leukapheresis buffy coat obtained with informed consent from an HLA-A*0201, -B*0701 homozygous blood donor. PBMC were seeded at 5×10⁶/ml in 150-mm tissue culture dishes (Corning Costar, USA) in Iscove's Modified Dulbecco's Medium (GibcoBRL, USA) supplemented with antibiotics (GibcoBRL, USA) and 1% FBS at 37° C., 5% CO₂, in a humidified incubator, for 2 hr. After removal of the non-adherent fraction, adherent cells were further cultured for 6 days in medium containing antibiotics, 1% FBS, 500 U/ml recombinant human GM-CSF (PeproTech, USA) and 250 U/ml recombinant human IL-4 (Strathman Biotech, Deutschland). Culture medium and growth factors were refreshed on day 3. At day 6, MDDC were ready for viral infection. 1% Aliquots of MDDC, before and after virus infection, were characterised by flow cytometry to verify purity as well as maturation of MDDC (not shown).

### Peptide Synthesis

Synthetic peptides standards were prepared by solid phase FMOC chemistry using a SYRO II simultaneous multiple peptide synthesizer (MultiSyntech GmbH, Witten, Germany). The purity and identity of the synthesized peptides was assessed by reverse phase high performance liquid chromatography (HPLC).

### Experimental Approaches A, A′, B, C, and C′ Leading to Human Cell Batches Expressing a Virus Infection-Associated MHC Class I Ligandome

In approach A, 10⁷ tissue culture infectious dosis₅₀/ml MV stock was used to infect a B-cell batch of 2×10⁹ WH cells at a multiplicity of infection (hereafter m.o.i.) of 0.5, for 2 hours, in RPMI 1640 medium containing antibiotics and 1% FBS. Hereafter, cells were washed and left to grow for the duration of 40 hours to allow expression of the MV-associated MHC class I ligandome. Another cell batch of 2×10⁹ untreated WH cells was prepared, expressing the control MHC class I ligandome after culturing in standard medium. Both cell batches were harvested, washed, counted, pelleted, snap-frozen and stored at −70° C. before MHC class I ligandomes were prepared and analysed separately.

Similarly in approach A′, a 10⁸ tissue culture infectious dosis₅₀/ml Influenza virus stock was used to infect a B-cell batch of 3.5×10⁸ MB-02 cells at a multiplicity of infection (hereafter m.o.i.) of 5, for 1 hour, in RPMI 1640 medium containing antibiotics and 1% FBS. Hereafter, cells were washed and left to grow for the duration of another 9 hours to allow expression of the Influenza-associated MHC class I ligandome. The cell batch was harvested, washed, counted, pelleted, snapfrozen and stored at −70° C. before the MHC class I ligandome was prepared and analysed.

In approach B, 10⁷ tissue culture infectious dosis₅₀/ml of MV was used to infect a B-cell batch of 1.5×10⁹ WH cells at a m.o.i. of 0.5, for 2 hours, in RPMI-1640 medium containing antibiotics and 1% FBS. These cells were subsequently incubated for 40 hours to allow virus infection-associated MHC class I ligandome expression in RPMI-1640 medium without L-leucine and L-methionine (Invitrogen), supplemented with 5% FBS and—for 50% of standard concentrations of L-leucine and L-methionine—with stable isotope-labelled amino acids ¹³C₆-L-leucine and ¹³C₅,¹⁵N₁-L-methionine (each with a mass increment of 6 Da as compared to their unlabelled light isotopes; Cambridge Isotope Laboratories), and for the other 50% with unlabelled amino acids L-leucine and L-methionine (Sigma-Aldrich). These amino acids are dominant anchor residues of HLA-A2 ligands. RPMI-1640 medium containing 5% FBS and 100% of the unlabelled amino acids was used to prepare another batch of 1.5×10⁹ uninfected WH cells. Both cell batches were harvested, washed, counted, mixed at a 1:1 cell ratio and then pelleted as one single cell batch, snapfrozen and stored at −70° C. before the MHC class I ligandome was prepared and analysed.

In approach C, 7×10⁷ plaque-forming-units/ml influenza virus was used to infect a cell batch of 2.2×10⁷ HLA-A*0201 homozygous MDDC at a m.o.i. of 2, for 4 hours. These cells were subsequently incubated for 40 h to allow virus infection-associated MHC class I ligandome expression in RPMI-1640 medium without L-leucine, L-methionine and L-Valine (Invitrogen), supplemented with 5% FBS and—for 50% of standard concentrations of L-leucine, L-methionine and L-valine—with stable isotope labelled amino acids ¹³C₆-L-leucine, ¹³C₅,¹⁵N₁-L-methionine and ¹³C₅,¹⁵N₁-L-valine (each with a mass increment of 6 Da as compared to their unlabelled light isotopes; from Cambridge Isotope Laboratories), and for the other 50% with unlabelled amino acids L-leucine, L-methionine and L-valine (Sigma-Aldrich). Another cell batch of 2.2×10⁷ HLA-A*0201 homozygous MDDC was prepared, expressing the control MHC class I ligandome after culturing in standard medium. Both cell batches were harvested, washed, counted, mixed at a 1:1 cell ratio and then pelleted as one single cell batch, snapfrozen and stored at −70° C. before the MHC class I ligandome was prepared and analysed.

Similarly in approach C′, plaque-purified respiratory syncytial virus was used to infect a cell batch of 2.5×10⁷ HLA-A*0201, -B*0701 homozygous MDDC at a m.o.i. of 5, for 3 hours. These cells were subsequently incubated for 48 hours to allow virus infection-associated MHC class I ligandome expression in complete RPMI-1640 medium. The cell batch was harvested, washed, counted, pelleted, snapfrozen and stored at −70° C. before the MHC class I ligandome was prepared and analysed.

Isolation of MHC class I Ligandomes

Cell batches, grown according to experimental approaches A, A′, B, C or C′ were thawed and lysed for solubilization of MHC class I molecules and subsequent isolation of viral infection-associated MHC class I ligandomes. Briefly, the cells were lysed in a TRIS-HCl buffer containing 1% CHAPS (Roche) and protease inhibitors at pH=8.0. After centrifugation, the supernatant was passed in succession over three CNBr-activated TRIS-blocked Sepharose columns: the first non-immunoglobulin-coupled (i.e. preclear 1), the second coupled with normal mouse immunoglobulin (i.e. preclear 2) and the third coupled with specific mouse antibodies specific for human MHC class I molecules (i.e. clear). In one example mouse antibodies reactive with HLA-A2 molecules (Clone BB7.2) were used, in another example mouse antibodies reactive with HLA-B molecules (Clone B1.23.2) were used. The MHC class I molecules and associated peptides retained on the clear column were eluted with 10% (v/v) acetic acid and passed over a 10-kDa molecular weight cut-off membrane filter. The filtrate was concentrated to ±10 μl using vacuum centrifugation and subsequently reconstituted in 5% formic acid and 5% dimethylsulfoxide to a final volume of 100 μl and stored at −70° C. until analysis. The peptide mixtures were spiked with known amounts of two synthetic peptide standards (Angiotensin-III and Oxytocin, Sigma-Aldrich, St Louis, Mo., USA) to correct for sample loss during the subsequent processing of the samples.

### Standard LCMS Technology

Peptide samples were analyzed by nanoflow liquid chromatography coupled to electro spray ionization-mass spectrometry (hereafter LCMS). Aliquots of peptide samples, representing ±10⁹ B-cells or 1−2×10⁷ MDDC, were loaded onto a standard nanoflow LC column switching system C18 precolumn, serially connected via a standard MicroTee tubing element to a 20-cm long analytical column, of 50 μm internal diameter (hereafter ID) packed with 5-μm C18 particles. The mobile phase used was a linear gradient at a flow rate of 125 nl/min of acetonitrile, from 100% A (water+0.1-M acetic acid) only to 60% of acetonitrile+0.1-M acetic acid in A in 55 min. Column tips were gold-coated and column head pressure was 150 bar. Mass spectra were recorded as ‘mass to charge ratios’ (hereafter m/z) every 1 sec on a mass spectrometer (Q-TOF, Waters Corp.) of at least a resolution of 10,000 Full Width at Half Maximum (hereafter FWHM) over a range of 300-1,500 Da (MS analysis).

For MS sequencing (MS/MS analysis) of candidate viral infection-associated MHC class I epitopes, mostly using a subsequent aliquot of the peptide sample, cycles of MS1 analyses were alternated by cycles of collision induced fragmentation on preselected masses or masses being most abundant at the time of elution into the mass spectrometer. MS/MS spectra were acquired at a scan rate of 1 sec/scan with a mass range of 50 to 2,000 Da and at a mass resolution of 5,000 FWHM. The optimal Collision Energy largely depended on the nature of the epitope and the type of mass spectrometer used and was optimized in these experiments. Interpretation of MS/MS spectra is either manually or using software tools, e.g. Mascot (Perkins et al., 1999 at www.matrixscience.com, Matrix Science Ltd., London UK), ProteinProspector (www.prospector.ucsf.edu, University of California, San Francisco, Calif., USA), BioWorks™ (Thermo Scientific, Waltham, Mass., USA) and/or ProteinLynx™ (Waters Corp., Milford, Mass., USA).

For semiquantification of identified epitopes, relative response factors were calculated by the intensity-amount of the synthetic analogue of the identified epitope divided by the mean of the intensity-amount of the standard peptides Angiotensin-III and Oxytocin. These factors were subsequently used for the semiquantification of the numbers of natural epitopes present in the cell batch.

### Identification of Candidate MV-Associated MHC Class I Ligands

In approach A, MS ion traces in MHC class I ligandomes derived from MV-infected and uninfected WH cells were compared, mass by mass. Standard to this procedure, abundant peptide ions present in both samples were used to assess small shifts occurring in μLC retention time. Peptide masses only occurring in the infected WH cells were sequenced and semi-quantified.

In approaches B and C, essential mass spectral information (defined by “mass values” and “intensity values”) was extracted from the MS spectra obtained from the MHC class I ligandomes and used for the algorithm search. First, simulated isotope patterns were calculated based on (i) the type and number of stable isotope labels used, (ii) the natural occurrence of these stable isotopes, (iii) the presumed maximum number of labelled amino acids incorporated in the epitope, (iv) the experimental design and (v) the charge state of the ions involved. Each individually simulated isotope pattern was mathematically moved along the mass axis of the MS spectrum.

FIG. 8, upper panel, depicts the simulated isotope patterns of viral and self-MHC class I ligands extracted from virally infected cell batches after use of two stable isotopes, described as in Methods in approach B. A viral epitope expressing e.g. methionine and/or leucine at two positions can be recognized by the relative ratio's of masses m (50), m+Δ (100) and m+2Δ (50), in which Δ is 6 Da for singly charged ions, typical for the three isotopic variants inherent to the labelling and cell mixing procedure in approach B (FIG. 8, upper panel, right pattern). Also, self-epitopes that remain unaltered or become upregulated during viral infection can be recognized by their own isotopic patterns (FIG. 8, upper panel, left four patterns). In addition, the degree of upregulation can be calculated, based upon the intensity ratio of the monoisotopic mass of the singly labelled isomer (I_{[m+Δ]}) and the native epitope (Iₘ), given the formula

$$Degree of Upregulation = {2}^{x} \cdot ( \frac{Intensity Ratio}{x - Intensity Ratio} )$$

where x represents the maximum number of labelled amino acids contained within the epitope. An upregulation of at least a factor of 2 was considered being significantly associated to the infection. Accordingly, isotope patterns were simulated for the usage of 3 labelled amino acids, such as in approach C. Matching isotope clusters were selected as candidate virus infection-associated MHC class I ligands for further LCMS/MS analysis.

### Platform LCMS Technology

For ‘peptide mining’ of virus infection-associated MHC class I ligandomes, several independent parameters of the LCMS system were modified to obtain a platform LCMS technology with a sensitivity being improved by one or more orders of magnitude, such that detection of e.g. MHC class I epitopes present at single copies per cell in batches of 10⁷-10⁸ cells would be enabled.

The platform LCMS technology consisted of a standard nanoflow LC column switching system C18 precolumn, serially connected via a modified MicroTee tubing element to a ≧90 cm long analytical column, of 25 μm ID densely packed with 3 μm C18 particles. The mobile phase used was a shallow linear gradient at a flow rate of 30 nl/min of acetonitrile, from 8% acetonitrile+0.1 M acetic acid in A (water+0.1 M acetic acid) to 28% acetonitrile in A in 240 min. Column tips were carbon-coated and column head pressure was ≧400 bar. Interpretation of the MS spectra, the subsequent MS/MS analyses and the semiquantification of epitopes were carried out as described for the standard LCMS technology.

Superiority of the Platform LCMS technology was analysed using peptide samples derived from a MV-infected WH B-cell batch described in approach A, an Influenza-infected MB-02 cell B-batch described in approach A′, and an RSV-infected MDDC cell batch described in approach C′ (as indicated later herein).

### Results I: MHC Class I Ligandomes

### Standard LCMS Technology Leads to the Identification of a Limited Number of HLA-A2-Bound MV Epitopes

MHC class I ligands were obtained as described from human WH cells after MV infection to identify MV associated MHC class I epitopes by the standard LCMS technology. Two HLA-A2 ligandome samples were investigated, one obtained following approach A (subtractive analysis), and one HLA-A2 ligandome sample following approach B (isotope labelling). In each approach, three candidate virus-associated MHC class I epitopes could be detected that were confirmed as MV epitopes after MS/MS sequencing (Table 1). As was published, standard LCMS technology allowed the identification of in total 4 different epitopes, containing the supradominant MV-C₈₄₋₉₂ epitope, that was found to be expressed at >100,000 copies per cell.

### Comparative Example

### Platform LCMS Technology Leads to the Identification of 10-15 Fold More MV Epitopes

Although the standard LCMS technology was able to support the identification and characterization of several, probably most abundant, viral epitopes at subfemtomolar range in complex MHC class I ligandome samples amongst thousands of chemically similar self epitopes, it was evident that with such state of the art technology a knowledge gap on important additional subdominant viral epitopes was going to be maintained.

We asked if rigorous modification in the LC part of the technology would create a platform LCMS technology allowing the detection and characterization of subdominant MHC class I ligands. FIG. 9 illustrates the typical LCMS peak performances on fractions of one single MV infection-associated MHC class I sample (as prepared in approach A) when using the standard LCMS technology (upper panel) or the platform LCMS technology containing several combined independent modifications, as described in Methods (lower panel). Online data dependent LCMS/MS sequencing of the lower LCMS run (platform technology) led to the identification of 39 MV-derived HLA-A2 ligands, representing 31 different epitopes (Table 2). Twenty-six epitopes of these naturally presented epitopes were novel MV epitopes, 3 were already identified using the standard LCMS technology (Table 1) and 2, although novel as quantified natural HLA-A2 ligands, were described in literature as a mouse and human MV CD8′ T cell epitope (Neumeister et al. 1998, Nanan et al. 1995). Hence, at least a factor 10 more epitopes were identified by platform modification of the standard LCMS method.

Additional Examples of Epitope Mining of MHC Class I Ligandomes from Other Viruses by Platform LCMS Technology

To further analyse its superiority, Platform LCMS technology was used to analyse MHC class I ligandomes prepared from other virus infected cell batches as described in approach A′ and C′. Six viral MHC class I epitopes were identified, which were not detectable by standard LCMS technology: four epitopes related to influenza virus infection and two epitopes related to RSV infection (Table 2).

### Epitope Mining of MHC Class I Ligandomes by Platform LCMS Technology is Caused by Several Independent Improvements of the LC Method

To appreciate the contribution of single modifications in the method on peak performance and peptide mining, the role of gradient steepness in combination with long columns and the influence of C18 particle size in combination with column ID were studied in separate supportive experiments. As is illustrated in FIG. 10 using a complex tryptic protein digest, the application of more shallow and extended gradient slopes in combination with a 90-cm long column increased the peak capacity and extended the peak widths of peptides in the chromatogram. This allows an extended presence of compounds in the MS source, facilitating the comprehensive data dependent multistage MS/MS analysis of low abundant peptides (peptide mining). As expected, a 4-times higher sensitivity of the LCMS system was obtained when using 3-μm C18 particles packed in a column of smaller ID (25 μm), as opposed to 3-μm C18 particles packed in a 50-μm ID column (FIG. 11, upper panels). Unexpectedly, the separation efficiency was also improved by the smaller ID column (FIG. 11, lower panels).

### Platform LCMS Analysis Allows Identification of Special Features of MV Epitopes

Important features of MHC class I ligands other than sequence information and diversity are length variation, abundance and possible PTM of epitopes. Table 2 illustrates that peptides of five different lengths were found among the MV-derived HLA-A2 ligands: 8-mers (n=2), 9-mers (n=21), 10-mers (n=9), 1′-mers (n=5) and 12-mers (n=2). Hence, 9-mers were most common and, according to the semiquantification data, the two most abundant peptide species, representing 26% and 18% of the MV-derived HLA-A2 ligandome, respectively, were 9-mers. The KLWESPQEI epitope, known as a supradominant epitope from earlier studies (Table 1), was underrepresented in this analysis. This was expected because a small HPLC fraction containing this special epitope only was selectively taken out of the sample for other research purposes. From 7 epitopes, 2 or 3 length variants sharing the same core epitope, were identified (Table 2).

In addition, epitopes RAN*VSLEEL from the Large Structural Protein, KLMPN*ITLL from the Fusion Glycoprotein FO precursor, and LSVDLSpPTV from the Hemagglutinin Glycoprotein (Table 2) were post-translationally modified epitopes, not deducible as such from the translated genome. Such modifications have not been described in literature for viral MHC class I epitopes.

### Identification of Virus Infection-Associated Upregulated MHC Class I Self Epitopes

As is illustrated in FIG. 8, not only virus-specific epitopes, but also de novo-induced or upregulated self-epitopes can be detected by combining the use of isotope labelling with the MHC class I isolation and LCMS technologies. The influenza virus infection-associated HLA-A2 ligandome was isolated from human MDDC, as described in approach C, and subjected to the standard LCMS technology. Isotope clusters matching the simulated isotope pattern of an upregulated peptide applying three labelled amino acids, were searched. FIG. 12 illustrates an example of an isotope cluster accommodating 3 isotope-labelled amino acids. The epitope was identified as VVSEVDIAKAD, derived from Human interferon-induced GTP-binding protein Mx1 (accession nr P20591). Six other upregulated self-epitopes were identified after influenza infection (Table 3). Although other self-epitopes have been reported as upregulated naturally presented MHC class I ligands after viral infections, the identified epitopes in this invention are novel and could specifically be related to influenza virus infection.

### Experimental Methods II

### MHC Class II Ligandomes Growth of Bordetella pertussis and Generation of a Whole Cell Preparation

Bordetella pertussis strain 509 was grown until stationary phase, either in native, ¹⁴N-containing minimal Bioexpress cell growth medium, or in 98%-enriched ¹⁵N-stable isotope-labelled minimal Bioexpress cell growth medium (Cambridge Isotope Laboratories, USA) both containing filtrated 0.15% lactic acid (Fluka, Switzerland) and 18.6 mM NaOH. After growth, both ¹⁴N- and ¹⁵N-labelled bacterial cultures were heat-inactivated by incubating at 56° C. for 30 min and concentrated 5 times in PBS by centrifugation at 2,000 g for 20 min and taking up the pellets in ⅕ volume of PBS. The optical densities of the ¹⁴N- and ¹⁵N-labelled whole cell preparations were measured at 590 nm and for the antigen pulse of antigen presenting cells a 1:1 mixture of these preparations was made based on these OD₅₉₀ values.

Preparation of Recombinant P.69 Pertactin from Bordetella pertussis.

E. Coli strain BL21-Codonplus (DE3)-RP (Stratagene, la Jolla, Calif.), containing plasmid pPRN1 encoding the extracellular domain of the B. pertussis P.69 Pertactin wild type variant P.69 Prn1 (accession nr AJ011091) (Hijnen et al. 2005) was grown at 37° C. at 250 rpm either in native ¹⁴N-labelled minimal Bioexpress cell growth medium, or in 98 atom % enriched ¹⁵N-labelled minimal Bioexpress cell growth medium (Cambridge Isotope Laboratories, USA), until the OD₅₉₀ reached 0.6-0.8. Subsequently, cultures were induced with 1 mM isopropyl-β-D-thiogalactopyranoside (IPTG), and incubated further for 4 hours. Induced ¹⁴N- and ¹⁵N-labelled bacteria were harvested by centrifugation at 5,000 g for 10 min at 4° C. and subsequently lysed using Bug Buster reagent (Novagen, Darmstadt, Germany). The cell lysates were treated with 5,000 U lysozyme and 125 U benzonase nuclease per gram of wet cell paste. Inclusion bodies were collected by centrifugation and were washed three times with 1:10 diluted Bug Buster reagent. The purified ¹⁴N- and ¹⁵N-labelled inclusion bodies were solubilized in 6M guanidine hydrochloride (GuHCl), 10 mM benzamidine, 1 mM EDTA, 100 mM NaCl, and 50 mM Tris.HClpH=8.8. Refolding of the ¹⁴N- and ¹⁵N-labelled rP.69 Prn1 proteins was initiated by rapid 50-fold dilution into the same buffer without GuHCl. Proteins were allowed to fully refold during overnight dialysis at 4° C. against 1 mM EDTA, 100 mM NaCl, and 50 mM Tris.HCl pH=8.8. Subsequently, the refolded proteins were dialyzed twice against 50 mM Tris.HCl pH=8.8, using dialysis membranes with a molecular weight cut-off of 50 kDa (Spectrum Laboratories, Rancho Dominguez, Calif.). The proteins were concentrated on an Amicon Ultra-15 concentrator with a 50-kDa cut-off (Millipore, Billerica, Mass.). Finally, 2 μg protease inhibitor (Roche, Penzberg, Germany) was added to 1 mg/ml of the concentrated proteins. For the antigen pulse of human MDDC, a 1:1 protein/protein mixture of the ¹⁴N- and ¹⁵N-labelled rP.69 Prn1 proteins was made, based on protein content as measured in a Bicinchoninic Acid (hereafter BCA) protein assay (Pierce Protein Research Products, Rockford, USA).

Growth of Neisseria meningitidis Isogenic Strains in Minimal Medium and OMV Preparation

Two class 3⁻, class 4⁻ isogenic strains of Neisseria meningitidis H44/76, expressing the serosubtypes P1.5-2.10 or P1.7-2.4 of the variable major outer membrane protein Porin A (hereafter PorA) (Peeter et al. 1996), respectively, were grown until stationary phase, either in native ¹⁴N-containing minimal Bioexpress cell growth medium, or in 98%-enriched ¹⁵N-labelled minimal Bioexpress cell growth medium (Cambridge Isotope Laboratories, USA). From these cultures, batches of ¹⁴N- and ¹⁵N-labelled outer membrane vesicles (hereafter OMV) were prepared and characterized according to Claassen (Claassen et al. 1996). For the antigen pulse of human MDDC, a 1:1 protein/protein mixture of the ¹⁴N- and ¹⁵N-labelled OMV batches was made, based on protein content as measured in a BCA protein assay (Pierce Protein Research Products, Rockford, USA).

### Expression and Labelling of Pathogen-Derived Proteins in Minimal Medium

For protein analysis of whole cell B. pertussis preparations, membrane complexes were prepared from small aliquots of the ¹⁴N- and ¹⁵N-labelled whole cell B. pertussis preparations. Bacterial cell batches were centrifuged at 7,000 g (15 min, 10° C.) and pellets were resuspended in 10 mM Tris.HClpH=8.0. These suspensions were sonicated on ice to disrupt cell membranes, centrifuged at 6,500 g (10 min, 10° C.) and supernatants were collected. Membrane fragments were spun down (40,000 g, 1 hour) and taken up in 1% sarcosyl in 10 mM Tris.HClpH=8.0. Membrane complexes were subjected to SDS-polyacrylamide gel electrophoresis (hereafter SDS-PAGE) and hereafter proteins were transferred to polyvinylidene difluoride membranes. The membranes were probed (western blotting) with monoclonal antibodies against known virulence factors Filamentous Hemagglutinin (1:500, clone 31E5), P.69 Pertactin (1:50, clone Pem4), Pertussis Toxin Subunit 1 (1:1,000, clone 151C1), Pertussis Toxin Subunit 4 (1:100, clone 1-227), and Fimbriae 2 (1:1,000, clone 21E7), all from the Netherlands Vaccine Institute, The Netherlands. Thereafter, the membrane was incubated with alkaline phosphatase-labelled anti-mouse IgG (1:5,000; SBA, UK), and the signal was detected using the ready to use AP conjugate substrate kit (Biorad, USA).

The efficiency of isotope labelling was investigated using P.69 Pertactin as a representative protein example. The ¹⁴N- and ¹⁵N-labelled 69-kDa bands were cut out of the gel after proteins were separated on SDS-PAGE. ¹⁴N- and ¹⁵N-labelled P.69 Pertactin and tryptic digests thereof were subjected to LCMS (P.69 Pertactin) and LCMS/MS (digests), respectively.

The integrity of proteins in ¹⁴N- and ¹⁵N-labelled rP.69 Pertactin preparations and of PorA in ¹⁴N- and ¹⁵N-OMV preparations, as well as the efficiency of isotope labelling of proteins and tryptic digests, were assessed by similar techniques (SDS-PAGE, western blotting, LCMS and LCMS/MS) as described above for membrane complexes of B. pertussis, specifically by targeting P.69 Pertactin and PorA, respectively. For PorA, serosubtype specific monoclonal antibodies were used in western blotting.

### Experimental Approaches D, E and F Leading to Human MDDC Batches Expressing Pathogen-Associated MHC Class II Ligandome

In approach D, human MDDC were cultured according to the procedure described in Experimental Methods I, with small modifications. Here, 1×10⁹ PBMC were isolated using a leukapheresis buffy coat obtained with informed consent from a HLA-DR2 homozygous blood donor. On day 6, the still immature MDDC were pulsed with a 1:1 mixture of ¹⁴N- and ¹⁵N-labelled whole cell B. pertussis preparations at a final concentration of OD₅₉₀=0.028. On day 8, whole cell B. pertussis-pulsed MDDC were harvested, washed in PBS and counted. The 20×10⁶ MDDC were pelleted, frozen and stored at −80° C. until peptide isolation and analysis. Small aliquots (1%) of MDDC before and after whole cell B. pertussis pulse were characterized by flow cytometry to verify purity as well as maturation of MDDC (not shown).

In approach E, as above, human MDDC were prepared according to the procedure described in Experimental Methods I, with small modifications. Here, PBMC obtained with informed consent from 9 different blood bank donors, representing a heterogeneous population of HLA-DR typings, were cultured separately (3×10⁸ PBMC/donor) to grow MDDC. On day 6, the still immature MDDC were pulsed with a 1:1 mixture of ¹⁴N- and ¹⁵N-labelled rP.69 Pertactin preparations at a final protein concentration of 10 μg/ml in the presence of 20 ng/ml LPS from S. abortis equi. On day 8, rP.69 Pertactin-pulsed MDDC were harvested (n=9), washed in PBS, pooled and counted. The 70×10⁶ pooled MDDC were then pelleted, frozen and stored at −80° C. until peptide isolation and analysis. Small aliquots (1%) of MDDC before and after B. pertussis rP.69 Pertactin pulse were characterized by flow cytometry to verify purity as well as maturation of MDDC (not shown).

In approach F, as above, human MDDC were prepared according to the procedure described in Experimental Methods I, with small modifications. Here, PBMC obtained with informed consent from a HLA-DR1 homozygous donor and from a HLA-DR2 homozygous donor, with informed consent, were cultured separately (2×10⁹ PBMC/donor) to grow MDDC. On day 6, each MDDC batch was divided in two aliquots and pulsed with a 1:1 mixture of either ¹⁴N- and ¹⁵N-labelled P1.7-2.4 OMV, or of ¹⁴N- and ¹⁵N-labelled P1.5-2.10 OMV, at a protein final concentration of 25 μg/ml in the presence of 20 ng/ml LPS from S. abortis equi. On day 8, the four different OMV-pulsed MDDC batches were harvested, washed in PBS, counted, pelleted, frozen and stored at −80° C. until individual peptide isolation and analysis. Small aliquots (1%) of each MDDC batch before and after OMV pulse were characterized by flow cytometry to verify purity as well as maturation of MDDC (not shown).

### Peptide Synthesis

Synthetic peptides standards were prepared by solid phase FMOC chemistry using a SYRO II simultaneous multiple peptide synthesizer (MultiSyntech GmbH, Witten, Germany). The purity and identity of the synthesized peptides was assessed by reverse phase high performance liquid chromatography (HPLC).

### Isolation of the MHC Class II Ligandome

The MDDC batches prepared according to approaches D, E and F were thawed and lysed for solubilization of MHC class II molecules and subsequent isolation of pathogen-associated MHC class II ligandome by immunochemistry, according to the isolation of MHC class I ligandomes as described in Experimental Methods I with the following small modifications. In the clear step, mouse antibodies specific for human HLA-DR molecules (clone B8.11.2) were used and after elution from the clear column with 10% acetic acid, HLA-DR molecules and associated peptides were passed over a 10-kDa molecular weight cut-off membrane filter and the filtrate was heated for 15 min to 70° C. Concentration, reconstitution, spiking and storage of the MHC class II ligandomes was similar to procedures described for MHC class I ligandomes in Experimental Methods I.

### Platform LCMS Analysis

Peptide samples were analyzed by optimized nanoflow liquid chromatography coupled to electro spray ionization-mass spectrometry (Platform LCMS) as described earlier herein. Aliquots of peptide samples, representing 1−2×10⁷ MDDC, were loaded onto a C18 precolumn, serially connected via a modified MicroTee tubing element to a 25-cm long analytical column, of 25-μm ID densely packed with 3-μm C18 particles. The mobile phase used was a shallow linear gradient at a flow rate of 30 μl/min of acetonitrile+0.1-M acetic acid, from 100% A (water+0.1-M acetic acid) to 60% acetonitrile+0.1-M acetic acid in A in 45 min. Column tips were gold- and carbon-coated and column head pressure was >250 bar. Mass spectra were recorded at a scan rate of 1 sec/scan with a mass range of 300-1,500 Da and at a mass resolution of at least 10,000 FWHM (MS analysis).

For MS sequencing (MS/MS analysis) of candidate pathogen-associated MHC class II epitopes, mostly using a second aliquot of the peptide sample, cycles of MS1 analyses were alternated by cycles of collision induced fragmentation on preselected masses or masses being most abundant at the time of elution into the mass spectrometer. MS/MS spectra were acquired at a scan rate of 1 sec/scan with a mass range of 50 to 2,000 Da and at a mass resolution of 5,000 FWHM. The optimal Collision Energy largely depended on the nature of the epitope and the type of mass spectrometer used and was optimized in these experiments. Interpretation of MS/MS spectra is either manually or using software tools, e.g. Mascot (Perkins et al. 1999., www.matrixscience.com, Matrix Science Ltd., London UK), ProteinProspector (www.prospector.ucsf.edu, Univ. of California, San Francisco, Calif., USA), BioWorks™ (Thermo Scientific, Waltham, Mass., USA) and/or ProteinLynx™ (Waters Corp., Milford, Mass., USA).

For quantification of identified epitopes, relative response factors were calculated by the intensity-amount of the synthetic analogue of the identified epitope divided by the mean of the intensity-amount of the standard peptides angiotensin-III and oxytocin. These factors were subsequently used for the semiquantification of the numbers of natural epitopes present in the cell batch.

### Online 2-Dimensional Platform LCMS Analysis

Peptides were analysed by online 2-dimensional nanoscale liquid chromatography coupled to electro spray ionization-mass spectrometry (2D-LCMS). Aliquots of peptide samples, representing 1-2×10⁷ MDDC, were loaded onto a precolumn comprising a mixture of weak anion exchange particles (e.g. PolyWAX LP™, available from PolyLC, Columbia, Md., USA) and strong cation exchange particles (e.g. PolySULFOETHYL Aspartamide™, available from PolyLC, Columbia, Md., USA) that were mixed in a ratio of 2-3 by weight of the dry particles. This mixed anion-cation exchange (ACE) stationary phase was slurry-packed in a fused silica tubing and sandwiched between two bed lengths of C18 particles (e.g. Reprosil-Pur® C18-AQ, 5 μm particle size, 120 Å pore size, available from Dr. Maisch, Germany). The length of each part of the precolumn bed was 20 mm and the interior diameter of the precolumn was 50 μm. The C18-ACE-C18 sandwich precolumn was serially connected via a modified MicroTee tubing element to a 25-cm long analytical column of 25 μm ID, densely packed with 3-μm C18 particles (e.g. Reprosil-Pur® C18-AQ, 3 μm particle size, 120 Å pore size, available from Dr. Maisch, Germany). The mobile phase used was a shallow linear gradient at a flow rate of 30 nl/min of acetonitrile+0.1-M acetic acid, from 100% A (water+0.1-M acetic acid_to 60% acetonitrile+0.1-M acetic acid in A. Column tips were gold and carbon-coated and column head pressure was >250 bar. Mass spectra were recorded at a scan rate of 1 sec/scan with a mass range of 300-1,500 Da and at a mass resolution of at least 10,000 FWHM (MS analysis). Five subsequent injection, analytical separation and MS analysis-cycles were performed by injecting aliquots of salt-free elution solvents, comprising water containing increasing amounts of formic acid and dimethylsulfoxide (DMSO), with a concentration of 1 nM, 1 μM, 10 mM, 1 M and 2M, respectively, followed by the separation and MS analysis of the peptides using the afore-mentioned shallow linear gradient of acetonitrile+0.1-M acetic acid and mass spectrometric conditions.

### Identification of Candidate Pathogen-Associated MHC Class II Ligands

To discriminate pathogen-derived MHC class II ligands from self-derived ligands, essential mass spectral information (defined by “mass values” and “intensity values”) was extracted from the MS spectra and used for an MHC class II mass spectral interpretation algorithm searching for mass spectral doublets. To positively assign a mass spectral doublet as a candidate pathogen-associated MHC class II ligand, five criteria must be met:

(i) the mass difference (Δm) between the monoisotopic masses of the ‘light’ and ‘heavy’ epitopes must be about 1.2% of the mass of the ‘light’ epitope. This relative mass difference is based on the average natural occurrence of nitrogen atoms in proteins and peptides. An increase in mass of each nitrogen atom by 1 Da results in a relative mass increment of 1.2% for the intact peptide/protein;
(ii) the charge states (z) of the ‘light’ and ‘heavy’ epitopes must be equal;
(iii) the intensity ratio of the ‘light’ and ‘heavy’ epitope must be about 1;
(iv) the mass spectral pattern of the ‘heavy’ epitope must manifest the incorporation of 98-atom %-enriched ¹⁵N-isotope, visualized as [M*−1] and [M*−2] isotopic peaks (M* represents the monoisotopic mass of the ‘heavy’ epitope containing the uniform incorporation of the ¹⁵N-isotope);
(v) the calculated number of nitrogen atoms present in the candidate epitope must be an integer. This number can be calculated by multiplying the absolute mass difference (Δm) of the monoisotopic masses of the ‘light’ and ‘heavy’ epitopes with the charge state (z) of these epitopes.

FIG. 8 (lower panel, right spectrum) depicts the simulated isotope pattern of pathogen-associated class II ligands extracted from antigen pulsed MDDC when using stable isotopes and meeting the above-mentioned criteria. Candidate pathogen-associated MHC class II ligands were searched by moving the simulated isotope pattern mathematically along the mass axis of the MS spectrum of the peptide eluate. Matching isotope clusters are selected for further LCMS/MS analysis.

### Immune Lymphocytes

Peripheral blood from healthy blood bank donors from Sanquin (Amsterdam) was obtained after informed consent (S03.0015-X). Peripheral blood mononuclear cells (PBMC) were isolated by centrifugation of buffy coat cells on fycoll-hypaque (Pharmacia Biotech, Uppsala Sweden) and were freshly used or cryopreserved until usage in the experiments. PBMC were cultured in complete medium, i.e. AIM-V medium (GibcoBRL, USA) supplemented with 2% human AB serum (Harlan, USA). Female spf Balb/c mice and C57black/6 mice were purchased from Harlan and kept in house under conventional conditions. All experiments were approved by The Animal Ethics Committee of the NVI. Groups of four mice were immunized subcutaneously at day 0 and day 28 either with LpxL1 adjuvated liposomes containing rP1.7-2.4 or rP1.5-2.10 (1.5 μg) in PBS, or with P1.7-2.4 or P1.5-2.10 OMV (1.5 μg PorA per dose), prepared as described in Experimental Methods II. After section at day 42, single splenocyte and lymph node cell suspensions were obtained by mechanical dissociation of organs through 70-μm pore size nylon filters. Red blood cells in splenocyte suspensions were lysed with 10 mM KHCO₃, 0.1 mM EDTA, 2 minutes at 4° C. Splenocytes were taken up in complete IMDM-10 medium, i.e. Iscove's Modified Dulbecco's Medium (GibcoBRL, USA) supplemented with 10% FCS (HyClone, USA) and pen/strep/glu (GibcoBRL, USA). Lymph node cells were taken up in complete IMDM-5 medium supplemented with 5% normal mouse serum (Harlan, USA), and pen/strep/glu.

### PorA Peptides and Proteins

Overlapping synthetic 18-mer peptides spanning the entire P1.7-2.4 and P1.5-2.10 protein, respectively, with 12 amino acid overlap, prepared as said, were pooled into 16 pools (A through H and 1 through 8) by smart pooling, i.e. such that each synthetic peptide was represented in two different pools of 8 peptides. Recombinant P1.7-2.4 and P1.5-2.10 proteins (hereafter rP1.7-2.4 and rP1.5-2.10) were obtained by recombinant protein expression technology as known in the art using PorA genes from mentioned isogenic strains of Neisseria meningitidis H44/76.

### Proliferation Assays

For P.69 Pertactin specific human proliferation assays, 10⁵ PBMC were incubated in complete medium at 150 gl/well in the absence or presence of the relevant peptide(s), at 1 or 10 μM at 37° C. in a 5% CO₂ atmosphere. For PorA specific human proliferation assays, 10⁵ PBMC or 2×10⁴ MB71.5 T cells were incubated in complete medium at 150 μl/well in the absence or presence of the relevant peptide(s), peptide pool or PorAs rP1.7-2.4, P1.5-2.10, P1.7.16, P1.19.15, or P1.22.14 at the indicated concentrations at 37° C. in a 5% CO₂ atmosphere. At day 4, 100-μl volumes were removed for the cytokine determinations. Then 0.5 μCi (18.5 kBq) ³H-thymidine (Amersham, USA) was added to the culture 18 hours before harvesting the cells. Determination of CPM and calculation of the results were performed as for the proliferation assay of immune splenocytes. Results are expressed as SI±SD from at least triplicate wells. The region 4 specific T cell line MB71.5 was generated by repetitive in vitro restimulation of MB71 PBMC with 0.5 μg/ml rP1.5-2.1 in complete medium.

For murine proliferation assays, splenocytes from P1.7-2.4 or P.15-2.10 immunized Balb/c or C57Black/6 mice were cultured at 1.5×10⁵ cells/150 μl in 96-well round-bottom plates (Greiner) in the presence of rPorA or 18-mer oligopeptides or medium only, in IMDM-10. On day 4, 0.5 μCi (18.5 kBq) ³H-thymidine (Amersham, USA) was added to the wells and cells were cultured for another 18 hours. Cells were harvested and ³H-thymidine incorporation was determined as counts per minute (CPM) using a Wallac 1205 β-plate liquid scintillation counter. Results are expressed as stimulation index (SI)±SD from triplicate wells, calculated as the quotient of CPM of cultures in the presence of antigen divided by the CPM of cultures in the presence of medium only.

### Results II: MHC Class II Ligandomes

### Protein Expression and Efficiency of ¹⁴N and ¹⁵N Isotope Labelling in Minimal Medium

Bacterial proteins in membrane complexes of the ¹⁴N- and ¹⁵N-labelled whole cell Bordetella pertussis preparations generated as described in approach D in Experimental Methods II were separated by SDS-PAGE and analysed by western blotting. Filamentous Hemagglutinin, P.69 Pertactin, Pertussis Toxin Subunits 1 and 4, and Fimbriae 2 were expressed at a similar rate in ¹⁴N- and ¹⁵N-labelled preparations, indicating a normal protein expression in heavy isotope labelled medium. LCMS analyses of proteins extracted from the ¹⁴N- and ¹⁵N-P.69 Pertactin bands confirmed a mass increment of 1.2% for the heavy form of the P.69 Pertactin protein relative to its light form. In addition, MS/MS spectra obtained from trypsin digestion products from ¹⁴N- and ¹⁵N-P.69 Pertactin revealed typical fragmentation into heavy and light amino acids confirming the successful stable isotope labelling throughout the full sequence of the P.69 Pertactin protein.

Likewise, protein expression and efficiency of ¹⁴N- and ¹⁵N-labelling were assessed for rP.69 Pertactin, as described in approach E and for OMV preparations derived from Neisseria meningitidis, as described in approach F, from Experimental Methods II. Protein integrity and successful labelling throughout the full protein were observed for rP.69 Pertactin and PorA preparations, respectively.

Identification of HLA-DR2-Bound Bordetella pertussis Epitopes in Experimental Approach D

Pathogen-associated HLA-DR ligands were extracted from HLA-DR2 homozygous MDDC that had been pulsed with a 1:1 (OD/OD) mix of ¹⁴N- and ¹⁵N-labelled whole cell Bordetella pertussis preparations, as described in Experimental Methods II. Mass spectral doublets representing the candidate Bordetella pertussis MHC class II ligands were searched in the LCMS spectrum using a mathematical search algorithm. FIG. 13 (upper panel) illustrates an example of a matching isotope cluster detected at m/z 788.94 Da and 797.42 Da, representing a candidate epitope containing 17 nitrogen atoms (FIG. 13, inset). The MS/MS spectrum (FIG. 13, bottom panel) of the epitope revealed a partial sequence, identifying an epitope derived from the Putative Periplasmic Protein from Bordetella pertussis (accession number CAE43606). Six other spectral doublets were sequenced and represented length variants of four epitopes, derived from four different proteins of B. pertussis (Table 4). The epitopes were semiquantified using internal standards.

Identification of HLA-DR-bound Bordetella pertussis rP.69 Pertactin Epitopes in Experimental Approach E

Pathogen-associated HLA-DR ligands were extracted from a HLA-DR heterozygous pooled batch of MDDC that had been pulsed with a 1:1 (OD/OD) mix of ¹⁴N- and ¹⁵N-labelled rP.69 Pertactin, as described in Experimental Methods II. Mass spectral doublets representing the candidate P.69 Pertactin MHC class II ligands were searched in the LCMS spectrum using a mathematical search algorithm. FIG. 14 (upper panel) illustrates an example of a matching isotope cluster detected spectral doublet at m/z 770.43 Da and 780.39 Da, representing a candidate epitope containing 20 nitrogen atoms (FIG. 14, inset). The MS/MS spectrum (FIG. 14, bottom panel) of the epitope revealed b-type ions series of matching peptide sequence LRDTNVTAVPASGAPA of P.69 Prn1 (accession number AJ011091). In total, five spectral doublets were sequenced and they represented length variants of two epitope regions from Bordetella pertussis P.69 Pertactin (Table 5). The epitopes were semiquantified using internal standards.

We investigated the immunogenicity of the two Bordetella pertussis P.69 Pertactin epitope regions in humans by in vitro restimulation of PBMC from a panel of healthy adult donors with synthetic standards representing the epitopes. For the second epitope region comprising the ASTLWYAESNALSKRLG sequence, immune recognition was observed in at least 2 donors (Table 5), indicating that the epitope is a functional human epitope.

Identification of HLA-DR1 and 2 Bound Neisseria meningitidis Epitopes in Experimental Approach F

Pathogen-associated HLA-DR ligands were extracted from 4 MDDC batches pulsed with labelled OMV preparations, such that the following combinations of HLA-DR alleles and PorA serosubtypes were represented: HLA-DR1/P1.7-2.4, HLA-DR2/P1.7-2.4, HLA-DR1/P1.5-2.10, and HLA-DR2/P1.5-2.10, respectively, as described in Experimental Methods II. Mass spectral doublets representing the candidate MHC class II ligands derived from P1.7-2.4 or P1.5-2.10 were searched in the LCMS spectrum using a mathematical search algorithm. FIG. 15 illustrates two examples of spectral doublets, one pair of [MH₂]²⁺ ions detected at m/z 1065.01 Da and 1076.47 Da in the HLA-DR1/P1.7-2.4 ligandome (panel A), and one pair of [MH₃]³⁺ ions detected at m/z 701.01 Da and 708.67 Da in the HLA-DR2/P1.5-2.10 ligandome (panel B), respectively. The mass increments within both mass spectral doublets indicate the presence of 24 nitrogen atoms in each candidate epitope. MS/MS sequencing of the [MH₂]² ion at m/z 1065.01 Da and the [MH₃]³⁺ ion at m/z 701.01 Da, respectively, revealed spectra matching PorA homologue epitopes SPDFSGFSGSVQFVPIQNSK (P1.7-2.4, panel C) and SPEFSGFSGSVQFVPAQNSK (P1.5-2.10, panel D). Collectively in the four ligandomes prepared as described in Experimental Methods II under approach F, 38 spectral doublets were characterized being length variants, serosubtype variants and/or HLA-DR allele specific ligands from 8 epitope regions from Neisseria meningitidis PorA (Table 6). The epitopes were semiquantified using internal standards. Twenty eight of the naturally presented epitopes were novel PorA HLA-DR ligands, 10 were described earlier, localizing to 4 known epitope regions (regions 1, 3, 7 and 8). Hence, 4 new naturally presented PorA epitope regions were disclosed (regions 2, 4, 5 and 6), of which region 2 has been reported to stimulate human CD4⁺ T cells (Wiertz et al. 1992). In all four investigated ligandomes, region 8 epitopes were abundantly expressed. MS sequencing of a mass spectral doublets in the HLA-DR1/P1.7-2.4 ligandome revealed two variants of this epitope region, representing approximately 1% of the total region 8 ligandome, containing the IGNYTQINAASVG core sequence, but extended C-terminally by +114 Da or +270 Da, not matching the natural C-terminal flanking residues of the epitope in this highly conserved region in PorA (FIG. 16). LCMS features of the ¹⁴N- and ¹⁵N-labelled counterparts of these variants and of synthetic standards made for this purpose, revealed that the elongations matched with an non-orthodox elongation of the core sequence with amino acids GG (or N), or GGR (or NR), respectively, that should result from an intramolecular splicing event. Splicing of MHC class II ligands has not been described. This first time demonstration of splicing as a PTM of MHC class II ligands is a direct result of the use of stable isotopes in combination with dedicated immunological experimental design and LCMS. Hence ignorance of the phenomenon PTM of MHC class II ligands is a realistic threat, as for MHC class I ligands, to our knowledge on T cell epitopes and needs the above approach to be solved.

As another result of the comprehensive LCMS analysis of mass spectral doublets in the 4 ligandomes obtained as described for approach F in Experimental Methods, 24 additional epitopes, not derived from PorA proteins, were identified. Collectively, the epitopes represented (length variants from) 18 epitopes from 13 different proteins associated with Neisseria meningitidis OMV preparations (Table 7). This finding discloses the epitope regions and their respective precursor proteins as potential T cell targets.

### High Through-Put Analysis of MHC Ligandomes Using Online 2-Dimensional Platform LCMS Technology

To advance high through-put analysis of MHC ligandomes, half of the same MHC class II peptide sample derived from an OMV pulsed MDDC batch described in approach F was subjected to the online 2-dimensional platform LCMS technology. In addition to epitopes earlier identified using Platform LCMS analysis of off-line prepared SCX fractions of the approach F sample, the on-line 2-D application yielded 19 additional, not previously identified peptide epitopes originating from PorA and a non-PorA protein of Neisseria meningitidis in a fast and sample saving manner (Table 8).

### MHC Ligandomes are (Co)Correlates of Immunogenicity and Protection

Hence, this type of analysis reveals not only the diversity of potential CD4 T cell epitope regions from an antigen, but also provides insight into their relative abundance, which regulates immunogenicity and the quality of the T cell response, and eventual PTM. Importantly, as is illustrated by this example, the experimental setup together with isotope labelling and dedicated LCMS technology facilitates the investigation of the role of pathogenic antigen variation and human HLA-DR polymorphisms in T cell immunity. Sequence alignment of multiple known Neisseria meningitidis PorA serosubtypes revealed that micropolymorphism occurred in three of the naturally presented regions described in Table 6 (region 1, 4 and 5). We investigated the functional role of the novel micropolymorphic region 4 using PBMC from healthy adult donors and splenocytes from immunized Balb/c mice and C57black/6 mice. First, we asked if by repetitive in vitro restimulation of PBMC from various donors with P1.7-2.4 or P1.5-2.10, respectively, would generate T cell lines specific for the SPDFSGFSGSVQFVPIQNSK (P1.7-2.4 variant, hereafter D/I) or SPEFSGFSGSVQFVPAQNSK (P1.5-2.10 variant, hereafter E/A), respectively. From one donor a specific T cell line (MB-71.5) was generated, recognizing autologous antigen presenting cells pulsed with overlapping synthetic 18-mer peptides PEFSGFSGSVQFVPAQNS (code S011-24) and SGSVQFVPAQNSKSAYTP (code S011-25), representing the P1.5-2.10 epitope variant, but not the overlapping synthetic 18-mer peptides PDFSGFSGSVQFVPIQNS (code S004-29) and SGSVQFVPIQNSKSAYTP (code S004-30), representing the P1.7-2.4 counterpart (FIG. 17A). MB-71.5 T cells also proliferated (FIG. 17B) or produced cytokines (not shown) when stimulated with autologous antigen presenting cells pulsed with P1.5-2.10 protein. From 5 other PorA variants, only P1.5-1.2-2 (E/A) and P1.22.14 (D/A) variants restimulated MB-71.5 T cells, but not P1.7-2.4 (D/I), P1.7.16 (E/I) or P1.19.15 (D/I), indicating that the alanine (A) residue in the C-terminal half of the naturally processed ‘region 4’ epitope was essential for T cell recognition. Furthermore, no D/I or A/I specific T cells could be detected in any of the tested individuals (n=5). In preclinical animal studies we made a similar observation: splenocytes from Balb/c mice immunized with P1.5-1, 2-2 (an E/A ‘region 4’ variant like P1.5-2.10) responded to the P1.5-2.10 ‘region 4’ peptides S011-24 and S011-25 but not to the P1.7-2.4 specific region 4 variants S004-29 and S004-30 (data not shown). Mice immunized with P1.7-2.4 did not mount a (measurable) T cell response to region 4 (Table 9). In addition, a T cell hybridoma derived from a Balb/c mouse immunized with P1.5-2.10 had an identical reaction pattern in the presence of 6 wild-type PorA variants as the human MB-71.5 T cells (data not shown). Also in C57black/6 mice, P1.7-2.4 failed to induce a (measurable) T cell response against ‘region 4’, whereas the P1.5-1, 2-2 ‘region 4’ was immunogenic. Both PorA's were equally able to evoke a T cell response against another epitope region identified by the dedicated LCMS technology, ‘region 6’, indicating that P1.7-2.4 was not completely unable to serve as a T cell antigen (Table 9). The poor capacity of P1.7-2.4 to induce bactericidal antibodies in humans as well in mice (refs 15 and 16) is a problem in vaccine development. In Balb/c mice, the magnitude of the anti-‘region 4’ splenocyte proliferation correlated in individual mice with the level of the bactericidal titer against P1.5-1, 2-2 (R=0.78). Collectively, these immunogenicity data earmark ‘region 4’ as an important functional T cell epitope of PorA.

### Discussion: MHC Class I and II Ligandomes

For the first time, a novel combination of methods leading to an improved LCMS device, as represented by the platform LCMS technology, was responsible for the epitope mining of MHC class I and II peptide samples that previously had only yielded a limited number of epitopes using the standard LCMS technology. Furthermore, specific epitope features such as length and length variation, abundance and PTM were determined by the platform technology.

Together with the use of relevant immunological experimental design and isotope labelling, the platform LCMS technology is capable of unambiguously identifying pathogen-associated MHC class I and II ligandomes at an unprecedented high level of precision and sensitivity.

The platform LCMS technology distinguishes itself from previously used (standard) LCMS methods in MHC class I and II ligandome analysis by allowing lower flow rates, higher column head pressure in combination with a required longer and more reliable liquid spraying process. Altogether, this enhances the intensity and dwelling time of ions at the time of the MS/MS cycle and, hence, the identification performance of the LCMS/MS to a level at which dominant and subdominant peptide species can be reliably characterized.

TABLE 1
Identification of viral HLA-A2-associated epitopes
after MV infection of WH cells using standard LCMS

| | | | Abundance |
|---|---|---|---|
| Experimental | Measles virus | Epitope | (copies/ |
| approach | source protein | sequence | cell)^{a} |
| A | Nonstructural | KLWESPQEI | >100,000 |
| | protein C | SEQ ID NO: 1 | |
| | Matrix protein | QLPEATFMV | 1,500 |
| | | SEQ ID NO: 2 | |
| | Hemagglutinin | LMIDRPYVL | 150 |
| | protein | SEQ ID NO: 3 | |
| B | Nonstructural | KLWESPQEI | 85 |
| | protein C | SEQ ID NO: 4 | |
| | Matrix | QLPEATFMV | not |
| | protein | SEQ ID NO: 5 | quanti- |
| | | | tated |
| | Nucleocapsid | GLASFILTI | 150 |
| | protein | SEQ ID NO: 6 | |

^{a}The values represent the number of copies of the individual peptides per cell.

TABLE 2
Epitope mining of viral MHC class I-associated
epitopes in peptide samples using platform LCMS

| | | |
|---|---|---|
| | | Relative |
| | Number of | abundance |
| viral protein and epitope^{a} | amino acids | (%)^{b} |

MV infected WH cells^{c}
MV Matrix protein

| | | |
|---|---|---|
| (D)VIINDDQGLFKV(L) | 12 | 3.3 |
| SEQ ID NO: 7^{d} | | |
| (E)QLPEATFMV(H)# | 9 | 4.8 |
| SEQ ID NO: 8 | | |
| (G)KIIDNTEQL(P) | 9 | 26.0 |
| SEQ ID NO: 9 | | |
| (T)RLSDNGYYTV(P) | 10 | 3.0 |
| SEQ ID NO: 10 | | |

MV Nucleoprotein

| | | |
|---|---|---|
| (M)ATLLRSLAL(F) | 9 | 0.5 |
| SEQ ID NO: 11 | | |
| (S)RLLDRLVRL(I)## | 9 | 18.2 |
| SEQ ID NO: 12 | | |

MV Large structural protein

| | | |
|---|---|---|
| (A)FLMDRHIIV(P) | 9 | 2.1 |
| SEQ ID NO: 13 | | |
| (A)SLMPEETLHQV(M) | 11 | 1.7 |
| SEQ ID NO: 14 | | |
| (S)LMPEETLHQV(M) | 10 | 1.1 |
| SEQ ID NO: 15 | | |
| (E)ILDHSVTGA(R) | 9 | 0.2 |
| SEQ ID NO: 16 | | |
| (G)LVEHRMGV(G) | 8 | 0.2 |
| SEQ ID NO: 17 | | |
| (Q)RAN*VSLEEL(R)### | 9 | 5.9 |
| SEQ ID NO: 18 | | |
| (Q)RLHDIGHHL(K) | 9 | 2.1 |
| SEQ ID NO: 19 | | |
| (Q)RLHDIGHHLKA(N) | 11 | 0.1 |
| SEQ ID NO: 20 | | |
| (R)KLINKFIQN(L) | 9 | 0.1 |
| SEQ ID NO: 21 | | |
| (S)RMSKGVFKV(L)#### | 9 | 1.9 |
| SEQ ID NO: 22 | | |
| (W)KLIDGFFPA(L) | 9 | 2.8 |
| SEQ ID NO: 23 | | |
| (W)KLIDGFFPAL(G) | 10 | 0.2 |
| SEQ ID NO: 24 | | |
| (Y)ARVPHAYSL(E) | 9 | 0.1 |
| SEQ ID NO: 25 | | |

MV Fusion glycoprotein F0 precursor

| | | |
|---|---|---|
| (I)KLMPNITLL(N) | 9 | 0.2 |
| SEQ ID NO: 26 | | |
| (I)KLMPN*ITLL(N)### | 9 | 5.8 |
| SEQ ID NO: 27 | | |
| (I)RQAGQEMILAV(Q) | 11 | 0.2 |
| SEQ ID NO: 28 | | |
| (K)YVATQGYLI(S) | 9 | 0.2 |
| SEQ ID NO: 29 | | |
| (V)IKLMPNITLL(N) | 10 | 1.2 |
| SEQ ID NO: 30 | | |
| (D)KILTHIAAD(H) | 9 | 1.0 |
| SEQ ID NO: 31 | | |

MV Hemagglutinin glycoprotein

| | | |
|---|---|---|
| (H)LMIDRPYVL(L)# | 9 | 0.9 |
| SEQ ID NO: 32 | | |
| (H)LMIDRPYVLL(A) | 10 | 0.1 |
| SEQ ID NO: 33 | | |
| (I)KIASGFGPLIT(H) | 11 | 0.2 |
| SEQ ID NO: 34 | | |
| (L)SMYRVFEV(G) | 8 | 2.5 |
| SEQ ID NO: 35 | | |
| (F)KVSPYLFTV(P) | 9 | 2.9 |
| SEQ ID NO: 36 | | |
| (P)YLFTVPIKEA(G) | 10 | 1.3 |
| SEQ ID NO: 37 | | |
| (G)KGVSFQLVNL(G) | 10 | 5.4 |
| SEQ ID NO: 38 | | |
| (V)LSVDLSpPTV(E)### | 9 | 1.1 |
| SEQ ID NO: 39 | | |

MV Nonstructural Protein C

| | | |
|---|---|---|
| (L)KLWESPQEI(S)# | 9 | 0.7 |
| SEQ ID NO: 40 | | |
| (L)KLWESPQEIS(R) | 10 | 1.0 |
| SEQ ID NO: 41 | | |
| (L)KLWESPQEISR(H) | 11 | 0.2 |
| SEQ ID NO: 42 | | |

MV Phosphoprotein

| | | |
|---|---|---|
| (R)RLASFGTEIASL(L) | 12 | 0.4 |
| SEQ ID NO: 43 | | |
| (S)KLESLLLLK(G) | 9 | 0.4 |
| SEQ ID NO: 44 | | |
| (Y)YVYDHSGEAV(K) | 10 | 0.2 |
| SEQ ID NO: 45 | | |

Influenza A virus infected MB-02 cells
FLU Nonstructural protein 1

| | |
|---|---|
| ILKEESDEAL | 10 |
| SEQ ID NO: 46 | |
| AIMEKNIML | 9 |
| SEQ ID NO: 47 | |

FLU Heamgglutinin

| | |
|---|---|
| KLATGMRNV | 9 |
| SEQ ID NO:: 48 | |

FLU Neuraminidase

| | |
|---|---|
| VPFHLGTKQV | 10 |
| SEQ ID NO: 49 | |

RSV infected MDDC
Matrix protein

| | |
|---|---|
| TPKGPSLRV | 9 |
| SEQ ID NO: 50 | |

Nucleocapsid protein

| | |
|---|---|
| FPHFSSVVL | 9 |
| SEQ ID NO: 51 | |

^{a}For MV epitopes, the residues adjacent to the identified epitopes are given between brackets. Accordingly, these residues are not part of the identified epitopes.
^{b}The values represent the relative abundance with a summed relative abundance of 100%.
^{c}Cell source of epitopes.
^{d}SEQ ID NRs 7-49 are HLA-A*0201 associated ligands and SEQ ID NRs 50-51 are HLA-B*0701 associated ligands.
#MV epitopes also detectable using standard LCMS.
##Epitope earlier described as a mouse CTL epitope (Neumeister et al. 1998).
###Epitope with PTM: an asterisk (*) denotes a deamidation of the particular amino acid residue, while phosphorylation sites are indicated by a ‘p’.
####Epitope earlier described as a human CTL epitope (Nanan et al. 1995).

TABLE 3
Significantly upregulated MHC class I associated
self-ligands induced by influenza virus infection.

| Epitope | Human source protein |
|---|---|
| VVSEVDIAKAD | Interferon-induced GTP-binding |
| SEQ ID NO: 52 | protein Mx1 (P20591) |
| RLSDAQIYV | Interferon-induced protein with |
| SEQ ID NO: 53 | tetratricopeptide repeats 3 (O14879) |
| HLANIVERV | Tripartite motif-containing protein |
| SEQ ID NO: 54 | 22 (Q8IYM9) |
| SLAEGLRRTV | Human 2′-5′-oligoadenylate |
| SEQ ID NO: 55 | synthetase 3 (Q9Y6K5) |
| AIHHFIEGV | Human interferon-induced protein |
| SEQ ID NO: 56 | with tetratricopeptide repeats 2 |
| | (P09913) |
| KPKNPEFTSGL | Human interferon-induced protein |
| SEQ ID NO: 57 | with tetratricopeptide repeats 2 |
| | (P09913) |
| KIRNFVVVF | Interferon-induced helicase C |
| SEQ ID NO: 58 | domain-containing protein 1 (Q9BYX4) |

TABLE 4
B. pertussis-derived HLA-DR2 epitopes identified
after processing of whole bacterial cells

| | |
|---|---|
| B. pertussis | Abundance |
| protein and epitope^{a} | (copies/cell)^{b} |

Putative periplasmatic protein (CAE43606)^{c}

| | |
|---|---|
| (L)AAFIALYPNSQLAPT(A) | 175 |
| SEQ ID NO: 59 | |
| (F)IALYPNSQLAPT(A) | 25 |
| SEQ ID NO: 60 | |

Adenylosuccinate synthetase (CAE42466)

| | |
|---|---|
| (K)LAEVLDYHNFVLTQ(Y) | 10 |
| SEQ ID NO: 61 | |

Putative peptidoglycan-associated
lipoprotein NP_881875)

| | |
|---|---|
| (R)GGAEYNLALGQRRADA(V) | 350 |
| SEQ ID NO: 62 | |
| (R)GGAEYNLALGQRRA(D) | 10 |
| SEQ ID NO: 63 | |

10-kDa Chaperonin (groES protein) (NP_882015)

| | |
|---|---|
| (E)KPDQGEVVAVGPGKKTEDG(K) | 80 |
| SEQ ID NO: 64 | |
| (E)KPDQGEVVAVGPGKKTED(G) | 5 |
| SEQ ID NO: 65 | |

^{a}For comprehensiveness, the residues adjacent to the naturally processed and presented epitopes are given between brackets.
^{b}The values represent the number of copies of the individual peptides per cell.
^{c}accession number.

TABLE 5
Identification of HLA-DR presented epitopes
derived from B. pertussis P.69 Prn1

| | | Abundance | Immuno- |
|---|---|---|---|
| | | (copies/ | genicity |
| | P.69 Pertactin epitope | cell)^{b} | in humans^{c} |
| 1 | (V)LRDTNVTAVPASGAPA(A) | 190 | +^{d} |
| | SEQ ID NO: 66 | | |
| | (L)RDTNVTAVPASGAPA(A) | 70 | + |
| | SEQ ID NO: 67 | | |
| 2 | (A)STLWYAESNALSKRLG(E) | 310 | + |
| | SEQ ID NO: 68 | | |
| | (L)ASTLWYAESNALSKRL(G) | 90 | + |
| | SEQ ID NO: 69 | | |
| | (A)STLWYAESNALSKR(L) | 370 | + |
| | SEQ ID NO: 70 | | |
| 3 | (P)EAGRFKVLTVNTLAGSG(L) | 75 | ++ |
| | SEQ ID NO: 71 | | |
| | (Q)QPAEAGRFKVLTVNTLAGSG(L) | 750 | ++ |
| | SEQ ID NO: 72 | | |

^{a}For comprehensiveness, the residues adjacent to the naturally processed and presented epitopes are given between brackets.
^{b}The values represent the number of copies of the individual peptides per cell.
^{c}immunogenicity as determined by specific in vitro proliferative activity against synthetic peptide representing the epitope region.
^{d}nd not determined.

TABLE 6
Natural display of Neisseria meningitidis
PorA-derived epitopes associated with HLA-DR

| | | Abundance |
|---|---|---|
| | Epitope^{b} from Porin A | (copies/ |
| R^{a} | (Neisseria meningitidis) | cell)^{c} |
| 1 | (-)DVSLYGEIKAGVEGRNIQLQ(L) | 1,700-7,420 |
| | SEQ ID NO: 73 | |
| | (-)DVSLYGEIKAGVEGRNIQ(L) | 2,800-16,890 |
| | SEQ ID NO: 74 | |
| | (-)DVSLYGEIKAGVEGRNYQLQ(L) | 30 |
| | SEQ ID NO: 75 | |
| | (-)DVSLYGEIKAGVEGRNYQ(L) | 50-1,440 |
| | SEQ ID NO: 76 | |
| 2 | (R)IRTKISDFGSFIGFKG(S) | 580-1,000 |
| | SEQ ID NO: 77 | |
| | (R)IRTKISDFGSFIGFK(G) | 40 |
| | SEQ ID NO: 78 | |
| | (R)TKISDFGSFIGFKG(F) | 60 |
| | SEQ ID NO: 79 | |
| 3 | (G)LAGEFGTLRAGRVANQFD(D) | 25 |
| | SEQ ID NO: 80 | |
| | (G)LAGEFGTLRAGRVANQF(D) | 75 |
| | SEQ ID NO: 81 | |
| | (G)LAGEFGTLRAGRVANQ(F) | 750-3,500 |
| | SEQ ID NO: 82 | |
| | (G)LAGEFGTLRAGRVAN(Q) | 300 |
| | SEQ ID NO: 83 | |
| | (L)AGEFGTLRAGRVANQ(F) | 300-8,250 |
| | SEQ ID NO: 84 | |
| | (L)AGEFGTLRAGRVAN(Q) | 2,500 |
| | SEQ ID NO: 85 | |
| | (L)AGEFGTLRAGRVA(N) | 350 |
| | SEQ ID NO: 86 | |
| | (F)GEFGTLRAGRVANQF(D) | 750 |
| | SEQ ID NO: 87 | |
| | (F)GEFGTLRAGRVANQ(F) | 100-3,600 |
| | SEQ ID NO: 88 | |
| | (F)GEFGTLRAGRVAN(Q) | 1,000 |
| | SEQ ID NO: 89 | |
| | (F)GEFGTLRAGRVA(N) | 350 |
| | SEQ ID NO: 90 | |
| | (E)FGTLRAGRVANQ(F) | 75 |
| | SEQ ID NO: 91 | |
| 4 | (F)KRHDDMSVSVRYDSPEFSGFSGSVQFVPA | 110 |
| | QNSK(S) | |
| | SEQ ID NO: 92 | |
| | (K)RHDDMₒₓSVSVRYD(S) | 170 |
| | SEQ ID NO: 93 | |
| | (D)SPEFSGFSGSVQFVPAQNSK(S) | 970 |
| | SEQ ID NO: 94 | |
| | (D)SPDFSGFSGSVQFVPIQNSK(S) | 50 |
| | SEQ ID NO: 95 | |
| 5 | (V)GKPGSDVYYAGLNYKNGGFAGNYAFKYAR | 2,100 |
| | HANVG(R) | |
| | SEQ ID NO: 96 | |
| | (V)GKPGSDVYYAGLNYKNGGFAGNYAFKYAR | 920 |
| | HANV(G) | |
| | SEQ ID NO: 97 | |
| | (V)GKPGSDVYYAGLNYKNGGFAGNYAFKYAR | 580 |
| | HAN(V) | |
| | SEQ ID NO: 98 | |
| | (G)KPGSDVYYAGLNYKNGGFAGNYAFKYARH | 520 |
| | AN(V) | |
| | SEQ ID NO: 99 | |
| 6 | (A)ATASYRFGNAVPRIS(Y) | 160 |
| | SEQ ID NO: 100 | |
| 7 | (N)TSYDQIIAGVDYDFSKRTSAIVSGAWLKR | 1,800 |
| | NTG(I) | |
| | SEQ ID NO: 101 | |
| 8 | (K)RNTGIGNYTQINAASVG(L) | 20-60 |
| | SEQ ID NO: 102 | |
| | (K)RNTGIGNYTQINAAS(V) | 30 |
| | SEQ ID NO: 103 | |
| | (T)GIGNYTQINAASVGLR(H) | 200-1,500 |
| | SEQ ID NO: 104 | |
| | (T)GIGNYTQINAASVG(L) | 80-150 |
| | SEQ ID NO: 105 | |
| | (G)IGNYTQINAASVGLR(H) | 300-3,500 |
| | SEQ ID NO: 106 | |
| | (G)IGNYTQINAASVGL(R) | 30-800 |
| | SEQ ID NO: 107 | |
| | (G)IGNYTQINAASVG(L) | 80-2,000 |
| | SEQ ID NO: 108 | |
| | (G)NYTQINAASVGLRHKF(-) | 1,070-1,850 |
| | SEQ ID NO: 109 | |
| | (N)YTQINAASVGLRHKF(-) | 3,500-13,000 |
| | SEQ ID NO: 110 | |

^{a}R: PorA region of nested sets of epitopes.
^{b}For comprehensiveness, the residues adjacent to the naturally processed and presented epitopes are given between brackets, with (-) representing the N- or C- terminus of the protein. The variable residues between both strains are marked (bold). The residue Mₒₓ denotes an oxidized methionine residue.
^{c}The values represent the number of copies of the individual peptides per cell.

TABLE 7
Neisseria meningitidis non-PorA
derived HLA-DR presented epitopes

| | |
|---|---|
| | Abundance |
| | (copies/ |
| Epitope^{a} | cell)^{b} |

Periplasmic iron-binding protein (NP_283636)^{c}

| | |
|---|---|
| (S)AANLLEPLPASTINET(R) | 30 |
| SEQ ID NO: 111 | |
| (R)DPGALVTYSGAAVLK(S) | 80 |
| SEQ ID NO: 112 | |
| (L)INNYYWHAFAREKGVQ(N) | 150 |
| SEQ ID NO: 113 | |

Outer membrane surface protein A (AAD53286)

| | |
|---|---|
| (A)EGASGFYVQADAAHAKASSS(L) | 80 |
| SEQ ID NO: 114 | |
| (A)EGASGFYVQADAAHAKAS(S) | 350 |
| SEQ ID NO: 115 | |
| (A)YVQADAAHAKAS(S) | 380 |
| SEQ ID NO: 116 | |
| (A)YVQADAAHAKA(S) | 380 |
| SEQ ID NO: 117 | |

Fe-regulated outer membrane protein B CAA61902)

| | |
|---|---|
| (Y)SDSQILYHQGRFIVDPA(L) | 950 |
| SEQ ID NO: 118 | |
| (Y)IKNHGYELGASYRTGGLTAKVGVSHSKPRFY(D) | 6,290 |
| SEQ ID NO: 119 | |
| (Y)IKNHGYELGASYRTGGLTAKVGVSHSKPRF(Y) | 2,320 |
| SEQ ID NO: 120 | |
| (T)LPGVGRDVRLGVNYKF(-) | 9,610 |
| SEQ ID NO: 121 | |
| (G)VGRDVRLGVNYKF(-) | >2,000 |
| SEQ ID NO: 122 | |

30S Ribosomal protein S18 (NP_274340)

| | |
|---|---|
| (T)KAFYQRQLAVAVKRA(R) | 70 |
| SEQ ID NO: 123 | |
| (T)KAFYQRQLAVAVKR(A) | 790 |
| SEQ ID NO: 124 | |

Multidrug efflux pump channel protein (NP_274717)

| | |
|---|---|
| (I)YRKQYMIERNNLLPT(L) | 370 |
| SEQ ID NO: 125 | |
| (E)RSSYAAEGAALSAQ(L) | 30 |
| SEQ ID NO: 126 | |

Transferrin binding protein I (CAB85243)

| | |
|---|---|
| (F)ENKRHYIGGILERTQQT(F) | 260 |
| SEQ ID NO: 127 | |

Conserved hypothetical protein NMB1265 (NP_274286)

| | |
|---|---|
| (N)PRVFGSVSRGDDTENSDIDLLVDAKTGTTLLDLG(G) | 550 |
| SEQ ID NO: 128 | |

Opacity Protein (CAA448221)

| | |
|---|---|
| (E)DGSRSPYYVQADLAYAAERITHD(Y) | 70 |
| SEQ ID NO: 129 | |

Putative lipopolysaccharide biosynthesis
protein Wbpc (NP_274833)

| | |
|---|---|
| (F)MAQYDRLGLTRSNTSC(H) | 50 |
| SEQ ID NO: 130 | |

Secretin outer membrane protein precursor
(PilQ)(CAD91899)

| | |
|---|---|
| (Q)HDHIIVTLKNHTLPT(A) | 330 |
| SEQ ID NO: 131 | |

Zinc-binding propanol-preferring alcohol
dehydrogenase protein (NP_273591)

| | |
|---|---|
| (N)DDKLAFAKETGADLVVN(A) | 70 |
| SEQ ID NO: 132 | |

TonB-dependent outer membrane receptor (AAF73907)

| | |
|---|---|
| (K)DKKVFTDARAVSTRQD(I) | 70 |
| SEQ ID NO: 133 | |

VacJ-related membrane protein (NP_274955)

| | |
|---|---|
| (Q)ADRYIFAPAARGYRK(V) | 240 |
| SEQ ID NO: 134 | |

^{a}For comprehensiveness, the residues adjacent to the naturally processed and presented epitopes are given between brackets, with (-) representing the N- or C- terminus of the protein.
^{b}The values represent the number of copies of the individual peptides per cells.
^{c}accession number.

TABLE 8
Sensitive and high through-put epitope mining
using online 2-dimensional platform LCMS analysis

| | Number of |
|---|---|
| Protein and epitope^{a} | amino acids |
| Neisseria meningitidis P1.5-2,10 | |
| RHDDMSVSVRYDSPEFSGFSGSVQFVPAQNSK | 32 |
| SEQ ID NR: 135 | |
| RHDDM*SVSVRYDSPEFSGFSGSVQFVPAQNSK | 32 |
| SEQ ID NR: 136 | |
| VGKPGSDVYYAGLNYKNGGFAGNYAFKYAKHANVG | 35 |
| SEQ ID NR: 137 | |
| VVGKPGSDVYYAGLNYKNGGFAGNYAFKYAKHANVGR | 40 |
| DAF | |
| SEQ ID NR: 138 | |
| AVVGKPGSDVYYAGLNYKNGGFAGNYAFKYAKHANVG | 41 |
| RDAF | |
| SEQ ID NR: 139 | |
| KPGSDVYYAGLNYKNGGFAGNYAFKYAKHANV | 32 |
| SEQ ID NR: 140 | |
| KPGSDVYYAGLNYKNGGFAGNYAFKYAKHANVG | 33 |
| SEQ ID NR: 141 | |
| GSDVYYAGLNYKNGGFAGNYAFKYAKHANVG | 34 |
| SEQ ID NR: 142 | |
| KTKNSTTEIAATASYRFGNAVPRISYAHGFDFIE | 34 |
| SEQ ID NR: 143 | |
| KTKNSTTEIAATASYRFGNAVPRISYAHGFDFIER | 35 |
| SEQ ID NR: 144 | |

Neisseria meningitidis Fe-regulated outer
membrane protein B (CAA61902)

| | |
|---|---|
| SALDKRSYLAKIGTTFGDDDHRIVLSHMKDQHRGIR | 36 |
| SEQ ID NR: 145 | |
| SALDKRSYLAKIGTTFGDDDHRIVLSHM*KDQHRGIR | 36 |
| SEQ ID NR: 146 | |
| GVYVEAIHDIGDFTLTGGLRYDRFKVKTHDGKTVS | 35 |
| SEQ ID NR: 147 | |
| VYVEAIHDIGDFTLTGGLRYDRFKVKTHDGKTVS | 34 |
| SEQ ID NR: 148 | |
| GYIKNHGYELGASYRTGGLTAKVGVSHSKPRF | 32 |
| SEQ ID NR: 149 | |
| YIKNHGYELGASYRTGGLTAKVGVSHSKPR | 30 |
| SEQ ID NR: 150 | |
| YIKNHGYELGASYRTGGLTAKVGVSHSKPRF | 31 |
| SEQ ID NR: 151 | |
| YIKNHGYELGASYRTGGLTAKVGVSHSKPRFY | 32 |
| SEQ ID NR: 152 | |
| IKNHGYELGASYRTGGLTAKVGVSHSKPR | 29 |
| SEQ ID NR: 153 | |

^{a}Additional epitopes from P1.5-2,10 and FrpB proteins identified by the online-two dimensional version of the platform LCMS analysis in 25% of a peptide eluate derived from OMV pulsed HLA-DR*1501 MDDC, which were not identified using off-line prepared SCX fractions from 50% of the same peptide eluate. Originally identified epitopes were confirmed by peptide-mining.
*oxidized Methionine

TABLE 9
Summary of immunogenic PorA epitope
regions in Balb/c and C57black/6 mice

| | P1.7-2, 4¹ | P1.5-1, 2-2¹ |
|---|---|---|
| Balb/c mice | — (none)² | Region 4 |
| C57black/6 mice | Region 6 | Region 4 + Region 6 |

¹Groups of animals were immunized with 1.5 μg of the indicated PorA incorporated in liposomes or OMV as described in Experimental Methods II
²PorA epitope region recognized in mouse strain

### REFERENCES

Claassen I, Meylis J, van der Ley P, Peeters C, Brons H, Robert J, Borsboom. D, van der Ark A, van Straaten I, Roholl P, Kuipers B, Poolman J. Production, characterization and control of a Neisseria meningitidis hexavalent class I outer membrane protein containing vesicle vaccine. Vaccine. 1996; 14(10):1001-8.
Engelhard V H, Altrich-Vanlith M, Ostankovitch M, Zarling A L. Post-translational modifications of naturally processed MHC-binding epitopes. Curr Opin Immunol. 2006 February; 18(1):92-7. Review.
Hijnen M, van Gageldonk P G, Berbers G A, van Woerkom T, Mooi F R. The Bordetella pertussis virulence factor P.69 pertactin retains its immunological properties after overproduction in Escherichia coli. Protein Expr Purif. 2005; 41(1):106-12.
Hunt D F, Henderson R A, Shabanowitz J, Sakaguchi K, Michel H, Sevilir N, Cox A L, Appella E, Engelhard V H. Characterization of peptides bound to the class I MHC molecule HLA-A2.1 by mass spectrometry. Science. 1992; 255(5049):1261-3.
Licklider L J, Thoreen C C, Peng J, Gygi S P. Automation of nanoscale microcapillary liquid chromatography-tandem mass spectrometry with a vented column. Anal Chem. 2002 Jul. 1; 74(13):3076-83.
Masignani V, Rappuoli R, Pizza M. Reverse vaccinology: a genome-based approach for vaccine development. Expert Opin Biol Ther. 2002; 2(8):895-905. Review.
Motoyama A, Xu T, Ruse C I, Wohlschlegel J A, Yates J R 3rd. Anion and cation mixed-bed ion exchange for enhanced multidimensional separations of peptides and phosphopeptides. Anal Chem. 2007 May 15; 79(10):3623-34.
Nanan R, Carstens C, Kreth H W. Demonstration of virus-specific CD8+ memory T cells in measles-seropositive individuals by in vitro peptide stimulation. Clin Exp Immunol. 1995; 102(1):40-5.
Neumeister C, Niewiesk S. Recognition of measles virus-infected cells by CD8+ T cells depends on the H-2 molecule. J Gen Virol. 1998; 79 (Pt 11):2583-91.
Peeters C C, Rümke HC, Sundermann L C, Rouppe van der Voort E M, Meulenbelt J, Schuller M, Kuipers A J, van der Ley P, Poolman J T. Phase I clinical trial with a hexavalent PorA containing meningococcal outer membrane vesicle vaccine. Vaccine. 1996; 14(10):1009-15.
Perkins D N, Pappin D J, Creasy D M, Cottrell J S. Probability-based protein identification by searching sequence databases using mass spectrometry data. Electrophoresis. 1999; 20(18):3551-67.
Sallusto F, Lanzavecchia A. Efficient presentation of soluble antigen by cultured human dendritic cells is maintained by granulocyte/macrophage colony-stimulating factor plus interleukin 4 and downregulated by tumor necrosis factor alpha. J Exp Med. 1994; 179(4):1109-18.
Temmerman S, Pethe K, Parra M, Alonso S, Rouanet C, Pickett T, Drowart A, Debrie A S, Delogu G, Menozzi F D, Sergheraert C, Brennan M J, Mascart F, Locht C. Methylation-dependent T cell immunity to Mycobacterium tuberculosis heparin-binding hemagglutinin. Nat. Med. 2004 September; 10(9):935-41.
Van Deemter J J, Zuiderweg F J and Klinkenberg A (1956). “Longitudinal diffusion and resistance to mass transfer as causes of non ideality in chromatography”. Chem. Eng. Sc. 5: 271-289.
Wiertz E J, van Gaans-van den Brink J A, Gausepohl H, Prochnicka-Chalufour A, Hoogerhout P, Poolman J T. Identification of T cell epitopes occurring in a meningococcal class I outer membrane protein using overlapping peptides assembled with simultaneous multiple peptide synthesis. J Exp Med. 1992 Jul. 1; 176(1):79-88.

1-30. (canceled)

31. A liquid chromatography-mass spectrometry (LCMS) device for analyzing a sample comprising a pump arrangement, an analytical column, an electro spray ionization unit and a mass spectrometer, wherein the pump arrangement is constructed and arranged for providing a nanoscale flow to the analytical column, the analytical column comprises a stationary phase for liquid chromatography and has an interior diameter of less than 200 μm, the electro spray ionization unit comprises an emitter for electro spraying positioned downstream of the analytical column in the flow path of the sample, said emitter having an interior diameter of less than 70 μm, and wherein the mass spectrometer is positioned downstream of the emitter,
wherein the LCMS is adapted to perform two-dimensional chromatography, the first dimension comprising strong cation exchange chromatography and the second dimension comprising reversed phase chromatography, and wherein an elution solvent for chromatography in both dimensions is a salt-free solution.

32. The LCMS device according to claim 1, wherein the salt-free solution comprises acetic acid.

33. The LCMS device according to claim 1, wherein the salt-free solution comprises formic acid.

34. The LCMS device according to claim 1, wherein the emitter comprises a tapered end for spraying the sample, said tapered end provided with a first coating and a second coating.

35. The LCMS device according to claim 1, wherein the analytical column and the emitter have an interior diameter of 55 μm or less.

36. The LCMS device according to claim 1, wherein the emitter is integrally formed with the analytical column.

37. The LCMS device according to claim 34, wherein the second coating comprises carbon.

38. The LCMS device according to claim 34 wherein the second coating comprises a conductive carbon cement.

39. The LCMS device according to claim 1, wherein the second coating is a silicon alloy or a electricity conducting polymer.

40. The LCMS device according to claim 1, wherein the tapered end of the emitter has an interior diameter of less than 20 μm.

41. The LCMS device according to claim 40, wherein the tapered end of the emitter has an interior diameter of less than 10 μm.

42. The LCMS device according to claim 34, wherein the first coating comprises a precious metal.

43. The LCMS device according to claim 42 wherein the precious metal is gold.

44. The LCMS device according to claim 34, wherein the emitter comprises fused silica provided with the first and second coatings.

45. A LCMS device according to claim 1, which further comprises a connecting element for connecting at least two tubing elements of the device, said tubing element having an outer diameter and cavity having an interior diameter,
wherein the connecting element comprises at least two ferrules and at least two receiving cavities for receiving the ferrules, said ferrules having an internal cavity and an interior diameter adapted for receiving the tubing element, such that the two ferrules received in the receiving space align the tubing elements, and wherein the connecting element comprises an interior volume connecting and aligned with the internal cavity of the ferrules, said interior volume having an internal diameter adapted to receive the ends of the tubing elements and, in a connected state, allows the ends of the tubing elements to be brought into abutment in the interior volume.

46. An emitter for nanoscale flow that is part of an electrospray ionization unit, comprising an upstream end for receiving a sample and a second tapered end for electrospraying the sample, wherein the emitter is formed from fused silica and has an interior diameter of less than 55 μm, wherein the tapered end is provided with a conductive first gold coating and a conductive second carbon-based coating.

47. An emitter according to claim 46, the interior diameter of which, near the tapered end, is at most 10 μm.


SEQUENCE LISTING (159 sequences)

SEQ ID NO: 1 - protein, 9 aa, Measles virus
KLWESPQEI

SEQ ID NO: 2 - protein, 9 aa, Measles virus
QLPEATFMV

SEQ ID NO: 3 - protein, 9 aa, Measles virus
LMIDRPYVL

SEQ ID NO: 4 - protein, 9 aa, Measles virus
KLWESPQEI

SEQ ID NO: 5 - protein, 9 aa, Measles virus
QLPEATFMV

SEQ ID NO: 6 - protein, 9 aa, Measles virus
GLASFILTI

SEQ ID NO: 7 - protein, 12 aa, Measles virus
VIINDDQGLFKV

SEQ ID NO: 8 - protein, 9 aa, Measles virus
QLPEATFMV

SEQ ID NO: 9 - protein, 9 aa, Measles virus
KIIDNTEQL

SEQ ID NO: 10 - protein, 10 aa, Measles virus
RLSDNGYYTV

SEQ ID NO: 11 - protein, 9 aa, Measles virus
ATLLRSLAL

SEQ ID NO: 12 - protein, 9 aa, Measles virus
RLLDRLVRL

SEQ ID NO: 13 - protein, 9 aa, Measles virus
FLMDRHIIV

SEQ ID NO: 14 - protein, 11 aa, Measles virus
SLMPEETLHQV

SEQ ID NO: 15 - protein, 10 aa, Measles virus
LMPEETLHQV

SEQ ID NO: 16 - protein, 9 aa, Measles virus
ILDHSVTGA

SEQ ID NO: 17 - protein, 8 aa, Measles virus
LVEHRMGV

SEQ ID NO: 18 - protein, 9 aa, Measles virus
RANVSLEEL

SEQ ID NO: 19 - protein, 9 aa, Measles virus
RLHDIGHHL

SEQ ID NO: 20 - protein, 11 aa, Measles virus
RLHDIGHHLKA

SEQ ID NO: 21 - protein, 9 aa, Measles virus
KLINKFIQN

SEQ ID NO: 22 - protein, 9 aa, Measles virus
RMSKGVFKV

SEQ ID NO: 23 - protein, 9 aa, Measles virus
KLIDGFFPA

SEQ ID NO: 24 - protein, 10 aa, Measles virus
KLIDGFFPAL

SEQ ID NO: 25 - protein, 9 aa, Measles virus
ARVPHAYSL

SEQ ID NO: 26 - protein, 9 aa, Measles virus
KLMPNITLL

SEQ ID NO: 27 - protein, 9 aa, Measles virus
KLMPNITLL

SEQ ID NO: 28 - protein, 11 aa, Measles virus
RQAGQEMILAV

SEQ ID NO: 29 - protein, 9 aa, Measles virus
YVATQGYLI

SEQ ID NO: 30 - protein, 10 aa, Measles virus
IKLMPNITLL

SEQ ID NO: 31 - protein, 9 aa, Measles virus
KILTHIAAD

SEQ ID NO: 32 - protein, 9 aa, Measles virus
LMIDRPYVL

SEQ ID NO: 33 - protein, 10 aa, Measles virus
LMIDRPYVLL

SEQ ID NO: 34 - protein, 11 aa, Measles virus
KIASGFGPLIT

SEQ ID NO: 35 - protein, 8 aa, Measles virus
SMYRVFEV

SEQ ID NO: 36 - protein, 9 aa, Measles virus
KVSPYLFTV

SEQ ID NO: 37 - protein, 10 aa, Measles virus
YLFTVPIKEA

SEQ ID NO: 38 - protein, 10 aa, Measles virus
KGVSFQLVNL

SEQ ID NO: 39 - protein, 9 aa, Measles virus
LSVDLSPTV

SEQ ID NO: 40 - protein, 9 aa, Measles virus
KLWESPQEI

SEQ ID NO: 41 - protein, 10 aa, Measles virus
KLWESPQEIS

SEQ ID NO: 42 - protein, 11 aa, Measles virus
KLWESPQEISR

SEQ ID NO: 43 - protein, 12 aa, Measles virus
RLASFGTEIASL

SEQ ID NO: 44 - protein, 9 aa, Measles virus
KLESLLLLK

SEQ ID NO: 45 - protein, 10 aa, Measles virus
YVYDHSGEAV

SEQ ID NO: 46 - protein, 10 aa, Influenza A virus
ILKEESDEAL

SEQ ID NO: 47 - protein, 9 aa, Influenza A virus
AIMEKNIML

SEQ ID NO: 48 - protein, 9 aa, Influenza A virus
KLATGMRNV

SEQ ID NO: 49 - protein, 10 aa, Influenza A virus
VPFHLGTKQV

SEQ ID NO: 50 - protein, 9 aa, respiratory syncytial virus
TPKGPSLRV

SEQ ID NO: 51 - protein, 9 aa, respiratory syncytial virus
FPHFSSVVL

SEQ ID NO: 52 - protein, 11 aa, Homo sapiens
VVSEVDIAKAD

SEQ ID NO: 53 - protein, 9 aa, Homo sapiens
RLSDAQIYV

SEQ ID NO: 54 - protein, 9 aa, Homo sapiens
HLANIVERV

SEQ ID NO: 55 - protein, 10 aa, Homo sapiens
SLAEGLRRTV

SEQ ID NO: 56 - protein, 9 aa, Homo sapiens
AIHHFIEGV

SEQ ID NO: 57 - protein, 11 aa, Homo sapiens
KPKNPEFTSGL

SEQ ID NO: 58 - protein, 9 aa, Homo sapiens
KIRNFVVVF

SEQ ID NO: 59 - protein, 15 aa, Bordetella pertussis
AAFIALYPNSQLAPT

SEQ ID NO: 60 - protein, 12 aa, Bordetella pertussis
IALYPNSQLAPT

SEQ ID NO: 61 - protein, 14 aa, Bordetella pertussis
LAEVLDYHNFVLTQ

SEQ ID NO: 62 - protein, 16 aa, Bordetella pertussis
GGAEYNLALGQRRADA

SEQ ID NO: 63 - protein, 14 aa, Bordetella pertussis
GGAEYNLALGQRRA

SEQ ID NO: 64 - protein, 19 aa, Bordetella pertussis
KPDQGEVVAVGPGKKTEDG

SEQ ID NO: 65 - protein, 18 aa, Bordetella pertussis
KPDQGEVVAVGPGKKTED

SEQ ID NO: 66 - protein, 16 aa, Bordetella pertussis
LRDTNVTAVPASGAPA

SEQ ID NO: 67 - protein, 15 aa, Bordetella pertussis
RDTNVTAVPASGAPA

SEQ ID NO: 68 - protein, 16 aa, Bordetella pertussis
STLWYAESNALSKRLG

SEQ ID NO: 69 - protein, 16 aa, Bordetella pertussis
ASTLWYAESNALSKRL

SEQ ID NO: 70 - protein, 14 aa, Bordetella pertussis
STLWYAESNALSKR

SEQ ID NO: 71 - protein, 17 aa, Bordetella pertussis
EAGRFKVLTVNTLAGSG

SEQ ID NO: 72 - protein, 20 aa, Bordetella pertussis
QPAEAGRFKVLTVNTLAGSG

SEQ ID NO: 73 - protein, 20 aa, Neisseria meningitidis
DVSLYGEIKAGVEGRNIQLQ

SEQ ID NO: 74 - protein, 18 aa, Neisseria meningitidis
DVSLYGEIKAGVEGRNIQ

SEQ ID NO: 75 - protein, 20 aa, Neisseria meningitidis
DVSLYGEIKAGVEGRNYQLQ

SEQ ID NO: 76 - protein, 18 aa, Neisseria meningitidis
DVSLYGEIKAGVEGRNYQ

SEQ ID NO: 77 - protein, 16 aa, Neisseria meningitidis
IRTKISDFGSFIGFKG

SEQ ID NO: 78 - protein, 15 aa, Neisseria meningitidis
IRTKISDFGSFIGFK

SEQ ID NO: 79 - protein, 14 aa, Neisseria meningitidis
TKISDFGSFIGFKG

SEQ ID NO: 80 - protein, 18 aa, Neisseria meningitidis
LAGEFGTLRAGRVANQFD

SEQ ID NO: 81 - protein, 17 aa, Neisseria meningitidis
LAGEFGTLRAGRVANQF

SEQ ID NO: 82 - protein, 16 aa, Neisseria meningitidis
LAGEFGTLRAGRVANQ

SEQ ID NO: 83 - protein, 15 aa, Neisseria meningitidis
LAGEFGTLRAGRVAN

SEQ ID NO: 84 - protein, 15 aa, Neisseria meningitidis
AGEFGTLRAGRVANQ

SEQ ID NO: 85 - protein, 14 aa, Neisseria meningitidis
AGEFGTLRAGRVAN

SEQ ID NO: 86 - protein, 13 aa, Neisseria meningitidis
AGEFGTLRAGRVA

SEQ ID NO: 87 - protein, 15 aa, Neisseria meningitidis
GEFGTLRAGRVANQF

SEQ ID NO: 88 - protein, 14 aa, Neisseria meningitidis
GEFGTLRAGRVANQ

SEQ ID NO: 89 - protein, 13 aa, Neisseria meningitidis
GEFGTLRAGRVAN

SEQ ID NO: 90 - protein, 12 aa, Neisseria meningitidis
GEFGTLRAGRVA

SEQ ID NO: 91 - protein, 12 aa, Neisseria meningitidis
FGTLRAGRVANQ

SEQ ID NO: 92 - protein, 33 aa, Neisseria meningitidis
KRHDDMSVSVRYDSPEFSGFSGSVQFVPAQNSK

SEQ ID NO: 93 - protein, 12 aa, Neisseria meningitidis
  misc_feature (5)..(5): oxidized methionine
RHDDMSVSVRYD

SEQ ID NO: 94 - protein, 20 aa, Neisseria meningitidis
SPEFSGFSGSVQFVPAQNSK

SEQ ID NO: 95 - protein, 20 aa, Neisseria meningitidis
SPDFSGFSGSVQFVPIQNSK

SEQ ID NO: 96 - protein, 34 aa, Neisseria meningitidis
GKPGSDVYYAGLNYKNGGFAGNYAFKYARHANVG

SEQ ID NO: 97 - protein, 33 aa, Neisseria meningitidis
GKPGSDVYYAGLNYKNGGFAGNYAFKYARHANV

SEQ ID NO: 98 - protein, 32 aa, Neisseria meningitidis
GKPGSDVYYAGLNYKNGGFAGNYAFKYARHAN

SEQ ID NO: 99 - protein, 31 aa, Neisseria meningitidis
KPGSDVYYAGLNYKNGGFAGNYAFKYARHAN

SEQ ID NO: 100 - protein, 15 aa, Neisseria meningitidis
ATASYRFGNAVPRIS

SEQ ID NO: 101 - protein, 32 aa, Neisseria meningitidis
TSYDQIIAGVDYDFSKRTSAIVSGAWLKRNTG

SEQ ID NO: 102 - protein, 17 aa, Neisseria meningitidis
RNTGIGNYTQINAASVG

SEQ ID NO: 103 - protein, 15 aa, Neisseria meningitidis
RNTGIGNYTQINAAS

SEQ ID NO: 104 - protein, 16 aa, Neisseria meningitidis
GIGNYTQINAASVGLR

SEQ ID NO: 105 - protein, 14 aa, Neisseria meningitidis
GIGNYTQINAASVG

SEQ ID NO: 106 - protein, 15 aa, Neisseria meningitidis
IGNYTQINAASVGLR

SEQ ID NO: 107 - protein, 14 aa, Neisseria meningitidis
IGNYTQINAASVGL

SEQ ID NO: 108 - protein, 13 aa, Neisseria meningitidis
IGNYTQINAASVG

SEQ ID NO: 109 - protein, 16 aa, Neisseria meningitidis
NYTQINAASVGLRHKF

SEQ ID NO: 110 - protein, 15 aa, Neisseria meningitidis
YTQINAASVGLRHKF

SEQ ID NO: 111 - protein, 16 aa, Neisseria meningitidis
AANLLEPLPASTINET

SEQ ID NO: 112 - protein, 15 aa, Neisseria meningitidis
DPGALVTYSGAAVLK

SEQ ID NO: 113 - protein, 16 aa, Neisseria meningitidis
INNYYWHAFAREKGVQ

SEQ ID NO: 114 - protein, 20 aa, Neisseria meningitidis
EGASGFYVQADAAHAKASSS

SEQ ID NO: 115 - protein, 18 aa, Neisseria meningitidis
EGASGFYVQADAAHAKAS

SEQ ID NO: 116 - protein, 12 aa, Neisseria meningitidis
YVQADAAHAKAS

SEQ ID NO: 117 - protein, 11 aa, Neisseria meningitidis
YVQADAAHAKA

SEQ ID NO: 118 - protein, 17 aa, Neisseria meningitidis
SDSQILYHQGRFIVDPA

SEQ ID NO: 119 - protein, 31 aa, Neisseria meningitidis
IKNHGYELGASYRTGGLTAKVGVSHSKPRFY

SEQ ID NO: 120 - protein, 30 aa, Neisseria meningitidis
IKNHGYELGASYRTGGLTAKVGVSHSKPRF

SEQ ID NO: 121 - protein, 16 aa, Neisseria meningitidis
LPGVGRDVRLGVNYKF

SEQ ID NO: 122 - protein, 13 aa, Neisseria meningitidis
VGRDVRLGVNYKF

SEQ ID NO: 123 - protein, 15 aa, Neisseria meningitidis
KAFYQRQLAVAVKRA

SEQ ID NO: 124 - protein, 14 aa, Neisseria meningitidis
KAFYQRQLAVAVKR

SEQ ID NO: 125 - protein, 15 aa, Neisseria meningitidis
YRKQYMIERNNLLPT

SEQ ID NO: 126 - protein, 14 aa, Neisseria meningitidis
RSSYAAEGAALSAQ

SEQ ID NO: 127 - protein, 17 aa, Neisseria meningitidis
ENKRHYIGGILERTQQT

SEQ ID NO: 128 - protein, 34 aa, Neisseria meningitidis
PRVFGSVSRGDDTENSDIDLLVDAKTGTTLLDLG

SEQ ID NO: 129 - protein, 23 aa, Neisseria meningitidis
DGSRSPYYVQADLAYAAERITHD

SEQ ID NO: 130 - protein, 16 aa, Neisseria meningitidis
MAQYDRLGLTRSNTSC

SEQ ID NO: 131 - protein, 15 aa, Neisseria meningitidis
HDHIIVTLKNHTLPT

SEQ ID NO: 132 - protein, 17 aa, Neisseria meningitidis
DDKLAFAKETGADLVVN

SEQ ID NO: 133 - protein, 16 aa, Neisseria meningitidis
DKKVFTDARAVSTRQD

SEQ ID NO: 134 - protein, 15 aa, Neisseria meningitidis
ADRYIFAPAARGYRK

SEQ ID NO: 135 - protein, 32 aa, Neisseria meningitidis
RHDDMSVSVRYDSPEFSGFSGSVQFVPAQNSK

SEQ ID NO: 136 - protein, 32 aa, Neisseria meningitidis; identical to SEQ ID NO: 135
  misc_feature (5)..(5): oxidated methionine

SEQ ID NO: 137 - protein, 35 aa, Neisseria meningitidis
VGKPGSDVYYAGLNYKNGGFAGNYAFKYAKHANVG

SEQ ID NO: 138 - protein, 40 aa, Neisseria meningitidis
VVGKPGSDVYYAGLNYKNGGFAGNYAFKYAKHANVGRDAF

SEQ ID NO: 139 - protein, 41 aa, Neisseria meningitidis
AVVGKPGSDVYYAGLNYKNGGFAGNYAFKYAKHANVGRDAF

SEQ ID NO: 140 - protein, 32 aa, Neisseria meningitidis
KPGSDVYYAGLNYKNGGFAGNYAFKYAKHANV

SEQ ID NO: 141 - protein, 33 aa, Neisseria meningitidis
KPGSDVYYAGLNYKNGGFAGNYAFKYAKHANVG

SEQ ID NO: 142 - protein, 31 aa, Neisseria meningitidis
GSDVYYAGLNYKNGGFAGNYAFKYAKHANVG

SEQ ID NO: 143 - protein, 34 aa, Neisseria meningitidis
KTKNSTTEIAATASYRFGNAVPRISYAHGFDFIE

SEQ ID NO: 144 - protein, 35 aa, Neisseria meningitidis
KTKNSTTEIAATASYRFGNAVPRISYAHGFDFIER

SEQ ID NO: 145 - protein, 36 aa, Neisseria meningitidis
SALDKRSYLAKIGTTFGDDDHRIVLSHMKDQHRGIR

SEQ ID NO: 146 - protein, 36 aa, Neisseria meningitidis; identical to SEQ ID NO: 145
  misc_feature (28)..(28): oxidated methionine

SEQ ID NO: 147 - protein, 35 aa, Neisseria meningitidis
GVYVEAIHDIGDFTLTGGLRYDRFKVKTHDGKTVS

SEQ ID NO: 148 - protein, 34 aa, Neisseria meningitidis
VYVEAIHDIGDFTLTGGLRYDRFKVKTHDGKTVS

SEQ ID NO: 149 - protein, 32 aa, Neisseria meningitidis
GYIKNHGYELGASYRTGGLTAKVGVSHSKPRF

SEQ ID NO: 150 - protein, 30 aa, Neisseria meningitidis
YIKNHGYELGASYRTGGLTAKVGVSHSKPR

SEQ ID NO: 151 - protein, 31 aa, Neisseria meningitidis
YIKNHGYELGASYRTGGLTAKVGVSHSKPRF

SEQ ID NO: 152 - protein, 32 aa, Neisseria meningitidis
YIKNHGYELGASYRTGGLTAKVGVSHSKPRFY

SEQ ID NO: 153 - protein, 29 aa, Neisseria meningitidis
IKNHGYELGASYRTGGLTAKVGVSHSKPR

SEQ ID NO: 154 - protein, 18 aa, Unknown
  Synthetic sequence
PEFSGFSGSVQFVPAQNS

SEQ ID NO: 155 - protein, 18 aa, Unknown
  Synthetic sequence
SGSVQFVPAQNSKSAYTP

SEQ ID NO: 156 - protein, 18 aa, Unknown
  Synthetic sequence
PDFSGFSGSVQFVPIQNS

SEQ ID NO: 157 - protein, 18 aa, Unknown
  Synthetic sequence
SGSVQFVPIQNSKSAYTP

SEQ ID NO: 158 - protein, 367 aa, Neisseria meningitidis
DVSLYGEIKAGVEGRNIQLQLTEPLPNIQPQVTKRKSRIRTKISDFGSFIGFKGSEDLGEGLKAVWQLEQDVSVAGGGASQWGNRESFIGLAGEFGTLRAGRVANQFDDASQAIDPWDSNNDVASQLGIFKRHDDMSVSVRYDSPEFSGFSGSVQFVPAQNSKSAYTPAHFVQNKQNQRPTLVPAVVGKPGSDVYYAGLNYKNGGFAGNYAFKYAKHANVGRDAFELFLIGSATSDEAKGTDPLKNHQVHRLTGGYEEGGLNLALAAQLDLSENADKTKNSTTEIAATASYRFGNAVPRISYAHGFDFIERGKKGENTSYDQIIAGVDYDFSKRTSAIVSGAWLKRNTGIGNYTQINAASVGLRHKF

SEQ ID NO: 159 - protein, 372 aa, Neisseria meningitidis
DVSLYGEIKAGVEGRNYQLQLTEAQAANGGASGQVKVTKAKSRIRTKISDFGSFIGFKGSEDLGEGLKAVWQLEQDVSVAGGGATQWGNRESFIGLAGEFGTLRAGRVANQFDDASQAIDPWDSNNDVASQLGIFKRHDDMPVSVRYDSPDFSGFSGSVQFVPIQNSKSAYTPAHVVVNNKVATHVPAVVGKPGSDVYYAGLNYKNGGFAGNYAFKYARHANVGRNAFELFLIGSATSDQAKGTDPLKNHQVHRLTGGYEEGGLNLALAAQLDLSENGDKAKTKNSTTEIAATASYRFGNAVPRISYAHGFDLIERGKKGENTSYDQIIAGVDYDFSKRTSAIVSGAWLKRNTGIGNYTQINAASVGLRHKF